(19) United States
(12) Patent Application Publication
(10) Pub. No.: US 2005/0030622 A1
(43) Pub. Date: Feb. 10, 2005

(54) Three-dimensional observation apparatus

(76) Inventors: Kazuo Morita, Tokyo (JP); Susumu Takahashi, Iruma-shi (JP)

Correspondence Address: Arnold International, P.O. Box 129, Great Falls, VA, 22066, US

(21) Appl. No.: 10/891,181

(22) Filed: Jul. 15, 2004

(30) Foreign Application Priority Data
Jul. 15, 2003 (JP) 2003-274854

(51) Int. Cl. G02B 27/22

(52) U.S. Cl. 359/464

(57) ABSTRACT

A stereoscopic observation apparatus is disclosed that includes an image projector that projects left and right eye images to an image surface, with the images being substantially overlapped at the image surface. The images may be viewed auto stereoscopically by virtue of an imaging element having positive optical power that conjugates the apertures to observation exit pupils. A holographic optical element that has little or no optical power is positioned at or near the image surface for the purpose of dispersing the light in the non-zero diffracted orders. The amount of dispersion caused by the holographic optical element over the wavelength range 450 nm-650 nm for diffracted light of the first order is less than or equal to one-half the angular amount that each first-order diffracted beam is diffracted from the direction of propagation of the zero-order beam that passes straight through the holographic optical element.

This application claims the benefit of foreign priority of Japanese Patent Application 2003-274854, filed on Jul. 15, 2003, the subject matter of which is hereby incorporated by reference.

### BACKGROUND OF THE INVENTION

A three-dimensional (herein 3-D) observation apparatus that does not require the wearing of glasses to observe 3-D images has previously been proposed. As shown in FIG. 67, Japanese Laid-Open Patent application S51-24116 discloses a three-dimensional observation apparatus formed of two display devices 51R and 51L, two concave mirrors 52R and 52L, and a concave mirror 53 that faces the two concave mirrors. In the figure, the right and left pupils of an observer are indicated by 54R and 54L.

FIG. 68 is a side view of the apparatus shown in FIG. 67, but with the apparatus in FIG. 67 shown upside down and with the display devices omitted, for convenience of explanation. In FIG. 68, the conjugate positions 54R′ (54L′), 54R″ (54L″) of the pupils of the observer are shown, and the display device 51R (51L) shown in FIG. 67 is positioned somewhere between the infinite point PR (∞) (PL (∞)) and the front focal point PR (f) (PL (f)) of the concave mirror 52R (52L). When the display device 51R (51L) is positioned at the infinite point PR (∞) (PL (∞)), light emerging from the display device 51R (51L) is reflected by the concave mirror 52R (52L), imaged at the front focal point A of the concave mirror 53, reflected and collimated by the concave mirror 53, and reaches the pupil 54R (54L) of the observer. When the display device 51R (51L) is positioned at the front focal point PR (f) (PL (f)) of the concave mirror 52R (52L), light emerging from the display device 51R (51L) is reflected and collimated by the concave mirror 52R (52L), reflected by the concave mirror 53, imaged at the back focal point B of the concave mirror 53, and reaches the pupil 54R (54L) of the observer with the image being enlarged.

The prior art observation apparatus described above does not use a half mirror, thus bright images are provided by this observation apparatus. Instead, it uses concave mirrors, but a concave mirror generates image distortion. Therefore, in order to cancel the distortion produced, in each optical path, two concave mirrors are restrictively positioned so as to face each other and thereby cancel the distortion. However, such a design leads to increased aberrations and focal point shifts due to inaccuracies in the production and in the assembly of the concave mirrors. In order to resolve these problems it is necessary to produce and assemble the concave mirror surfaces with high precision and accuracy, which results in a high cost for this type of design of a 3-D observation apparatus.

Furthermore, there is also increased image distortion with such a 3-D observation apparatus due to a shift of position of the observer from an ideal observation position. Consequently, this type of observation apparatus provides an observer with little freedom of position, imposing on him/her a limited posture. In order to increase an observer's freedom of position while observing, the exit pupil has to be enlarged. In order to enlarge the exit pupil, the concave mirrors must be enlarged, but this increases the size of the observation apparatus.

### BRIEF SUMMARY OF THE INVENTION

The present invention relates to a three-dimensional observation apparatus that does not require the wearing of glasses to observe 3-D images. Moreover, the three-dimensional observation apparatus of the present invention provides bright images, allows the observer more freedom of position when observing 3-D images, produces no noticeable image distortion even when the observer changes his viewing position, and thus allows an observer to assume a comfortable posture when observing 3-D images.

### BRIEF DESCRIPTION OF THE DRAWINGS

The present invention will become more fully understood from the detailed description given below and the accompanying drawings, which are given by way of illustration only and thus are not limitative of the present invention, wherein:

FIG. 1 shows angles subtended by the centers of two light sources as seen from a top, middle, and bottom position on an interference recording surface of a hologram recording material;

FIG. 2 shows the wavelength dispersion that occurs in association with the diffraction of light by a hologram-type, diffractive optical element;

FIG. 3 shows how exit pupils for light at three wavelengths of an image projection means may be projected for observation by an observer;

FIG. 4 shows how the projected exit pupils shown in FIG. 3 are seen by the observer;

FIG. 5 shows a hologram-type, diffractive optical element that transmits plus and minus first-order light beams as scattered light beams;

FIG. 6 shows how the exit pupil of an image projection means is split and projected near the observer as a zero-order exit pupil that is not enlarged, as well as plus and minus first-order exit pupils that are each enlarged;

FIG. 7 shows how two exit pupils of an image projection means are projected near the observer as six exit pupils, due to the diffractive nature of the panel 40;

FIG. 8 shows the centers of the exit pupils projected by the plus and minus first-order light beams as well as the center of the exit pupil projected by the zero-order light beam;

FIG. 9 shows the overlapping area of the plus and minus first-order exit pupils and the zero-order exit pupil;

FIGS. 10(a) and 10(b) show the structure and operation of Embodiment 3 of the present invention, when designed so that the exit pupil of the plus first-order light beam is aligned for viewing by an observer, with FIG. 10(a) illustrating an observer while observing the projected plus first-order images and with FIG. 10(b) illustrating an observer who rotates his view downward to view a region 70;

FIGS. 11(a) and 11(b) show the structure and operation of Embodiment 3, when designed so that the exit pupil of the minus first-order light beam is aligned for viewing by an observer, with FIG. 11(a) illustrating an observer while observing the projected minus first-order images and with FIG. 11(b) illustrating an observer who rotates his view downward to view a region 70;

FIG. 12 shows the elongated plus and minus first-order, enlarged exit pupils;

FIGS. 13(a) and 13(b) show the undesirable condition of one exit pupil extending so as to cover both eyes of an observer;

FIG. 14 shows the enlarged exit pupils in relation to the observer;

FIG. 15 shows that the lengthwise direction of vertically elongated, enlarged exit pupils coincides with the shift direction of the enlarged pupils for different wavelengths;

FIG. 16 shows the plus and minus first-order reconstructed light beams of a rectangular light source;

FIG. 17 shows a diffracted light intensity profile for a single wavelength, along the line that passes through the center of an enlarged exit pupil and is parallel to the length of one of the reconstructed light beams 87, 88 shown in FIG. 16;

FIGS. 18(a) and 18(b) show the structure of Embodiment 4;

FIG. 19 shows diffracted light intensity profiles at three different wavelengths of the enlarged exit pupils in the vertical direction, which profiles vary for different wavelengths due to the dispersion effect upon diffraction;

FIG. 20 shows the diffracted light intensity profile of an enlarged exit pupil for a single wavelength along a line that passes through the center of an enlarged exit pupil that is parallel to the width direction (i.e., the horizontal direction) of the enlarged exit pupil;

FIGS. 21(a) and 21(b) show the enlarged exit pupils for Embodiment 4 when a hologram-type, diffractive optical element is used to maintain a specified diffracted light intensity at the periphery in relation to the diffracted light intensity at the center of the enlarged exit pupil;

FIG. 22 shows the manner in which L1 and L2 are defined;

FIG. 23 shows that the exit pupil of an image projection means is projected at shifted positions and with different sizes for different wavelengths;

FIGS. 24(a) and 24(b) show the structure of a hologram-type, diffractive optical element 120 and a Fresnel concave minor 121;

FIG. 25 shows projected images that are inclined in relation to a hologram-type, diffractive optical element;

FIG. 26 shows projected images that are parallel to the hologram-type, diffractive optical element;

FIGS. 27(a) and 27(b) show the structure of Embodiment 1 of the present invention;

FIG. 28 is a schematic diagram, in perspective view, of the geometry of the optical system of the present invention;

FIG. 29 is a schematic diagram, in side view, of the geometry of the exposure conditions of the hologram diffuser of Embodiments 1 and 10 of the present invention;

FIGS. 30(a) and 30(b) show the structure of Embodiment 2 of the present invention;

FIG. 31 shows the geometry of the hologram diffuser of Embodiment 2 of the present invention;

FIG. 32 shows the manner in which the pupils are projected in Embodiment 2 of the present invention;

FIG. 33 shows the structure of Embodiment 4 of the present invention;

FIG. 34 shows the exposure conditions of the hologram diffuser according to Embodiments 4 and 10 of the present invention;

FIG. 35 shows the diffracted light intensity profile taken along a line that passes through the center of the plus first-order reconstruction beam from the second light source shown in FIG. 34 and is parallel to the length of the enlarged exit pupils shown in Embodiments 4 and 10;

FIG. 36 shows the diffracted light intensity profile taken along a line that passes through the center of the plus first-order reconstructed beam of the second light source and is parallel to the width of the enlarged exit pupils shown in Embodiments 4 and 10;

FIG. 37 shows the structure of Embodiment 5 of the present invention;

FIG. 38 is a side view of the optical system used in Embodiments 6 and 10 of the present invention;

FIG. 39 is a top view of the optical system used in Embodiments 6 and 10 of the present invention;

FIG. 40 shows the manner in which light is diffracted and diffused by the hologram-type, diffractive optical element in the vertical direction;

FIG. 41 shows the eyes of the observer positioned at the center of circular areas (the dash-dash lines) as well as within the center area of elongated exit pupils (heavy solid line);

FIG. 42 shows the structure and operation of Embodiment 8 of the present invention;

FIG. 43 shows the geometry of the hologram recording material and plural light sources;

FIG. 44 shows the structure and operation of Embodiment 7 of the present invention;

FIGS. 45(a) and 45(b) show the operation of a transmission-type, three-dimensional observation apparatus of the present invention (FIG. 45(a)) versus that of a reflection-type three-dimensional observation apparatus of the present invention (FIG. 45(b));

FIG. 46 shows the manner in which pupils are enlarged in the three-dimensional observation apparatus of the present invention;

FIGS. 47(a) and 47(b) show an embodiment of a transmission-type, three-dimensional observation apparatus of the present invention, with FIG. 47(a) being a top view and FIG. 47(b) being a side view;

FIGS. 48(a) and 48(b) show the structure and operation of another embodiment of the present invention, with FIG. 48(a) being a perspective view and FIG. 48(b) being a side view;

FIG. 49 is a side view of the structure shown in FIG. 48(b), but in more detail and from the opposite side;

FIGS. 50(a)-50(c) are side views of a modification of the embodiment shown in FIG. 49;

FIGS. 51(a) and 51(b) show the structure and operation of another embodiment of the present invention;

FIGS. 52(a) and 52(b) show an embodiment of a reflection-type display panel applicable to the three-dimensional observation apparatus of the present invention;

FIGS. 53(a) and 53(b) show another embodiment of a reflection-type display panel applicable to the three-dimensional observation apparatus of the present invention;

FIG. 54 shows another embodiment of a reflection-type display panel applicable to the three-dimensional observation apparatus of the present invention;

FIG. 55 shows another embodiment of a reflection-type display panel applicable to the three-dimensional observation apparatus of the present invention;

FIGS. 56(a)-56(c) show another embodiment of a reflection-type display panel applicable to the three-dimensional observation apparatus of the present invention;

FIGS. 57(a)-57(c) show another embodiment of a reflection-type display panel applicable to the three-dimensional observation apparatus of the present invention;

FIGS. 58(a) and 58(b) are schematic illustrations of the three-dimensional observation apparatus of the present invention;

FIGS. 59(a)-59(c) show the geometry of a Fresnel concave mirror and a diffusing plate that is formed of a transmission-type hologram;

FIGS. 60(a) and 60(b) show the geometry of a Fresnel concave mirror and a diffusing plate that is formed of a transmission-type hologram;

FIGS. 61(a) and 61(b) show the geometry of a reflection-type, three-dimensional observation apparatus of the present invention;

FIG. 62 shows an embodiment of a three-dimensional observation system using the three-dimensional observation apparatus of the present invention;

FIG. 63 is an illustration to explain an example of use of the three-dimensional observation apparatus of the present invention;

FIG. 64 is an illustration to explain another example of use of the three-dimensional observation apparatus of the present invention;

FIG. 65 is an illustration to explain another example of use of the three-dimensional observation apparatus of the present invention;

FIG. 66 is an illustration to explain another embodiment of use of the three-dimensional observation apparatus of the present invention;

FIG. 67 shows the structure and operation of a prior art three-dimensional observation apparatus;

FIG. 68 is a side view of the prior art apparatus in FIG. 67;

FIG. 69 shows Embodiment 9 of the present invention that includes a drape that is integrally formed with the three-dimensional observation apparatus;

FIG. 70 shows a sterilized pouch in which the drape of Embodiment 9 is incorporated;

FIG. 71 shows the usage of the drape of Embodiment 9;

FIG. 72 shows the drape of Embodiment 9 mounted on a Fresnel concave mirror;

FIG. 73 shows the three-dimensional observation apparatus of Embodiment 9 in use;

FIG. 74 shows an alternative design of the drape shown in FIG. 72;

FIGS. 75(a) and 75(b) show the structure and operation of Embodiment 10 of the present invention;

FIG. 76 shows the geometry of the hologram diffuser of Embodiment 10 of the present invention;

FIG. 77 shows how two exit pupils of the image projection means of Embodiment 10 are projected near the observer; and

FIG. 78 shows for Embodiment 10 how the brightness at the center of the projected exit pupils is measured from the projected pupil position.

### DETAILED DESCRIPTION

In the present invention, a hologram-type, diffractive optical element and a concave Fresnel mirror are used to project two exit pupils of an image projection means for observation by an observer.

Among images projected by the projection apparatus from two separated pupils, with the images having parallax, the observer observes a right-eye image with his/her right eye and a left-eye image with his/her left eye. Thus, the observer can observe right-eye and left-eye, two-dimensional images with his/her right and left eyes witthout wearing glasses so as to enable what is termed a ‘3-D’ effect to be realized.

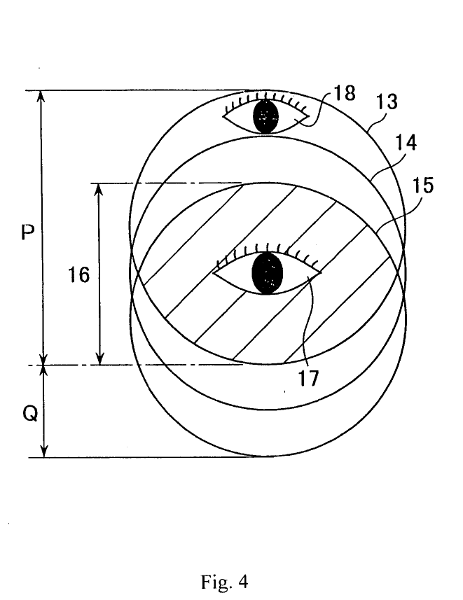

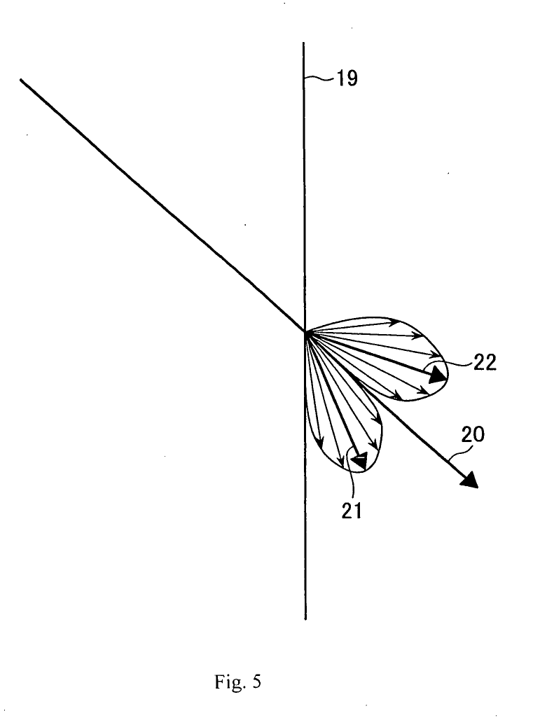

A hologram-type, diffractive optical element (DOE) will now be described with reference to FIG. 5. Such a DOE transmits and splits incident light into three light fluxes, namely, a zero-order diffracted light flux that undergoes no scattering, and two diffracted light fluxes, of plus and minus first-order, that undergo scattering. Thus, the hologram-type, diffractive optical element 19 transmits and diffracts incident light into a zero-order light beam 20, a plus first-order light beam 21, and a minus first-order light beam 22. Furthermore, the hologram-type, diffractive optical element 19 is provided in a three-dimensional observation apparatus in such a manner that the direction in which the light is split is vertical to the observer.

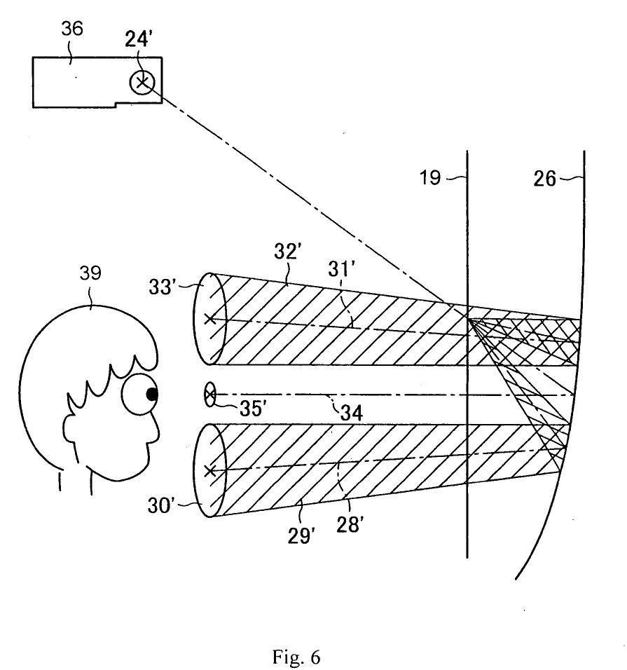

As shown in FIG. 6, the exit pupil 24′ of an image projection means 36 is split into a plus first-order enlarged exit pupil 30′ that has been projected on a plus first-order, scattered light flux 29′ that enlarges the plus first-order light flux 28′, a minus first-order enlarged exit pupil 33′ that has been projected on a minus first-order scattered light flux 32′ that enlarges the minus first-order light flux 31′, and a zero-order exit pupil 35′ that has been projected on a zero-order light flux 34. The exit pupils of the image projection means are projected to positions where an observer 39 can position his eye(s) by using a hologram-type, diffractive optical element 19 in conjunction with a Fresnel concave mirror 26. The Fresnel concave mirror 26 conjugates the left and right exit pupils of the image projection means to exit pupils for viewing by an observer. In this way, the two exit pupils 24′, 24′ of the image projection means 36 are projected near the observer as a total of six exit pupils, of which 4 are enlarged.

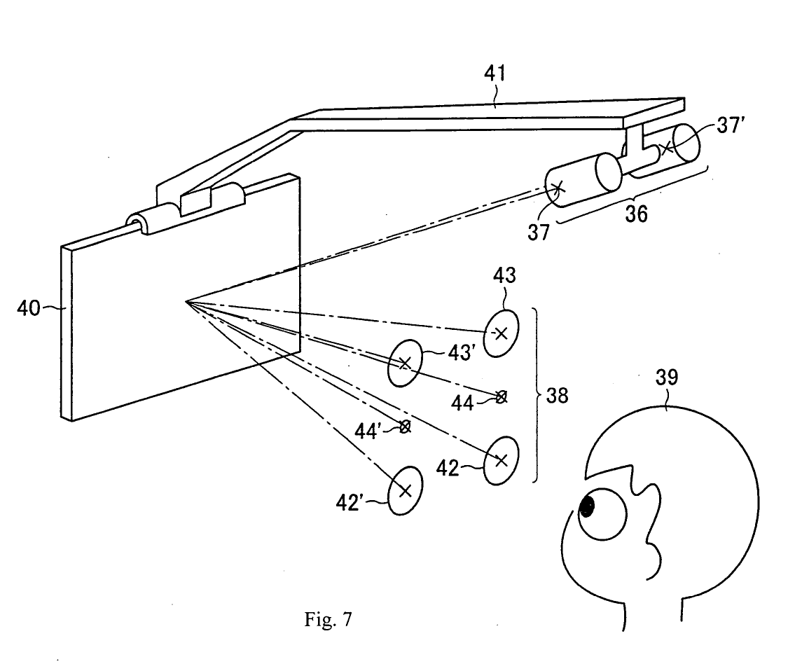

FIG. 7 shows: a projector exit pupil (having a center 37) that is imaged by the panel 40 so as to form conjugate regions 42, 43 that serve as exit pupils for observation by the right eye of an observer; a projector exit pupil, having a center 37′, that is imaged by the display so as to form conjugate regions 42′, 43′ that serve as exit pupils for observation by the left eye of the observer; a panel 40 where a hologram-type, diffractive optical element and a Fresnel concave mirror are integrally formed; and a holding means 41 for holding the image projection means 36 and the panel 40. In more detail, FIG. 7 shows: a plus first-order, enlarged exit pupil for the right eye 42 that has been projected from the exit pupil 37; a plus first-order, enlarged exit pupil for the left eye 42′ that has been projected from the exit pupil 37′; a minus first-order, enlarged exit pupil for the right eye 43 that has been projected from the exit pupil 37; a minus first-order, enlarged exit pupil for the left eye 43′ that has been projected from the exit pupil 37′; a zero-order exit pupil for the right eye 44 that has been projected from the exit pupil 37; and a zero-order exit pupil for the left eye 44′ that has been projected from the exit pupil 37′.

With the above design, an observer is able to observe right and left eye images at both positions, namely, the positions of the plus first-order, enlarged exit pupils 42 and 42′ and the positions of the minus first-order, enlarged exit pupils 43 and 43′, thereby increasing freedom of viewing position and posture. Therefore, the observer experiences less fatigue during observation.

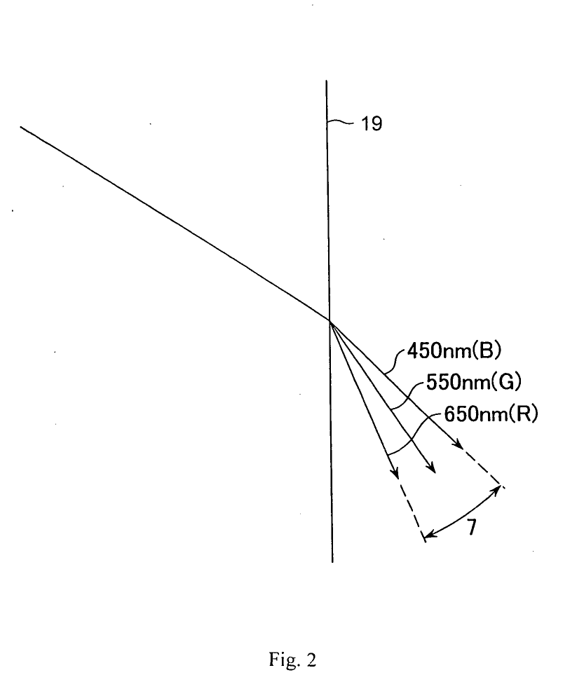

Referring to FIG. 2, the dispersion amount of visible wavelengths in association with the diffraction of the plus first-order and the minus first-order light in the hologram-type, diffractive optical element will herein be defined as the difference 7 in angular diffraction between the light having wavelengths of 450 nm and 650 nm that has passed through the hologram-type, diffractive optical element 19. This dispersion amount is less than half that of the diffraction angle amount, as measured from the direction of travel of the zero order beam, of the plus and minus first-order diffracted beams.

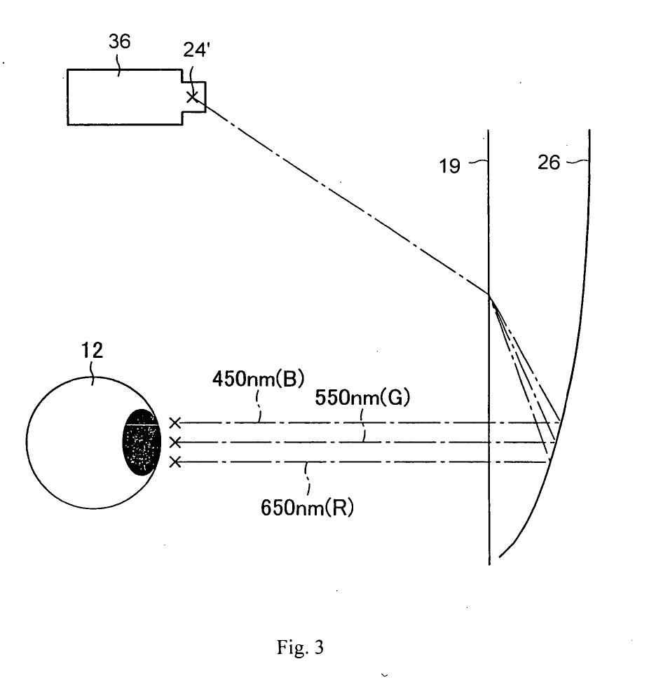

As shown in FIG. 3, with the design of the present invention, an exit pupil 24′ of the image projection means 36 is projected so that an eye 12 of the observer can view projected images with reduced shifts for different wavelengths because of the effects of the hologram-type, diffractive optical element 19 and the Fresnel concave mirror 26.

As shown in FIG. 4, when the projected pupil is seen from the observer's side, among the projected exit pupils 13, 14, and 15 of wavelengths 450 nm, 550 nm, and 650 nm, respectively, the shift amount Q between the projected exit pupil 13 for the wavelength 450 nm versus the projected exit pupil 15 for the wavelength 650 nm can be less than ½ of the length P of the projected pupil in the direction of shift due to wavelength dispersion. Thus, the three projected exit pupils 13 to 15 shown in FIG. 4 overlap over a length in the vertical direction that is greater than one-half the length P. With the eye positioned at a point 17 within the overlapping area 16, images can be observed in the correct colors. When the eye is positioned at a point 18 outside the area 16, images cannot be observed in the correct colors.

As described above, the design of the present invention ensures a greater overlapping area of the projected exit pupils for different wavelengths. Therefore, the observer has more freedom of position when observing and thus will experience less fatigue when observing.

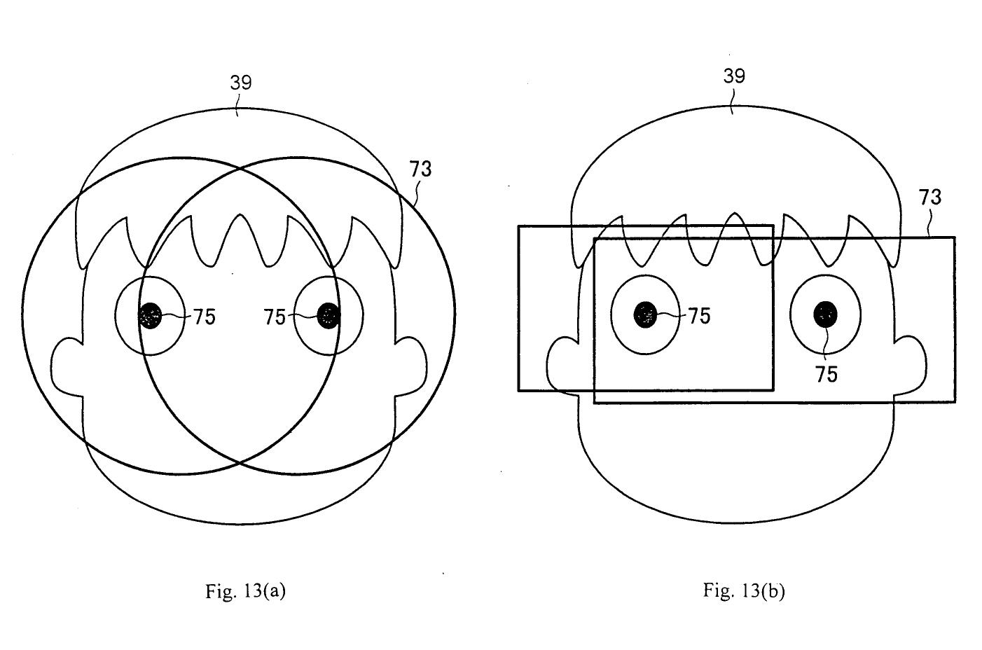

It is desirable that both right and left projected exit pupils be large in order for the observer to have more freedom of position. However (as shown in FIGS. 13(a) and 13(b)), when the projected exit pupil 73 is simply enlarged, a single projected exit pupil may cover both eyes 75, 75 of the observer 39. In such a case, an image that is supposed to be observed only with the right eye can be seen with the left eye, which causes the phenomenon known as crosstalk.

With the design of the present invention as is shown in FIG. 14, projected exit pupils 76 are elongated more in the vertical direction than in the horizontal direction, thereby preventing crosstalk while giving the observer additional freedom of position in viewing.

As shown in FIG. 41, when an observer 39 positions himself with his eyes 1005 and 1005′ within a vertically elongated area 1003, 1003′ the width of which is within a circular region 1004, 1004′ having a diameter Φ equal to 50 mm and centered at the center of each observation exit pupil, the observer will not be aware of the color changes of the images. It has been proven from studies that, within the circular region having a diameter Φ equal to 50 mm as well as within the area of the vertically elongated pupils 1003 and 1003′, an observer will be unlikely to notice any color change of the images observed and will feel that he has a sufficiently large exit pupil for observation that serves as a viewing window, so to speak. More specifically, when the area defined by (x, y)=(X±0.05, Y+0.05) is outside the region having a diameter Φ=50 mm centered about the center of the elongated exit pupil, an observer can move his eyes without perceiving color changes of the images in association with the movement of his eyes. Hence, the observer is provided with more freedom of eye position and experiences less fatigue during observation.

It has also been proven that, when the area defined by (X±0.03, Y±0.03) that is outside a region having a diameter Φ=60 mm that is centered at the center of the elongated pupil, the observer will barely be aware of color changes of the images in association with the movement of his eyes, and thus the observer will be able to move his eyes without any restrictions on the observed images being perceived in different colors that depend on the viewing direction.

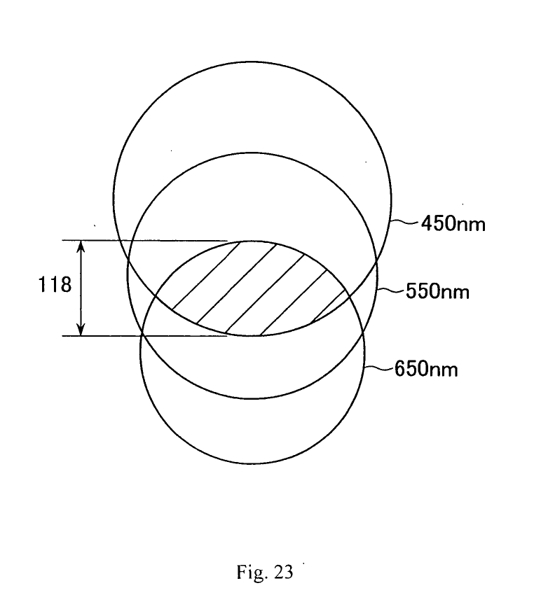

Hologram-type, diffractive optical elements that do not satisfy the conditions of the present invention, besides being diffractive, are strongly convergent or divergent. Therefore, wavelength dispersion in association with a light converging or diverging effect occurs in addition to wavelength dispersion in association with a light diffracting effect. Hence, as shown in FIG. 23, the exit pupils projected by a hologram-type, diffractive optical element and a Fresnel concave mirror are not only shifted in the vertical direction but they also differ in size for different wavelengths. Thus, the overlapping area 118 of the projected exit pupils for different wavelengths is further reduced. Using hologram-type, diffractive optical elements that satisfy the conditions of the present invention prevent the exit pupils that are projected by the combined hologram-type, diffractive optical element/Fresnel concave mirror from differing in size for different wavelengths. Therefore, the overlapping area of the projected exit pupils for different wavelengths is enlarged, and the observer experiences additional freedom of eye position and less fatigue during observation.

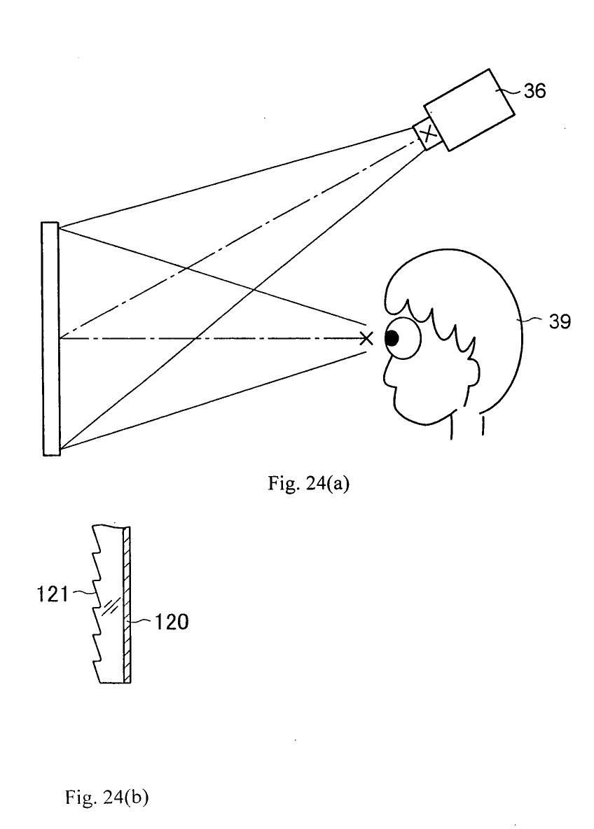

The three-dimensional observation apparatus of the present invention may use, as shown in FIGS. 24(a) and 24(b), a hologram-type, diffractive optical element 120 and a Fresnel concave mirror 121 to collect the light flux emerging from the image projection means 36 and to form exit pupils for observation where an observer 39 may position his left and right eyes for observing the projected images. Thus, even a rather dark image projection means can be used to provide sufficiently bright images to observe. On the contrary, an image projection means having a brightness of 800 lumens or higher (as measured according to the procedures defined by the American National Standards Institute, ANSI), such as provided by a conventional projector, is too bright for the observer to view images as described above.

Experiments have proven that an image projection means having a brightness of 200 ANSI lumens or lower can be used without the images being perceived as being too bright. Using an image projection means that satisfies the conditions of the present invention allows the observer to comfortably observe images. Where the image projection means produces a projected image that is too bright, a dimmer means such as a neutral density (ND) filter can be employed in order to reduce the brightness to 200 ANSI lumens or lower.

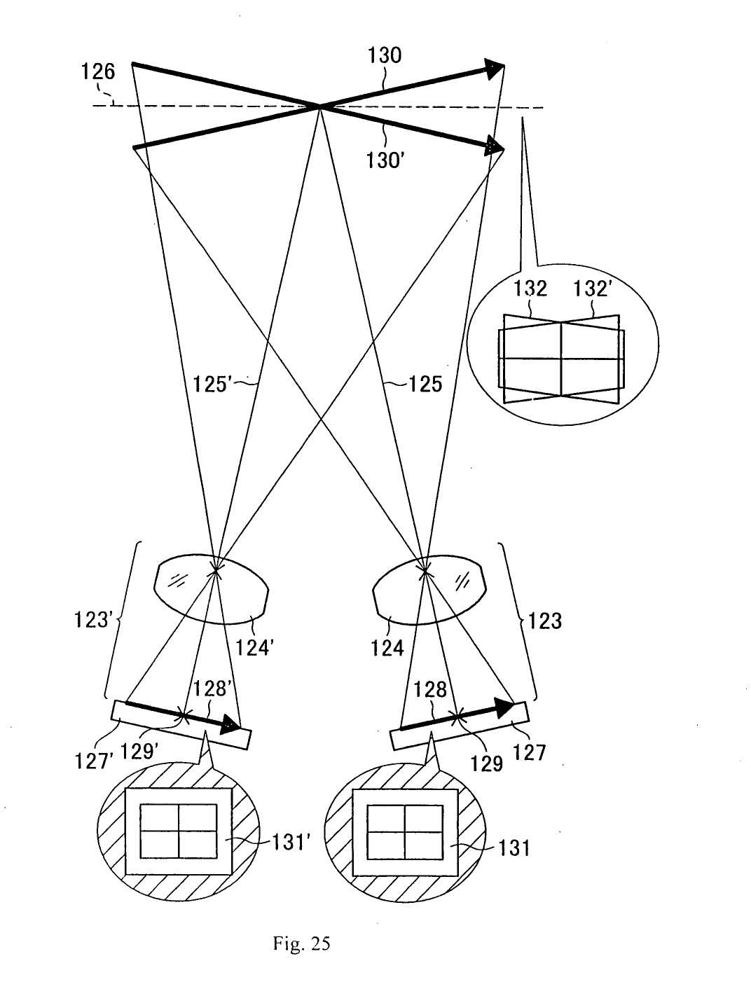

The three-dimensional observation apparatus of the present invention projects two images from two different apertures (i.e., exit pupils) via a screen that includes a hologram-type, diffractive optical element. When using a projection arrangement layout as shown in FIG. 25, the projected images 130 and 130′ will be inclined in relation to the hologram-type, diffractive optical element 126. The respective optical axes 125, 125′ of the image projection optical systems 124, 124′ that are included in the two image projection means 123, 123′ intersect at the surface of the hologram-type, diffractive optical element 126, and the centers 129, 129′ of the images 128, 128′ that are displayed on the image display means 127, 127′ are positioned on these respective optical axes at the point of intersection of these optical axes. When, for example, the images 131 and 131′ are displayed on the two image display means, respectively, the images 132 and 132′ are projected using the hologram-type, diffractive optical element 126. Therefore, a problem arises in that the two images. 132, 132′ do not coincide with each other, as illustrated.

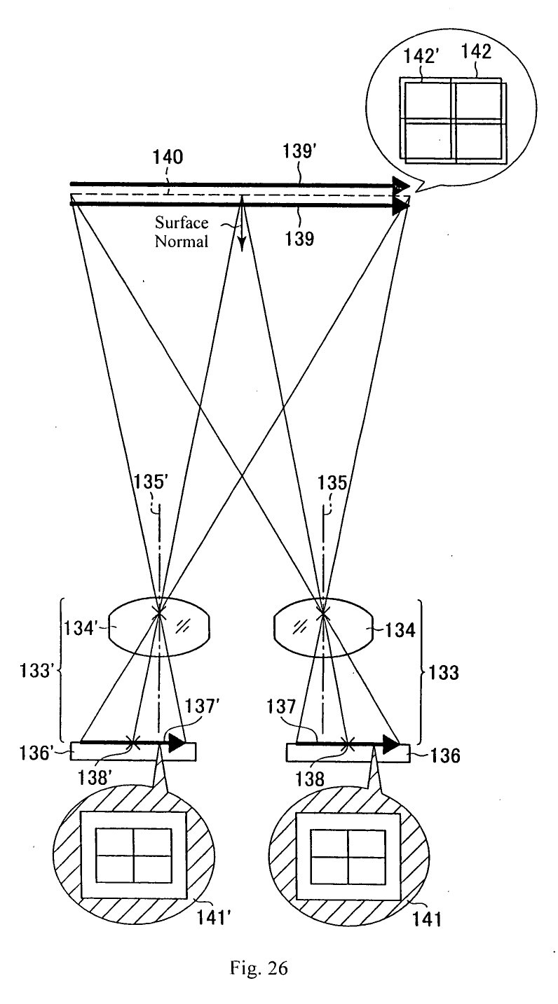

The structure of the present invention is used to resolve the problem mention above. As shown in FIG. 26, the respective optical axes 135 and 135′ of image projection optical systems 134 and 134′ that are included in the two image projection means 133 and 133′ are made to be substantially parallel to a normal line drawn to the hologram-type, diffractive optical element 140. In addition, the surfaces of the image display means 136 and 136′ are oriented so as to be substantially parallel to the surface of the hologram-type, diffractive optical element 140, and the centers 138 and 138′ of images 137 and 137′ that are displayed on image display means 136 and 136′ are positioned outside the optical axes 135 and 135′, respectively. In this way, the projected images 139 and 139′ are made to be parallel to the hologram-type, diffractive optical element 140.

With such a design, when the images 141 and 141′ are displayed on respective image display means, the two images 142 and 142′ projected by the hologram-type, diffractive optical element 140 will coincide with each other. Hence, the observer can readily perceive the two images as a single 3-D image by merging the two images in his brain without generating an uncomfortable feeling or tiredness.

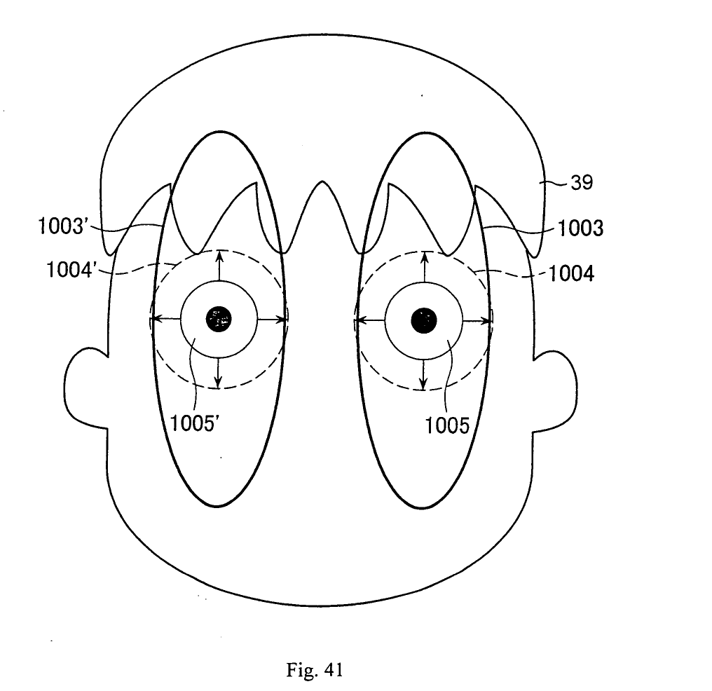

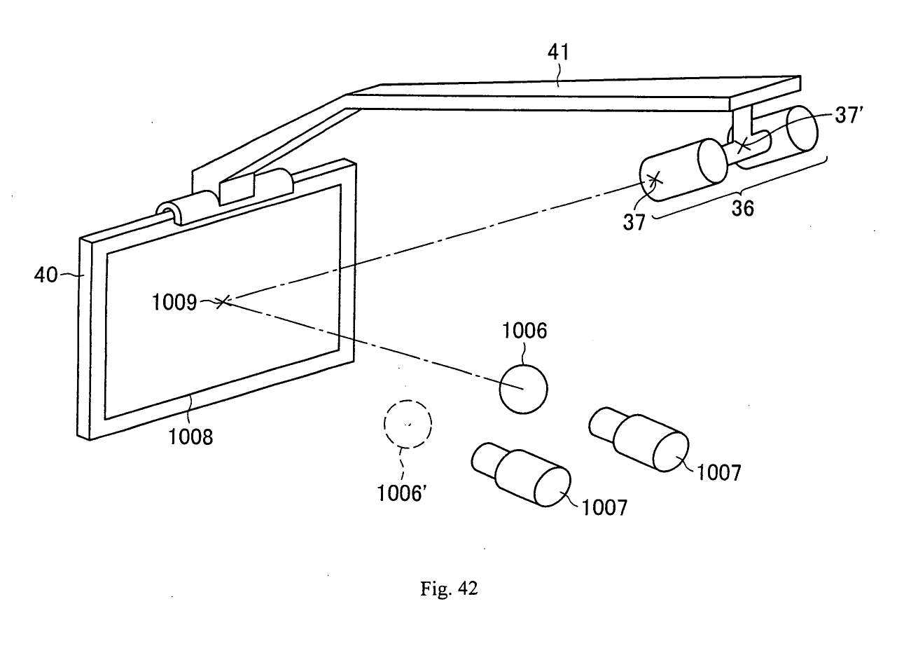

The brightness at the center of a first projected light flux as measured from the center of a first projected pupil at which an observer is able to observe an image and the brightness at the center of a second projected light flux as measured from the center of a second projected pupil at which the observer is not able to observe an image will now be described with reference to FIG. 42.

In FIG. 42, consider the situation when only a right-eye image is projected onto the panel 40 by the image projection means 36, and only a light flux is projected by the image projection means that normally would project a left-eye image. A projected exit pupil 1006 is formed of the exit pupil 37 by the panel 40 that projects an image. A projected exit pupil 1006′ is also formed by the panel 40 of the exit pupil 37′ which does not project an image but instead projects only a light flux.

The brightness at the center of the projected image (as measured from the position of an eye at which the observer is able to observe such an image) will be the brightness at the center 1009 of a projected light flux 1008 as measured by a luminance meter 1007 from inside the projected pupil 1006.

The brightness at the center of a projected light flux (as measured from the position of an eye at which the observer is not able to observe a projected image) will be the brightness at the center 1009 of a projected light flux 1008 as measured by a luminance meter 1007 from inside the projected pupil 1006′ projected from an exit pupil which projects merely a light flux.

When both brightness measurements satisfy the conditions of the present invention, crosstalk (a phenomenon wherein, for example, the left eye also views the right-eye image and vice-versa) can be reduced to the extent that a three-dimensional observation will not be noticeably affected. Crosstalk occurs due to the hologram-type, diffractive optical element producing diffracted light beams in directions other than a single desired direction. It is desirable that a hologram recording material be exposed to interference light in what is termed the ‘reference beam’ such that the intensity of light in the reference beam is 10 times or less so as to prevent unnecessary diffracted light from being produced. It has been shown experimentally that there will be an acceptable level of crosstalk when the following Condition (1) is satisfied:
H2/H1<0.05 Condition (1)
where

H1 is the light intensity, measured at the center of a first observation exit pupil that is conjugate to a first exit pupil of a stereoscopic observation apparatus, in the direction of the center′ of a first light flux when the first light flux is currently projecting an image of a test object, such as a white screen, at all field angles through the first exit pupil; and

H2 is the light intensity, measured at the center of a second observation exit pupil that is conjugate to a second exit pupil of the stereoscopic observation apparatus, in the direction of the center of a second light flux when the second light flux is projected through the second exit pupil, but at a time when the second light flux is not being projected through the second exit pupil, and the first light flux is being projected through the first exit pupil and carries the image of the test object.

Thus, it is preferable that Condition (1) above be satisfied.

Further, when the Condition (1′) shown below is satisfied, the level of crosstalk will be further improved:
H2/H1<0.02 Condition (1′)

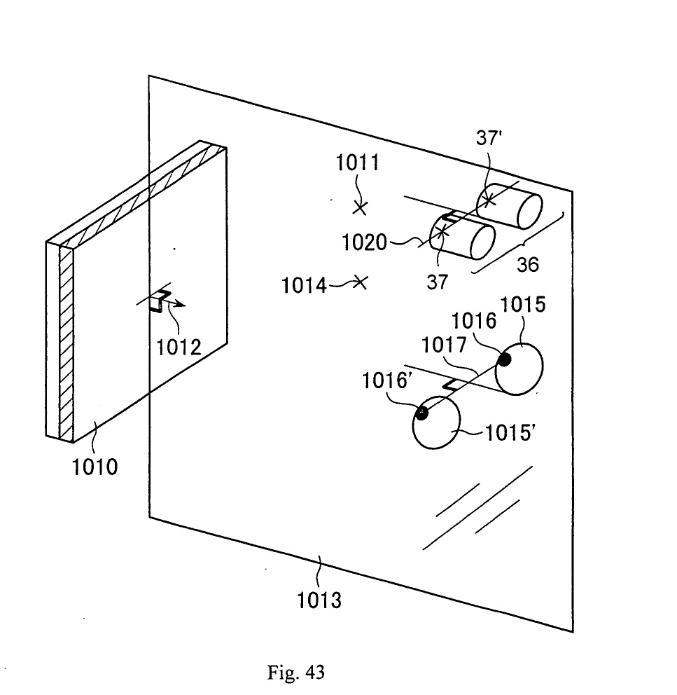

The present invention will now be described further, with reference to FIG. 43.

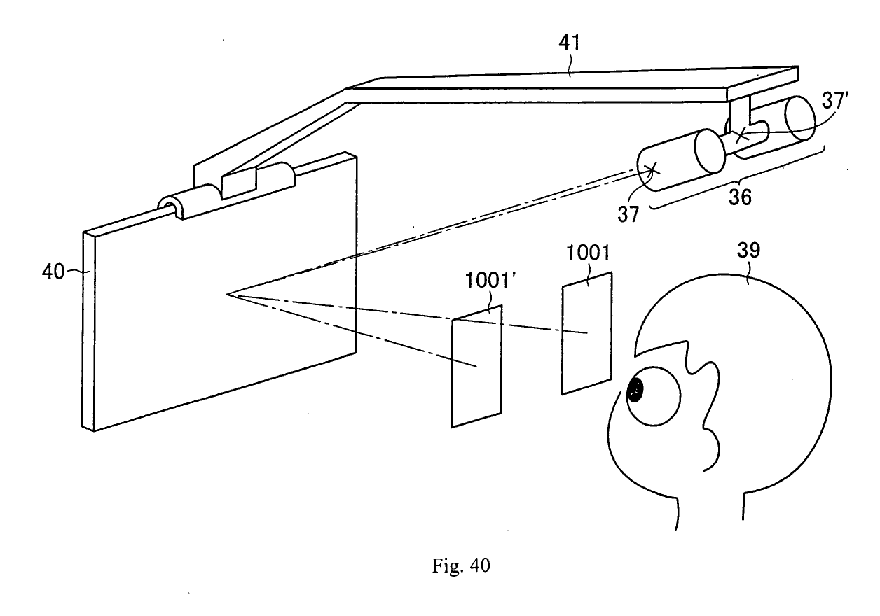

As shown in FIG. 43, a plane 1013 may be defined by the center 1011 of the light-emitting surface of a light source among plural light sources for exposing a hologram recording material 1010 to light and the normal line 1012 of the hologram recording material 1010. The center 1014 of the light-emitting surface of the other light source is positioned so as to be within the plane 1013. As can be seen, the plane 1013 is substantially orthogonal to a line that connects the respective centers 1016 and 1016′ of both eyes 1015 and 1015′ of an observer. The plane 1013 is also substantially orthogonal to a line 1020 that connects the two exit pupil centers 37 and 37′ of the image projection means 36. With such a structure, light will be diffracted and diffused by the hologram-type, diffractive optical element vertically with respect to the observer. Therefore, as shown in FIG. 40, the exit pupil 37 of the image projection means 36 that projects a right-eye image is enlarged and projected by the panel 40 that is formed of a hologram-type, diffractive optical element and a Fresnel concave mirror so as to produce an enlarged exit pupil 1001 that is conjugate to the exit pupil 37 within which the image for the right eye of an observer 39 who stands facing the front of the panel 40 may be observed. The exit pupil 37′ of the image projection means 36 that projects a left-eye image is likewise enlarged and projected so as to produce an enlarged exit pupil 1001′ that is conjugate to the exit pupil 37′ within which the image for the left eye of the observer 39 may be observed. By the above construction, an observer is able to readily observe three-dimensional images without wearing glasses.

The hologram-type, diffractive optical element having the structure of the present invention has optical power that is less than the optical power of the Fresnel concave mirror.

The angle subtended by the centers of two light sources as measured from the coherent light recording surface of a hologram recording material will now be described.

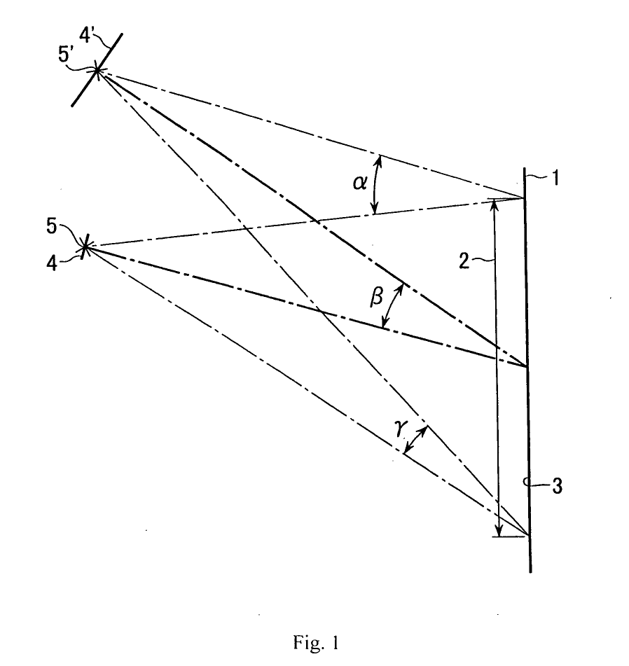

FIG. 1 shows a hologram recording material 1, an exposed area 2 of the hologram recording material, a coherent light recording surface 3 in the exposed area, two coherent light sources 4 and 4′, and their centers 5 and 5′.

The angle subtended by the centers of the two light sources as measured from the coherent light recording surface of a hologram recording material is an angle made by lines that connect any point on the hologram recording material to the centers of the light emitting surfaces of the light sources. In FIG. 1, α, β, and γ are examples of such angles.

As shown in FIG. 2, with the structure of the present invention, the difference in the diffraction angle due to dispersion caused by the hologram-type, diffractive optical element 19 for a light ray of wavelength 450 nm versus that of 650 nm is the angular dispersion amount 7. Thus, high efficacy of light observation can be obtained since the angular dispersion amount is relatively small.

The hologram-type, diffractive optical element of the present invention uses two interfering light beams to expose a hologram recording material to light flux from two coherent light sources. Each of the two light sources must be coherent but can conceivably comprise plural light sources with their light emitting surfaces arranged nearby one another. In such a case, the center of the light-emitting surface is the center of the combined light emitting surfaces of plural light sources arranged close to one another.

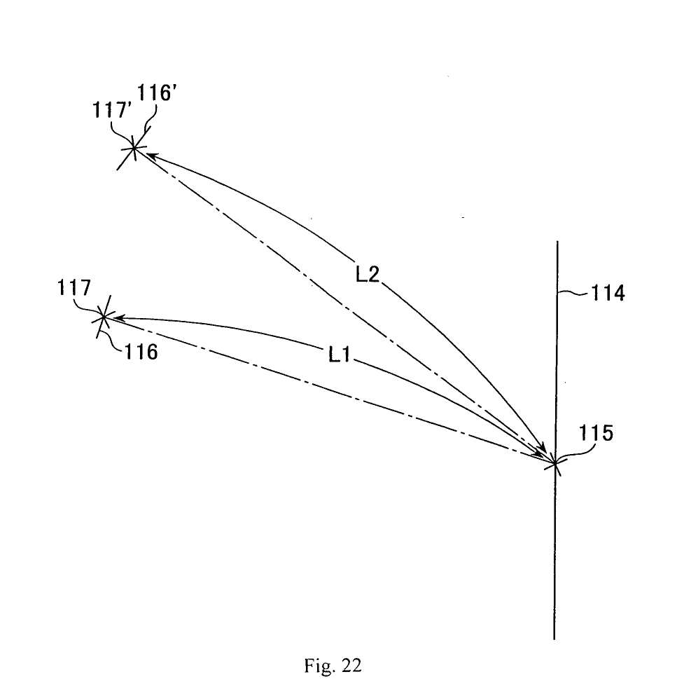

The values L1 and L2 of the present invention will now be described with reference to FIG. 22. FIG. 22 shows a hologram recording material 114, the center 115 of the exposed area of the hologram recording material, a first light source 116, the center of the light emitting surface of the first light source 117, a second light source 116′, and the center of the light emitting surface of the second light source 117′. L1 is defined as the distance between the exposed area center 115 of the hologram recording material 114 and the light emitting surface center 117 of the first light source. Similarly, L2 is defined as the distance between the exposed area center 115 of the hologram recording material 114 and the light-emitting surface center 117′ of the second light source. Because both L1 and L2 are relatively distant, preferably 50 mm or more from the optical recording material, the hologram-type, diffractive optical element that is exposed to (reconstruction) light under the conditions of the present invention has little optical power in terms of functioning as a lens and instead acts as a diffuser. The hologram diffracts incident light into the first-order beams (by an amount which varies with wavelength and with the angle subtended by the center points 117 and 117′ of the light used to record the hologram) but the distances L1 and L2 are such that the optical power of the hologram to converge light is less than the optical power of the concave Fresnel mirror. In the arrangement of FIG. 22, it is desirable to satisfy the following Condition (2):
0.9<L1/L2<1.11 Condition (2)

The hologram-type, diffractive optical element of the present invention uses interference exposure of the hologram recording material to coherent light to produce a hologram. Generally, in order to obtain two coherent light sources in the visible region, the light from a single light source must be split and the difference in the path lengths from the point that the light is split must not exceed the coherence length of the light, which varies inversely with the bandwidth of the light source used. It is known however that by self-coupling of two or more light sources, that plural independent light sources can be made to produce light that is coherent so as to produce an interference effect having stationary nodes provided the plural light sources are arranged nearby one another. In such a case, the “center of the light emitting surface” as referred to herein means the center of the combined light emitting surfaces of the plural light sources that are arranged nearby one another so that self-coupling occurs.

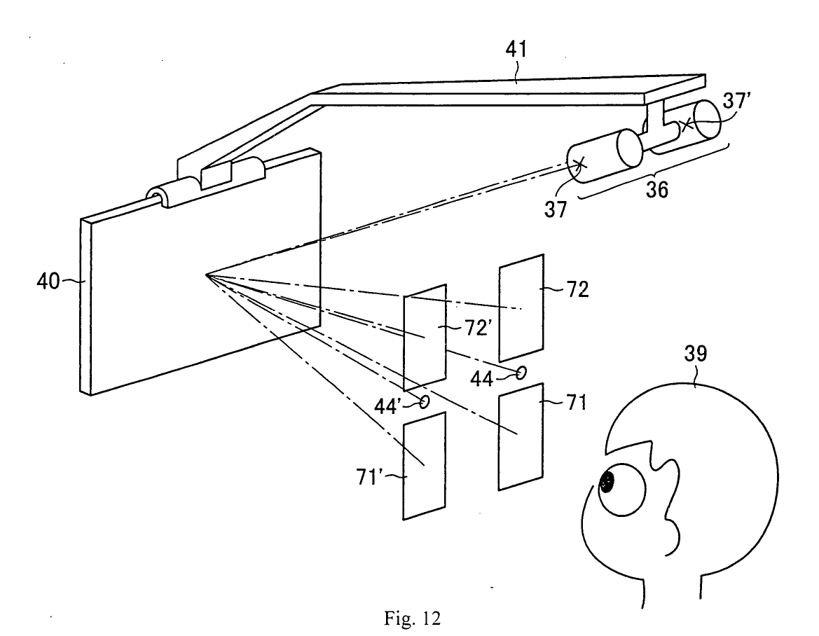

When exposed to reconstructive light, preferably time-reversed wave fronts similar to the wave fronts from the first light source 116 in FIG. 22, the hologram-type, diffractive optical element having the structure of the present invention produces plus first-order, enlarged exit pupils 71 and 71′ and minus first-order, enlarged pupils 72 and 72′ that are elongated as shown in FIG. 12 due to wavelength dispersion of the hologram.

It is desirable that the plus first-order, enlarged exit pupils and that the minus first-order, enlarged exit pupils both be large in order to give more freedom of position with regard to the posture of the observer. However, when the projected exit pupils 73 are simply enlarged as shown in FIGS. 13(a) and 13(b), one enlarged exit pupil extends over both eyes 75, 75 of the observer 39. This causes the phenomenon known as crosstalk wherein an image that should be observed only with the right eye is seen with the left eye, and vice-versa.

As shown in FIG. 14, in the present invention the enlarged exit pupils 76 are elongated vertically to the observer 39, which prevents the crosstalk and yet provides more freedom of position to the observer in observing.

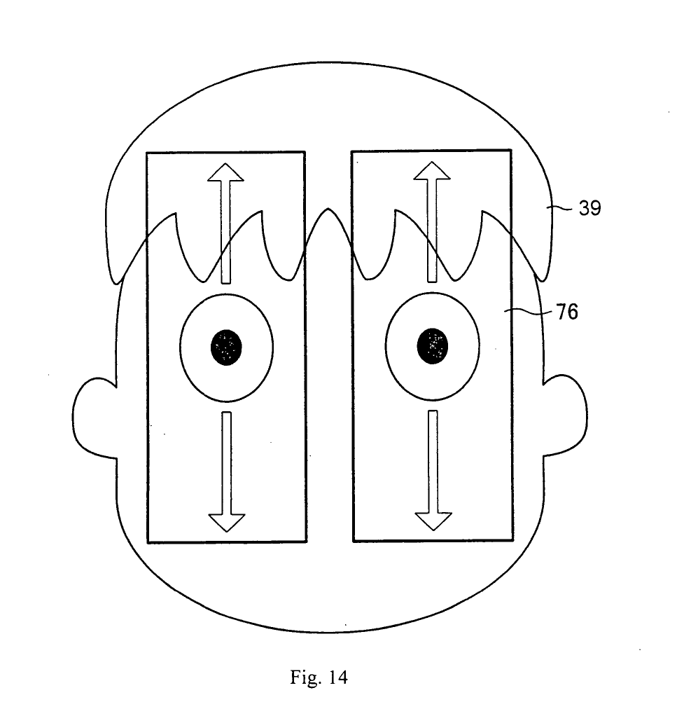

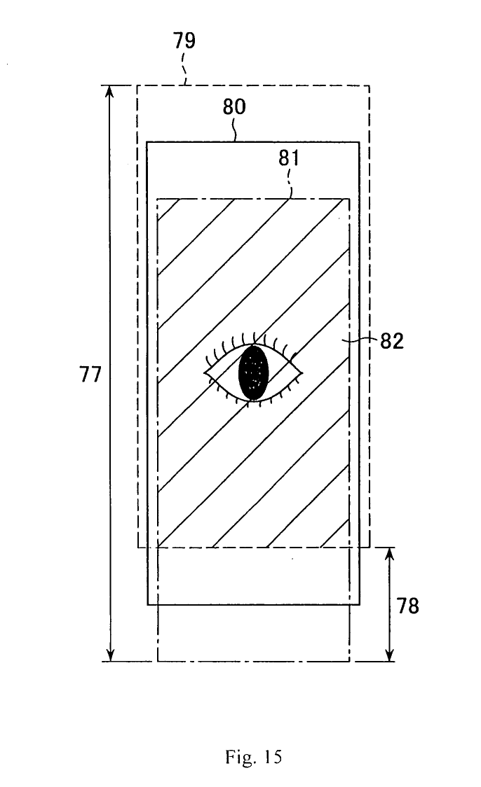

Referring to FIG. 15, in the present invention the lengthwise direction 77 of the elongated, enlarged exit pupil is made to coincide with the direction 78 in which the enlarged exit pupils are shifted in association with the wavelength dispersion caused by the hologram-type, diffractive optical element. Therefore, the overlapping area 82 of the enlarged exit pupils 79-81 for different wavelengths is increased. Hence, the observer is able to observe images in their correct colors over an extended area.

It is desirable that the elongated light emitting surface of the second light source have an area of 5000 mm² or greater in order to obtain greater efficacy of the hologram-type, diffractive optical element that functions as a light diffuser. It is further desirable that the light-emitting surface of the first light source has an area of 100 mm² or smaller in order to not produce unnecessary diffracted light.

The hologram-type, diffractive optical element of the present invention uses interference exposure of the hologram recording material to light fluxes from two coherent light sources in order to create a diffuser. As discussed above, each of the two light sources may comprise plural light sources with their light emitting surfaces arranged nearby one another so that self-coupling occurs and thus, the two light sources become able to produce light interference patterns whose standing waves are stationary, thereby allowing the interference pattern to be recorded as a hologram. In such a case, the ‘lengthwise direction’ of the light-emitting surface of a light source refers to the lengthwise direction of the combined light emitting surfaces of the plural light sources that are arranged nearby one another.

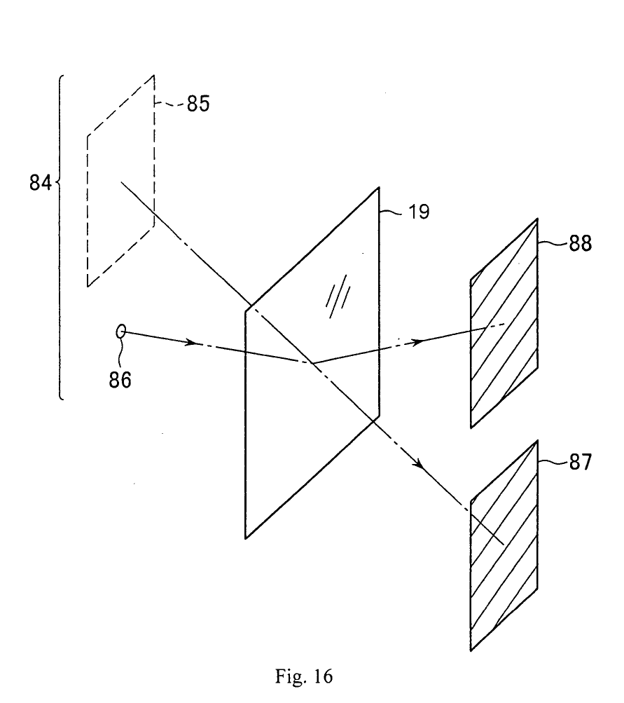

The plus and minus first-order reconstructed beams from an elongated light source of the present invention will now be described with reference to FIG. 16, which shows a hologram-type, diffractive optical element 19. When the hologram-type, diffractive optical element 19 is exposed to light flux from a light source 86, which is different from an elongated light source 85, among two coherent light sources 84 used to make the hologram-type, diffractive optical element, a plus first-order reconstructed beam 87 and a minus first-order reconstructed beam 88 of the elongated light source 85 will be produced on the far side of the hologram-type, diffractive optical element 19.

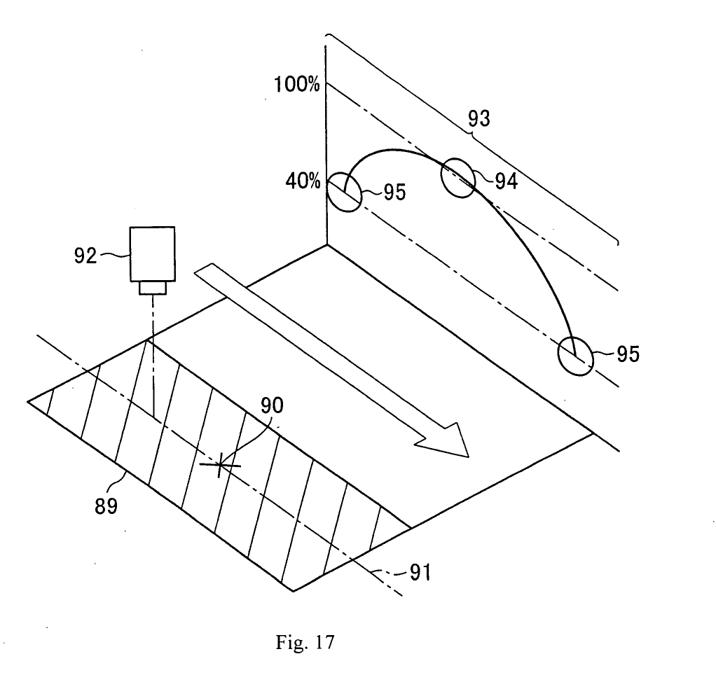

As shown in FIG. 17, the diffracted light intensity profile 93 of an image shown in FIG. 16 shows that at least one of the plus first-order image and the minus first-order image has a diffracted light intensity 95 at the periphery of the image that is 40% or greater than that provided at the diffracted light intensity 94 at the image center 90 when measured by a diffracted light intensity meter 92 along the line 91 that passes through the center of an image 89 and is parallel to the length of the image.

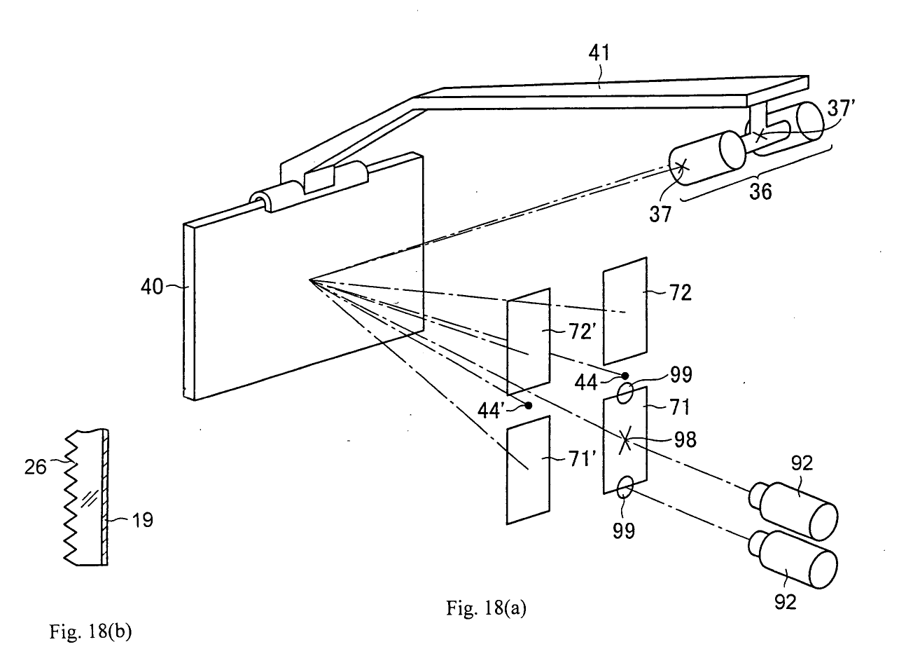

When the hologram-type, diffractive optical element described above is used in the apparatus shown in FIG. 18(a), the plus first-order, enlarged exit pupils 71 and 71 ′ or the minus first-order, enlarged exit pupils 72, 72′ that are projected by the hologram-type, diffractive optical element 19 and the Fresnel concave mirror 26 (enlarged in FIG. 18(b)) can maintain a diffracted light intensity 95 at the periphery in the lengthwise direction of 40% or greater in relation to the diffracted light intensity 94 at the center.

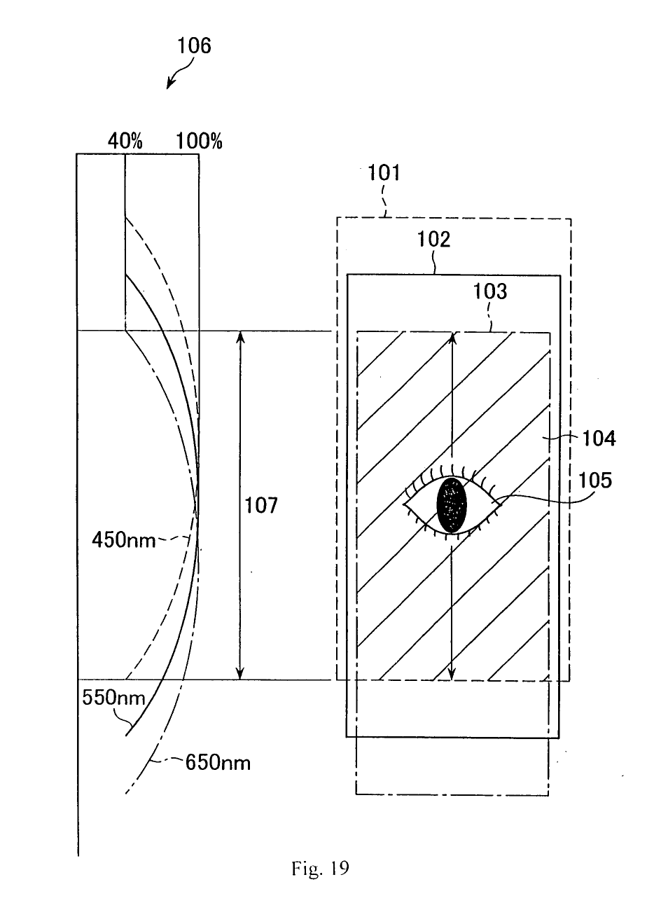

As shown in FIG. 19, the projected positions of the enlarged exit pupils 101, 102, and 103 for different wavelengths are shifted because of the wavelength dispersion caused by the hologram-type, diffractive optical element. The diffracted light intensity at the extreme periphery in the lengthwise direction within an enlarged exit pupil for each wavelength is at least 40% or more relative to that at the center. Thus, as shown in the diffracted light intensity profile 106, the differences in diffracted light intensity for different wavelengths are no more than 60% in the overlapping area 107 of the enlarged exit pupils.

With the above conditions being satisfied, it has been proven in experiments that images can be observed without concern about color changes of the observed images wherever the observer's eye 105 is within the overlapping area of the enlarged exit pupils for the different wavelengths. Hence, the observer is able to set his/her eyes anywhere within the overlapping area of the enlarged exit pupils for the different wavelengths and observe images in optimized colors without compromising his/her freedom of position.

As shown in FIG. 20, a diffracted light intensity curve 110 shows that at least one of the plus first-order diffracted light and the minus first-order diffracted light has an intensity 112 at the periphery in the width direction that is at least 60% relative to that of the diffracted light intensity 111 at the beam center 107 when measured by a light intensity meter 92 along a line 108 that passes through the flux center 107 of an enlarged exit pupil 109 and is parallel to the width of the enlarged exit pupil.

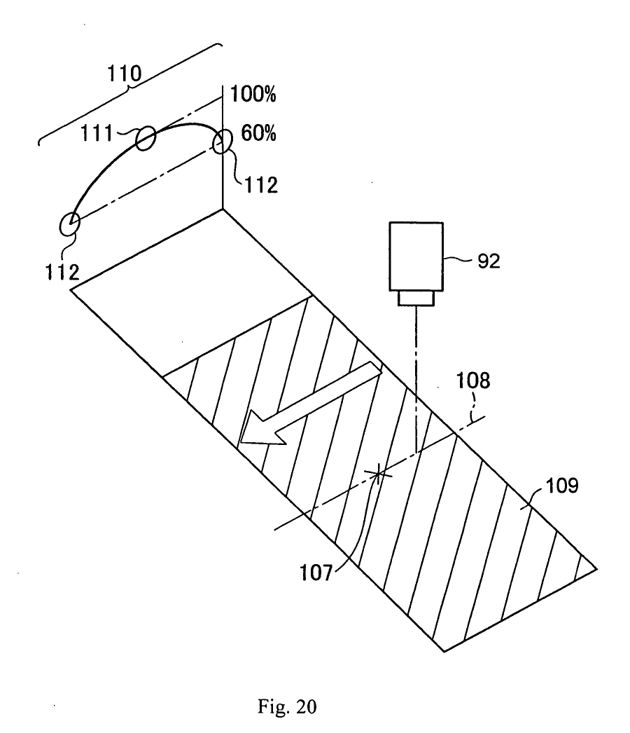

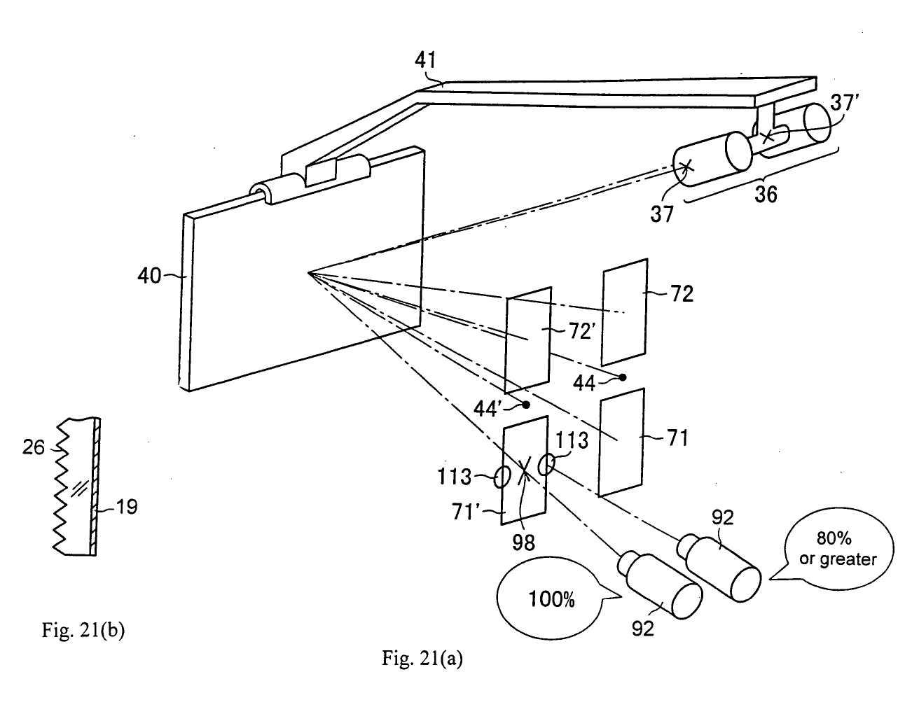

When the hologram-type, diffractive optical element described above is used in the apparatus shown in FIG. 21(a), the plus first-order, enlarged exit pupils 71 and 71′ and the minus first-order, enlarged exit pupils 72 and 72′ that are projected by the hologram-type, diffractive optical element 19 and the Fresnel concave mirror 26 (shown enlarged in FIG. 21(b)) can maintain a diffracted light intensity at the periphery 113 in the width direction of 60% or greater relative to that of the diffracted light intensity at the center 98 of the enlarged exit pupil.

With the above conditions being satisfied, it has been shown in experiments that images can be observed without concern about changes in their brightness when the observer's eye is placed at the plus or minus first-order, enlarged exit pupils. Hence, the observer is able to position his eyes anywhere within these enlarged exit pupils and to observe images with a proper brightness without compromising his freedom of position in observing the images.

With the structure of the present invention, when the three-dimensional observation apparatus is used during surgery in particular, the Fresnel concave mirror that is positioned nearby a surgical site is maintained in a sterilized state. Thus, there is no need to cover the hologram-type, diffractive optical element on which an image is projected by the image projection means with an additional sterilized drape. Light is transmitted through the sterilized drape, thereby preventing deterioration of images to be observed.

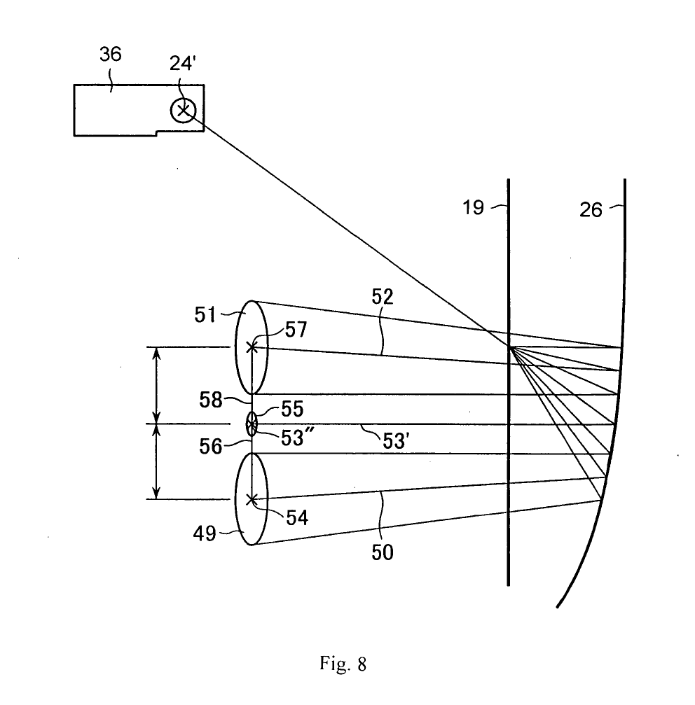

The exit pupils projected by the plus first-order light, the zero-order light, and the minus first-order light will now be described with reference to FIG. 8.

FIG. 8 shows an image projection means 36, an exit pupil 24′ of the image projection means, a hologram-type, diffractive optical element 19, and a Fresnel concave mirror 26. In addition, the figure also shows: a plus first-order, enlarged exit pupil 49 that has been enlarged and projected via a plus first-order, diffused light flux around a light ray 50 that has passed through the hologram-type, diffractive optical element; a minus first-order, enlarged exit pupil 51 that has been enlarged and projected via a minus first-order, diffused light flux around a light ray 52 that has passed through the hologram-type, diffractive optical element; and a zero-order exit pupil 55 that has been projected from a zero-order light flux 53′ that has passed through the hologram-type, diffractive optical element. FIG. 8 also shows: the center 54 of a pupil projected from the plus first-order, diffused light flux; the center 53″ of a pupil projected from the zero-order light flux; and the center 57 of a pupil projected from the minus first-order diffused light flux.

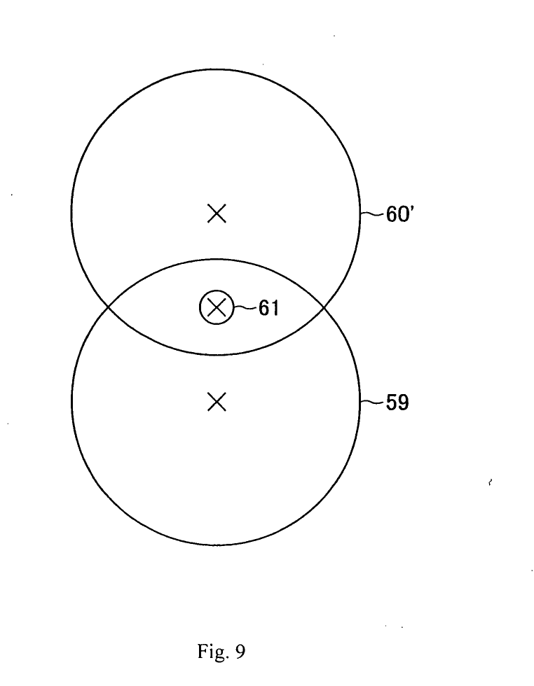

As shown in FIG. 9, when the centers of the respective pupils are not positioned to satisfy the conditions of the present invention, a plus first-order, diffused (i.e., enlarged) exit pupil 59, a minus first-order, diffused (i.e., enlarged) exit pupil 60′, and zero-order exit pupil 61 overlap as illustrated, giving less freedom of eye position to the observer. When the observer's eye overlaps the zero-order exit pupil 61, the observer may be dazzled by too much brightness when certain viewing directions are observed because the light in the zero-order exit pupil 61 has not been diffused (as by, for example, scattering) and thus the light intensity viewed within this region will be great. In the present invention, as discussed above, the freedom of eye position of the observer is maintained and images can be observed without interference by the zero-order light as will now be discussed in more detail in the following paragraphs.

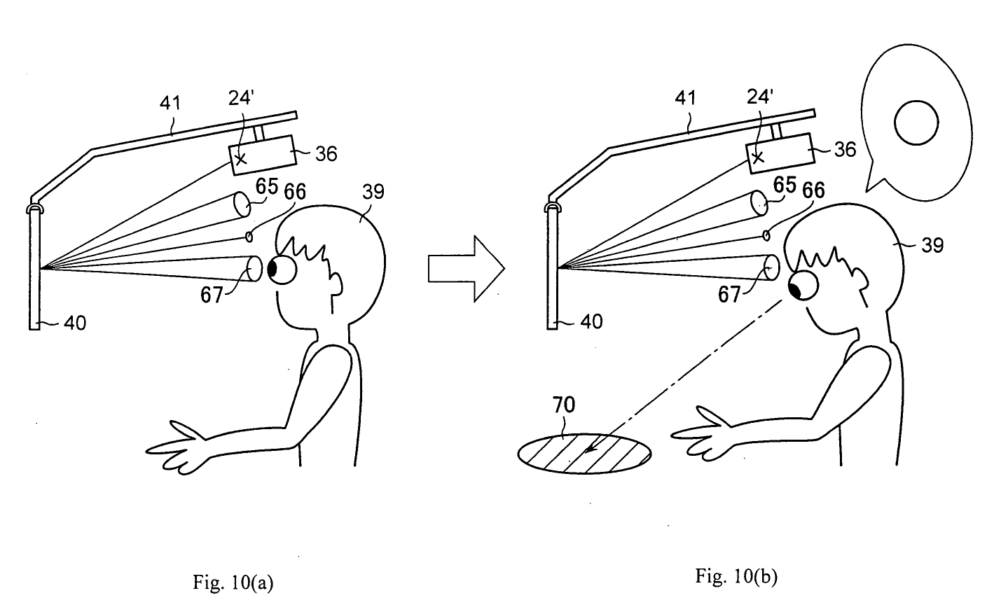

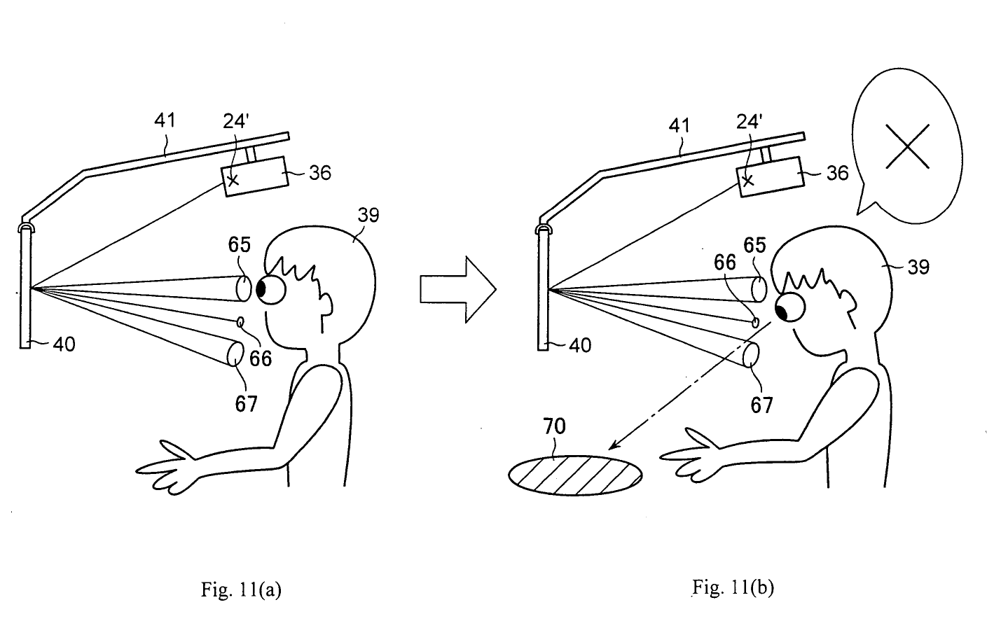

FIG. 10(a) shows an image projection means 36, a panel 40 that is formed of a hologram-type, diffractive optical element and a Fresnel concave mirror, and a holding means 41 for holding the image projection means and the panel. FIG. 10(a) also shows:(a) a plus first-order, enlarged exit pupil 67 that is the conjugate to an exit pupil 24′ as formed by the panel 40;(b) a zero-order pupil 66 that is the conjugate to the exit pupil 24′ as formed by the panel 40; and (c) a minus first-order, enlarged exit pupil 65 that is the conjugate to an exit pupil 24′ as formed by the panel 40. According to the present invention, the plus first-order, enlarged exit pupil 67 is positioned so that an observer approaching the display panel will first observe the plus first-order, enlarged exit pupil 67. This is advantageous for the reason that will now be described with reference to FIGS. 10(a)-11(b).

FIGS. 10(a) and 10(b) show the structure of Embodiment 3 when designed so that the exit pupil formed by the plus first-order light beam is first viewed by a viewer who approaches the panel 40 for viewing, with FIG. 10(a) illustrating an observer while observing the projected plus first-order images, and with FIG. 10(b) illustrating an observer who rotates his view downward to view a region 70. With this structure, as shown in FIG. 10(b), when the observer 39 looks downward from the direction of the panel 40 to see the region 70, there is no problem in clearly seeing the region 70.

FIGS. 11(a) and 11(b) show the situation when the structure of Embodiment 3 is modified so that the minus first-order, enlarged exit pupil 65 is first viewed by a viewer who approaches the panel 40 for viewing. In FIG. 11(a), the observer 39 observes images projected on the panel starting with the minus first-order, enlarged exit pupil 65 closest to the image projection means 36. With this structure, as shown in FIG. 11(b), when the observer 39 looks downward from the direction of the panel 40 to see the region 70, he must look through the zero-order light beams and the plus first-order light beams that carry the zero-order light exit pupil 66 and the enlarged plus first-order exit pupil 67. This is disadvantageous in that dust or smoke particles in the air may scatter light to the observer's eye and make it more difficult to clearly see the region 70. Thus, according to an advantageous feature of the present invention as shown in Embodiment 3, the observer is able to observe regions in his working space (such as the region 70) without scattered light from such airborne particles obscuring his view.

Various embodiments of the invention will now be explained in detail.

### Embodiment 1

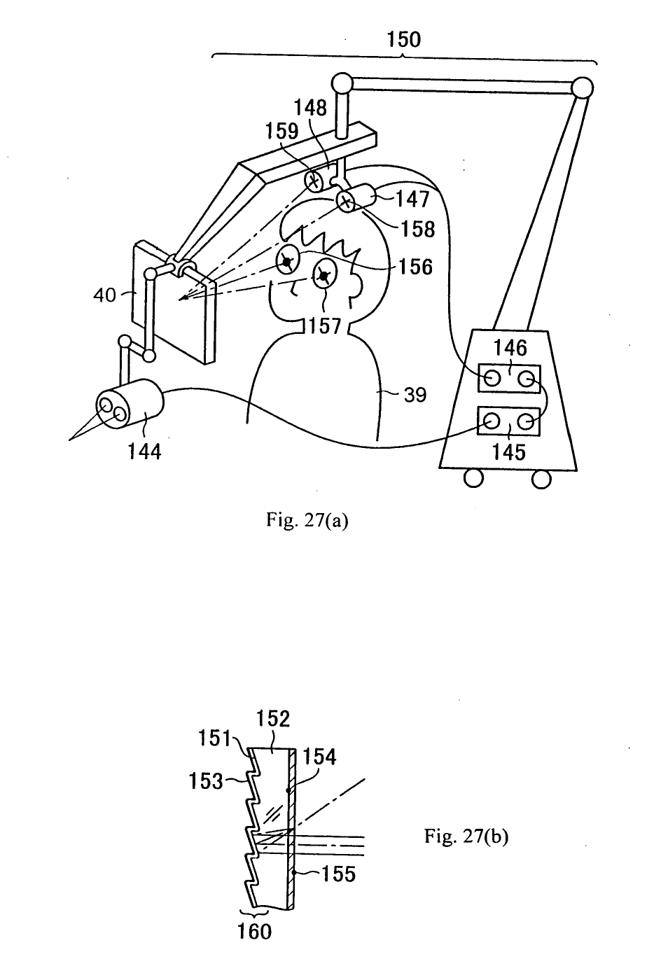

FIGS. 27(a) and 27(b) show Embodiment 1 of a three-dimensional observation apparatus according to the present invention. The figures illustrate: an observer 39; a surgical stereo microscope 144 for picking up two images having parallax with respect to each other; a camera control unit 145 for controlling a CCD incorporated in the surgical stereo microscope and transferring the two images to an image display device; an LCD controller 146; a panel 40 that is formed of a holographic optical element 155 that functions as a diffuser and a Fresnel concave mirror 160; and a holding unit 150 for holding the surgical stereo microscope 144, the image projectors 147 and 148, the panel 40, the camera control unit 145, and the LCD controller 146.

The LCD controller 146 controls the small LCD's incorporated in the image projectors 147 and 148 so as to enable different images for each eye to be separately transferred to the right-eye image projector 147 and the left-eye image projector 148. The panel 40 is an acrylic panel 152 having a Fresnel lens surface 151 on one side. The Fresnel lens surface 151 is provided with an aluminum mirror coating 153. The panel 40 has a flat surface 154 on the side opposite the Fresnel lens surface. With the flat surface 154 facing the observer 39, the Fresnel lens surface with the aluminum mirror coating serves as a Fresnel concave mirror. The holographic optical element 155 that serves as a diffuser is applied to the flat surface 154.

The holding unit 150 holds the panel and image projectors in a manner such that the exit pupil 158 of the right-eye image projector 147 is conjugated to a proper position with respect to the viewer's right eye 156 by the panel 40 and in a manner such that the exit pupil 159 of the left-eye image projector 148 is conjugated to a proper position with respect to the viewer's left eye 157 by the panel 40. Furthermore, the holding unit 150 holds the panel and image projectors in a manner such that the two light fluxes projected by the image projectors 147 and 148 substantially coincide on the surface of the panel 40. Thus, the exit pupils 158 and 159 of the image projectors are enlarged and projected near the right and left eyes of the observer by the combined effects of the holographic optical element 155 that functions as a diffuser and the Fresnel concave mirror 160 of the panel 40.

With the structure above, the observer can observe right-eye and left-eye images detected by the surgical stereo microscope with his right and left eyes, respectively. Thus, an observer can observe three-dimensional images without wearing glasses.

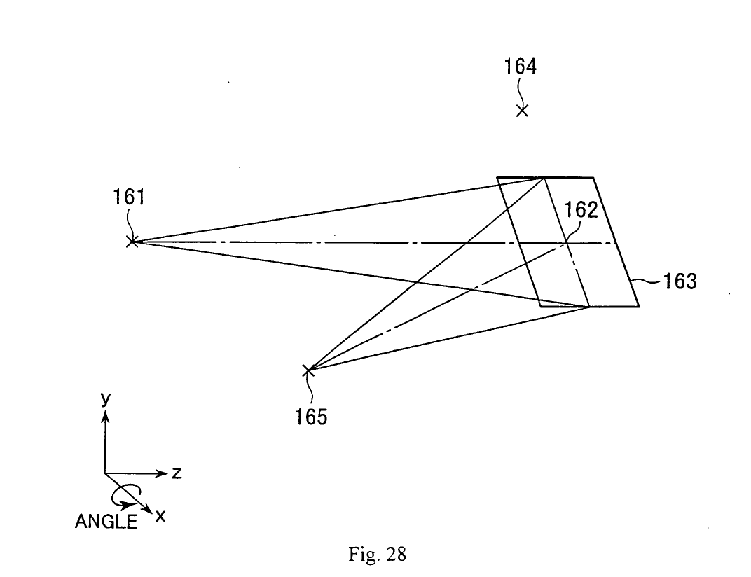

FIG. 28 is a schematic diagram, in perspective view, of the geometry of the optical system of the present embodiment. This figure illustrates: an exit pupil position of the right-eye image projector 161; the center position 162 of the panel; an effective area 163 of the panel; the center position 164 of the Fresnel concave mirror; and the pupil position 165 of the observer.

Table 1 below lists the surface number, in order from the object side, the type of surface/radius of curvature, the eccentricity type, as well as the index of refraction Nd and Abbe number Ud (both measured relative to the d-line) of the optical elements of the optical system of Embodiment 1. In the middle portion of the table are listed the details of the four eccentricity types. In the bottom portion of the table, is listed the radius of curvature of the Fresnel concave mirror surface.

TABLE 1

| | | Type of | | |
|---|---|---|---|---|
| # | (Surface type or R) | eccentricity | N_{d} | υ_{d} |
| (right-eye image | ∞ | | | |
| projector exit | | | | |
| pupil surface) | | | | |
| 1 | (hologram diffuser) | (1) | 1.49 | 57.4 |
| 2 | (image projection | (2) | 1.49 | 57.4 |
| | surface) | | | |
| 3 | (aspheric) | (3) | 1.49 | 57.4 |
| 4 | ∞ | (1) | | |
| (observer pupil | ∞ | (4) | | |
| surface) | | | | |

| | | | |
|---|---|---|---|
| Type of eccentricity (1): | Angle = 25° | Y = 0.00 | Z = 650 |
| X = 46.944 | | | |
| Type of eccentricity (2): | Angle = 25° | Y = 0.423 | Z = 650.906 |
| X = 46.944 | | | |
| Type of eccentricity (3): | Angle = 25° | Y = 157.23 | Z = 577.786 |
| X = 46.944 | | | |
| Type of eccentricity (4): | Angle = 25° | Y = −190.178 | Z = 242.161 |
| X = 79.444 | | | |

The radius of curvature of the Fresnel concave mirror surface equals −407.451.

As noted in Table 1 above, surface # 3 is aspheric, with its surface defined by the following Equation (A):
z=Cr²/[1+{1−(1+k)C²r²}^{1/2}]+ar⁴+br⁶+cr⁸ Equation (A)
where

z is the length (in mm) of a line drawn from a point on the aspheric surface at a distance r from the optical axis to the tangential plane of the aspheric surface vertex,

C is the curvature (=1/the radius of curvature, R) of the aspheric surface on the optical axis,

r is the distance (in mm) from the optical axis (i.e., r=(X²+y²)^{1/2}), where x and y are Cartesian coordinates about the optical axis z,

k is the conic coefficient, and

a b, and c are aspheric coefficients.

Table 2 below lists the values of k, a, b, and c used in Equation (A) above for surface #3, based on the assumption that the point 161 in FIG. 28 is the origin and the directions shown by the arrows in FIG. 28 are positive. An “E” in the data indicates that the number following the “E” is the exponent to the base 10. For example, “1.0E-2” represents the number 1.0×10⁻².

TABLE 2

k = −58.103
a = −7.513E−9
b = 7.58E−14
c = −3.148E−19

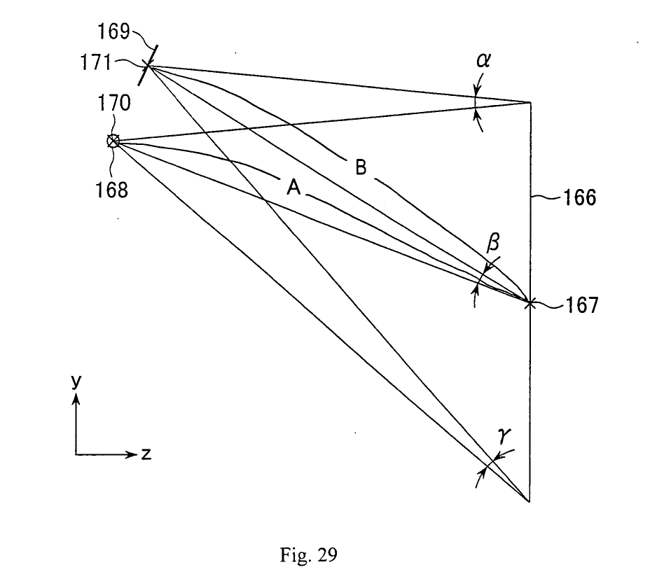

FIG. 29 illustrates the exposure conditions of the hologram diffuser of this embodiment. This figure shows: a hologram recording material 166; the center of the exposure surface of the hologram recording material 167; a first light source 168; a second light source 169; the center point of the first light source 170; and the center point of the second light source 171. When the exposure surface center 167 of the hologram recording material is taken as the origin, the coordinates (X1, Y1, Z1) of the first light source, which is a point source of light, are as follows:
X1=0
Y1=297.11
Z1=−578.12

The coordinates of the center position (X2, Y2, Z2) of the second light source, where the second light source is a diffusing surface light source are:
X2=0
Y2=435.317
Z2=−482.718

The angles α, β, and γ y between the center point of the first light source 170 and the center point of the second light source 171 as subtended from the positions shown on the exposure surface of the hologram recording material are all less than 15°. Preferably these angles should be less than or equal to 20°.

Thus, the hologram diffuser has a weak light deflecting power with regard to bending of the incident light. As a result, wavelength dispersion of light transmitted through the hologram diffuser is reduced to 5° or less. Furthermore, the exit pupils of the image projectors are conjugated by the panel consisting of the hologram diffuser and the Fresnel concave mirror to observation exit pupils having reduced shifts and an increased overlapping area for different wavelengths of the observation exit pupils. Thus, the observer experiences good freedom of eye position and little fatigue during observation.

In FIG. 29, the distance A between the exposure surface center 167 of the hologram recording material and the first light source center 170 is exactly equal to the distance B between the exposure surface center 167 of the hologram recording material and the second light source center 171. The hologram diffuser produced under this condition has only a diffraction effect and substantially no optical power such as provided by a lens for converging or diverging light. A Fresnel concave mirror having an optical power of 0.0025 diopter serves to converge the light and thereby form the observation exit pupils.

The three-dimensional observation apparatus of this embodiment provides observation exit pupils that do not vary in size for different wavelengths. Thus, a greater overlapping area of the enlarged exit pupils for observation is ensured, and the observer has good freedom of eye position and experiences little fatigue during observation.

### Embodiment 2

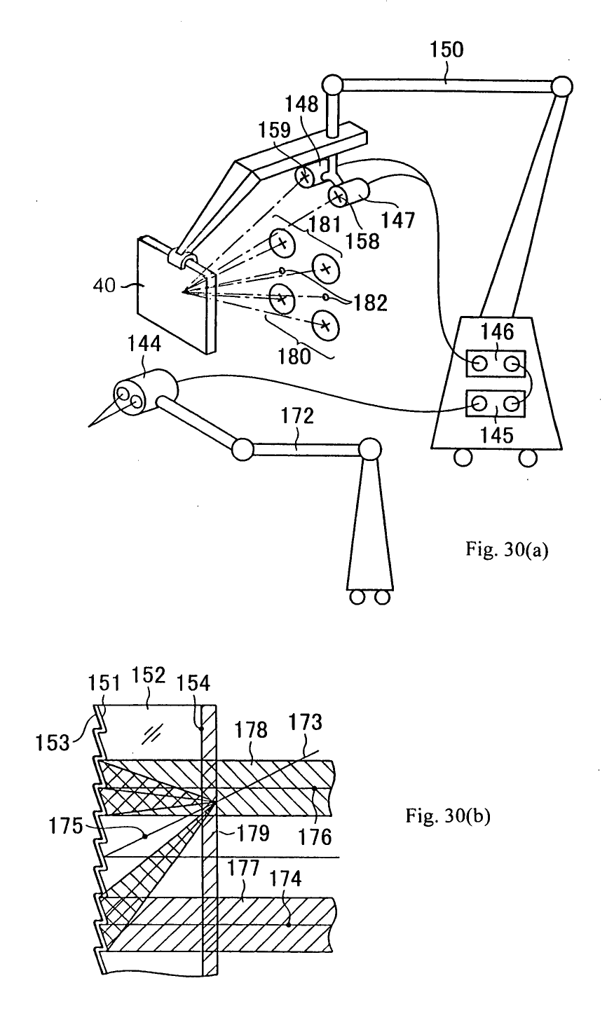

FIGS. 30(a) and 30(b) show the three-dimensional observation apparatus of Embodiment 2. These figures show: a surgical stereo microscope 144 for picking up two images having parallax; a surgical stereo microscope holding unit 172 for holding the surgical stereo microscope; a camera control unit 145 for controlling a CCD incorporated in the surgical stereo microscope and for transferring the two images having parallax to a display device; and an LCD controller 146 for separately transferring the two images transferred from the camera control unit to a right-eye image projector 147 and a left-eye image projector 148 and for controlling respective small LCDs incorporated in the image projectors 147 and 148.

FIGS. 30(a) and 30(b) also show: a panel 40 that is formed of a hologram-type, diffractive optical element and a Fresnel concave mirror; a holding unit 150 for holding the image projectors 147 and 148, and the panel 40. The holding unit 150 is attached to a movable base housing that holds the camera control unit 145, and the LCD controller 146. Referring to the expanded portion of the figure (FIG. 30(b)), the panel 40 is an acrylic panel 152 having a Fresnel lens surface 151 on one side that is provided with an aluminum mirror coating 153, and a flat surface 154 on the opposite side. With the flat surface 154 facing the observer, the Fresnel lens surface with the aluminum mirror coating serves as a Fresnel concave mirror. A hologram diffuser 179 is applied to the flat surface 154 so as to split a light flux 173 that is incident onto the flat surface 154 into three light fluxes, namely, minus first-order, zero-order, and plus first-order light fluxes 176, 175, and 174, respectively. The plus and minus first-order light fluxes form scattered light fluxes 177 and 178. The respective exit pupils 158 and 159 of the image projectors are imaged (i.e., conjugated) by the panel 40 as plus first-order, enlarged exit pupils 180, 180, minus first-order enlarged exit pupils 181, 181, and zero-order exit pupils 182, 182.

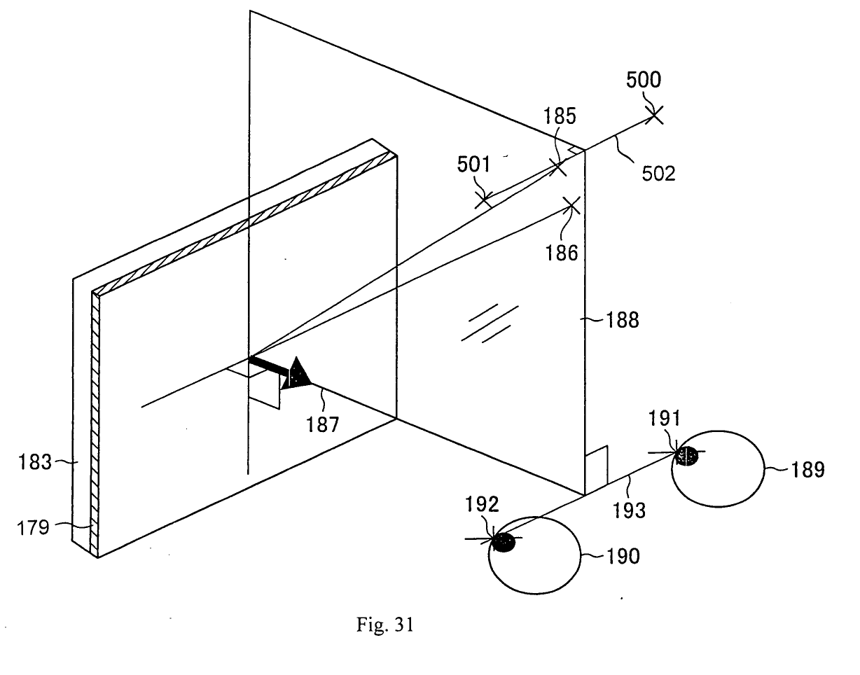

As shown in FIG. 31, a hologram diffuser 179 is provided on a generally planar or slightly curved substrate 183 such that a plane 188 that includes the normal line 187 and two light sources 185 and 186 for exposure is substantially orthogonal to a line that connects the centers 191 and 192 of the pupils of both eyes 189 and 190 of an observer and the plane 188 is substantially orthogonal to a line 502 that connects the centers 500 and 501 of the right and left exit pupils of the image projectors.

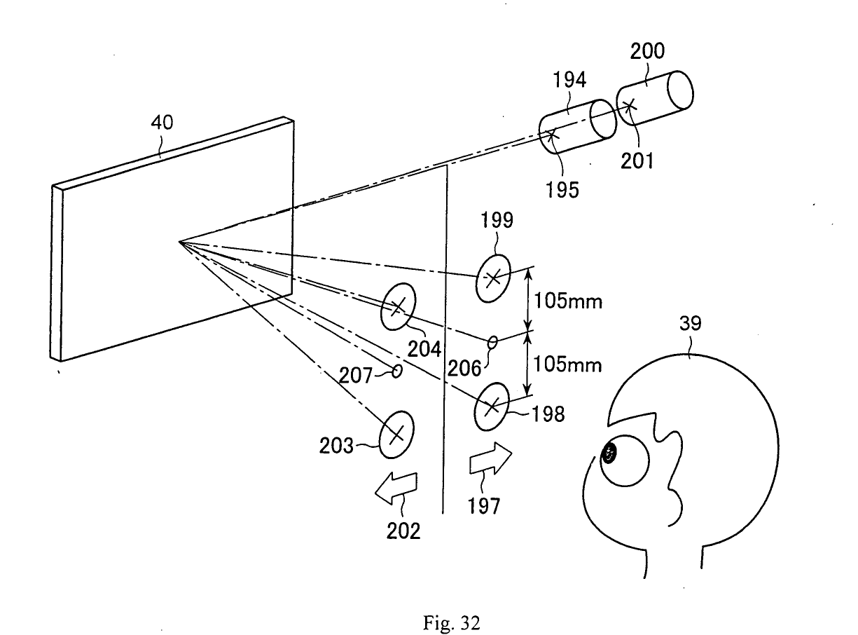

As shown in FIG. 32, the structure shown in FIG. 31 enables an exit pupil 195 of the right-eye image projector 194 to be imaged by the hologram diffuser and Fresnel concave mirror to the right 197 of the observer 39 as a right-eye, plus first-order, enlarged exit pupil 198 and a right-eye, minus first-order, enlarged exit pupil 199. Likewise, the exit pupil 201 of the left-eye image projector 200 is imaged to the left 202 of the observer 39 as a left-eye, plus first-order, enlarged exit pupil 203 and a left-eye, minus first-order, enlarged exit pupil 204. Then, the observer can observe images projected on the panel 40 at two positions, namely, the plus first-order, enlarged exit pupils 198, 203 and the minus first-order, enlarged exit pupils 199, 204. This increases the freedom of posture during image observation and reduces fatigue. The centers 206 and 207 of zero-order exit pupils are also shown in FIG. 32. The distance between the zero-order exit pupil center 206 and the plus first-order, enlarged exit pupil center 198 is 105 mm, and the distance between the zero-order exit pupil center 206 and the minus first-order, enlarged exit pupil center 199 is also 105 mm.

Thus, the plus first-order, enlarged exit pupil, the zero-order exit pupil, and the minus first-order, enlarged exit pupil do not overlap with one another, as shown in FIG. 9. Hence, making best use of either pair of the plus first-order, enlarged exit pupils or the minus first-order, enlarged exit pupils, the observer is able to observe images with a proper brightness.

### Embodiment 3

FIGS. 10(a) and 10(b) show the three-dimensional observation apparatus of this embodiment. FIG. 10(a) shows an image projection means 36, a panel 40 integrally formed of a hologram-type, diffractive optical element and a Fresnel concave mirror, and a holding means 41 for holding the image projection means and the panel. These figures further show: a minus first-order, enlarged exit pupil 65 that is conjugate to the exit pupil 24′ of the image projection means; a zero-order exit pupil 66 that is conjugate to the exit pupil 24′ of the image projection means; a plus first-order, enlarged exit pupil 67 that is conjugate to the exit pupil 24′ of the image projection means; and an observer 39 who observes images projected on the panel.

The pupils are arranged so that the plus first-order, enlarged exit pupil 67 is first observed by an observer who approaches the panel. Thus, the observer observes images starting with the plus first-order, enlarged exit pupil 67. As mentioned above, such a design is advantageous as compared to the situation illustrated in FIGS. 11(a) and 11(b), in that airborne particles illuminated by the light will not tend to obscure clear viewing of the region 70, as occurs in FIG. 11(b).

### Embodiment 4

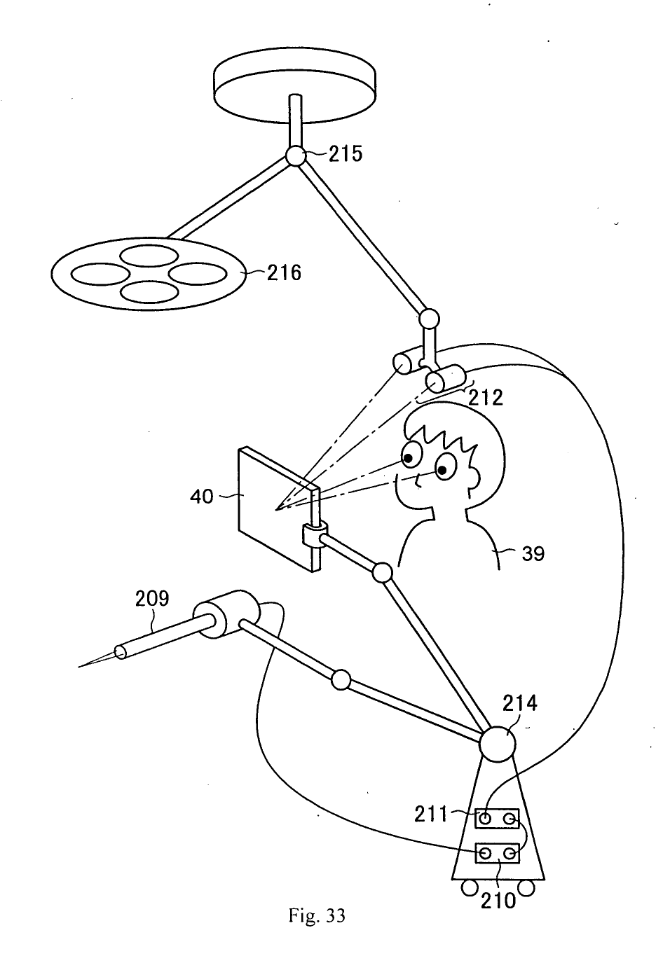

FIG. 33 shows the three-dimensional observation apparatus of this embodiment. This figure illustrates: an observer 39; a three-dimensional endoscope 209 for picking up two images having parallax; a camera control unit 210 for controlling a CCD incorporated in the three-dimensional endoscope and for transferring the two images to an image display device; and a DMD controller 211 for transferring the two images received from the camera control unit to an image projector 212 and for controlling a DMD (digital micro mirror device) incorporated in the image projector. FIG. 33 also illustrates: a panel 40 formed of a hologram-type, diffractive optical element and a Fresnel concave mirror; a floor-stand-type holding unit 214 for holding the three-dimensional endoscope 209, and the panel 40 relative to a moveable floor stand which supports the camera control unit 210, and DMD controller 211. In this embodiment, a ceiling suspension-type holding unit 215 for holding a surgical-room-type lamp 216 and the image projector 212 from the ceiling is provided.

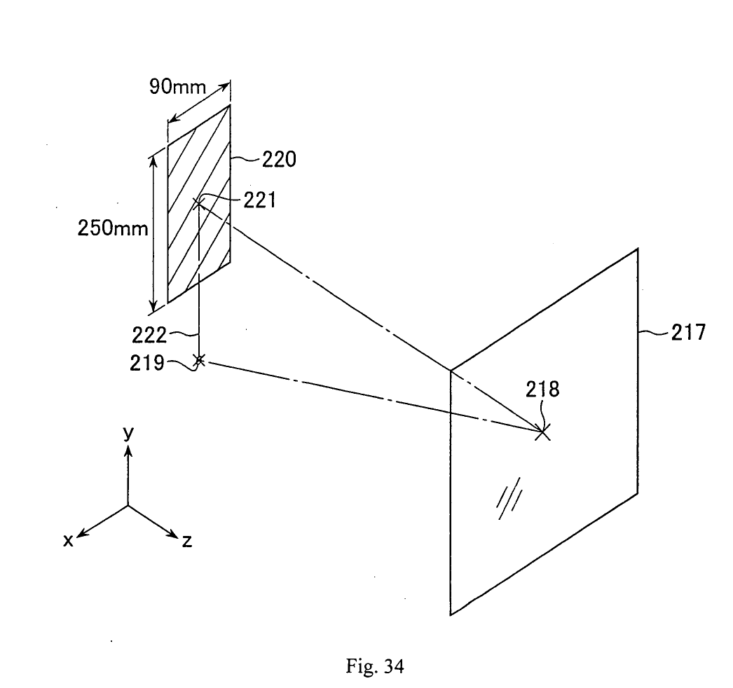

FIG. 34 shows the exposure condition geometry of the hologram diffuser of this embodiment. This figure shows: a hologram recording material 217; the center of the exposure surface of the hologram recording material 218; a first light source 219; a second light source 220, and the center of the second light source 221. When the exposure surface center 218 of the hologram recording material is taken as the origin, the coordinates (X1, Y1, Z1 ) of the first light source, which is a point light source, are:
X1=0
Y1=297.11
Z1=−578.12.

The coordinates (X2, Y2, Z2) of the center position of the second light source, which is a rectangular diffusing surface light source that extends along the line 222 that connects the first light source position 219 and the second light source center position 221 and has dimensions of 250 mm×90 mm, are:
X2=0
Y2=435.317
Z2=−482.718

The ratio of the length to the width of the second light source is 2.78.

FIG. 14 shows the exit pupils for observation of the three-dimensional observation apparatus of this embodiment when a hologram diffuser that has been produced with the exposure conditions described above is used to enlarge the exit pupils for observation. Thus, an observer has more freedom of observation in terms of eye position in the vertical direction.

As shown in FIG. 15, the lengthwise direction 77 of the rectangular, enlarged exit pupil coincides with the direction of the positional shift 78 of the enlarged exit pupil for different wavelengths due to wavelength dispersion caused by the hologram diffuser. Thus, a greater overlapping area 82 of the enlarged exit pupils 79 to 81 for different wavelengths is ensured. Hence, an observer is able to observe images in correct colors over a greater area.

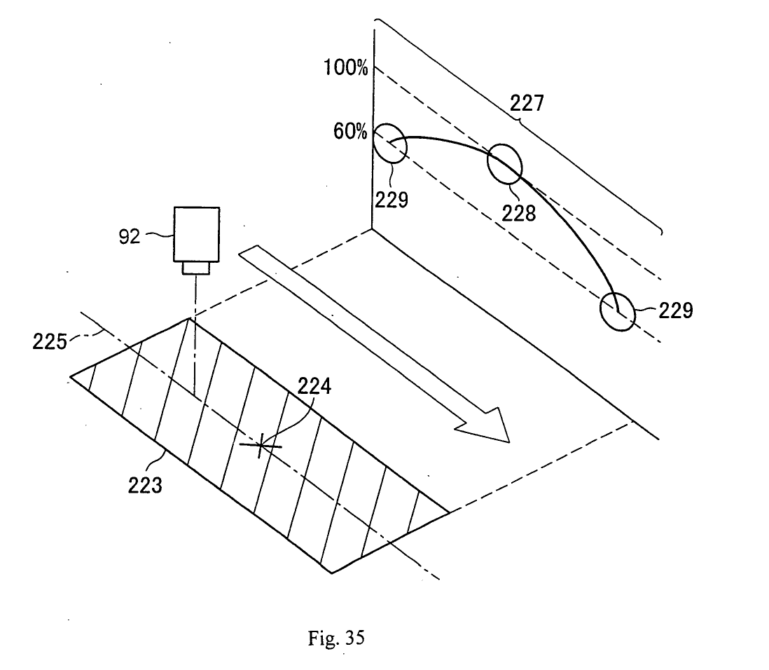

As shown in FIG. 35 for this embodiment, a diffracted light intensity profile 227 shows that the diffracted light intensity at the periphery 229 in the lengthwise direction of an image is 60% or greater relative to that of the diffracted light intensity 228 at the center of the image when measured by a diffracted light intensity meter 92 that travels along a line 225 which passes through the first-order image center 224 and is parallel to the lengthwise direction of the first-order image 223 of the second light source. When the hologram diffuser above is used in the apparatus shown in FIG. 18(a), the plus first-order, enlarged exit pupils 71 and 71′ that are formed by the hologram diffuser 19 and Fresnel concave mirror 26 (FIG. 18(b)) maintain a diffracted light intensity at the periphery 99 in the lengthwise direction of 60% or more relative to that of the diffracted light intensity at the rectangular pupil center 98. Thus, when the hologram diffuser of this embodiment is used in a three-dimensional observation apparatus, the wavelength dispersion caused by the hologram diffuser results in the positional shift of projected pupils for different wavelengths.

As shown in FIG. 19, the diffracted light intensity at the most peripheral part in the lengthwise direction of the enlarged exit pupils for different wavelengths is 40% or greater relative to that at the center. As can be seen in viewing FIG. 19, the difference in diffracted light intensity among the different wavelengths can be no more than 60% and, as is apparent from viewing FIG. 19, is about 50% in the overlapping area of the projected pupils for the different wavelengths.

Hence, an observer's eyes can be positioned anywhere within the overlapping area of the enlarged exit pupils for the different wavelengths in the range 450 nm-650 nm so as to observe images in their true colors, thereby increasing the freedom of viewing positions.

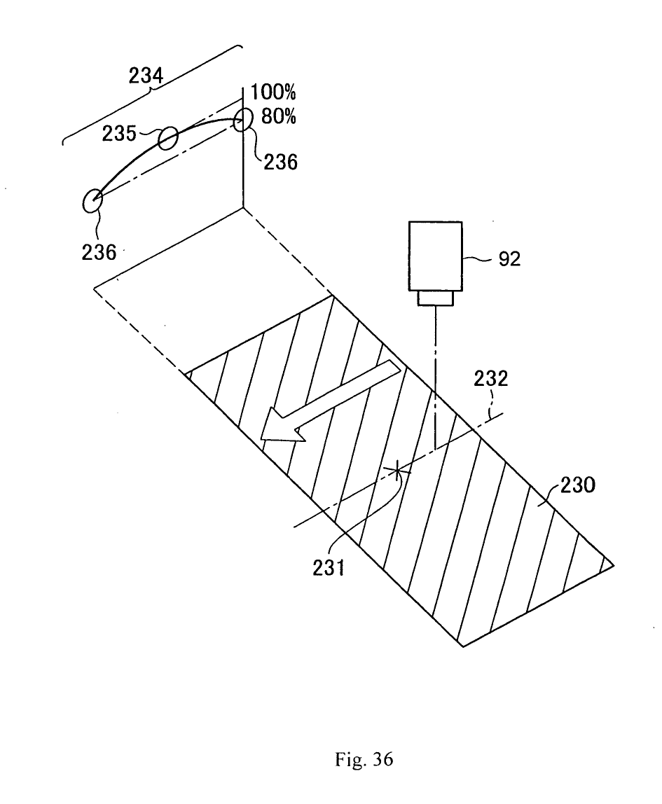

FIG. 36 shows the diffracted light intensity profile 234 of this embodiment in the width direction, which indicates that the diffracted light intensity at the periphery 236 of an image in the width direction is 80% or greater relative to that of the diffracted light intensity at the center of an image 235, when measured by a light intensity meter 92 along a line 232 that passes through the first-order image center 231 and is parallel to the width direction of the first-order image 230 of the second light source.

When the hologram diffuser above is used in the apparatus shown in FIG. 21(a), the plus first-order, enlarged exit pupils 71 and 71′ projected via the hologram diffuser 19 and the Fresnel concave mirror 26 (FIG. 21(b)) maintain a diffracted light intensity at the periphery 113 in the width direction of 80% or greater relative to that of the diffracted light intensity at the rectangular pupil center 98. Hence, an observer's eyes can be positioned anywhere within the first-order, enlarged exit pupils so as to observe images with a proper brightness, thereby increasing the freedom of viewing positions.

### Embodiment 5

FIG. 37 shows the three-dimensional observation apparatus of this embodiment. The figure shows: a surgical stereo microscope 144 for detecting two images having parallax; a camera controller 238 for controlling a CCD incorporated in the surgical stereo microscope 144 and for transferring the two images to an image display device; a DMD (digital micro mirror device) controller 239 for transferring the two images transferred from the camera controller separately to a right-eye image projector 240 and a left-eye image projector 241 and for controlling the DMDs incorporated in the image projectors. FIG. 37 also shows: a panel 40 that is formed of a hologram-type, diffractive optical element and a Fresnel concave mirror; a light source 243; a light guide cable 244 for transferring illumination light from the light source 243 to the image projectors 240 and 241; an image signal cable 245; and a holding unit 246 for holding the surgical stereo microscope 144, the image projectors 240 and 241, and the panel 40. The holding unit 246 is supported by a movable base that holds the camera controller 238, the DMD controller 239, and the light source 243.

As shown in FIGS. 24(a) and 24(b), the three-dimensional observation apparatus of this embodiment uses a hologram-type, diffractive optical element 120 and a Fresnel concave mirror 121 to form exit pupils for observation by an observer 39 that are conjugate to the exit pupils of the image projector 36.

An image projection means having a brightness of 800 ANSI lumens or higher, such as provided by a conventional projector, is too bright to view projected images in the manner described in this embodiment. Therefore, an image projector used with the three-dimensional observation apparatus of this embodiment has a brightness of 100 ANSI lumens or lower. Experiments have shown that image projection means having a brightness of 200 ANSI lumens or lower can be used without the images being perceived as being too bright. An image projection means that satisfies the condition that the brightness not exceed 200 lumens allows the observer to comfortably observe images.

The three-dimensional observation apparatus of this embodiment does not use respective light sources for the right-eye image projector, left-eye image projector, and surgical stereo microscope. Thus, the image projectors and surgical stereo microscope can be made small, and the components of the three-dimensional observation apparatus that are near the observer can be made to be compact, thereby providing the observer with a greater working space.

The image display means of this embodiment uses a DMD. However, a transmission-type liquid crystal display device or a reflection-type liquid crystal display device can instead be used. A display device that does not use polarized light for forming images, such as a DMD, is desired for the three-dimensional observation apparatus of this embodiment wherein a single light source is used.

The image projector of this embodiment has a brightness of 100 ANSI lumens. Of course, an image projector having a brightness of 200 ANSI lumens or more can instead be used, as long as such an image projector is provided with a neutral density (ND) filter so as to reduce the projected output beam intensity to 100 ANSI lumens or less.

### Embodiment 6

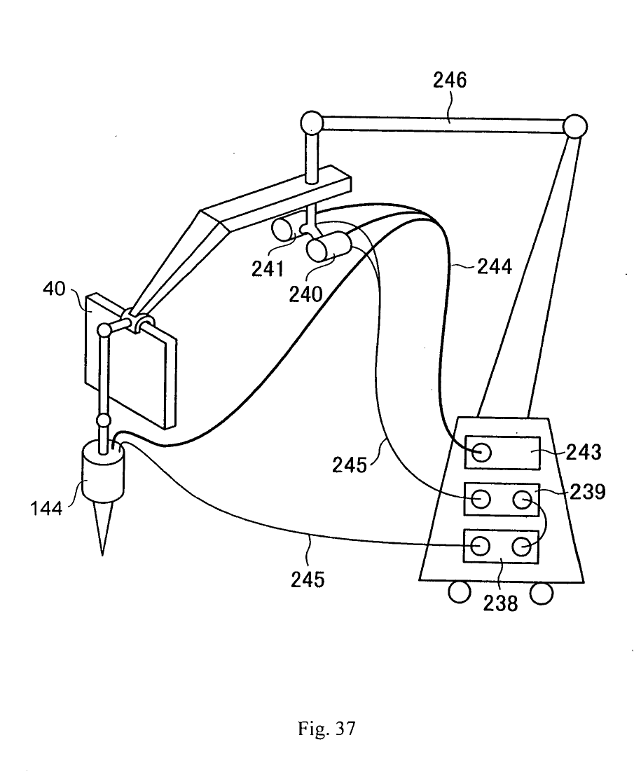

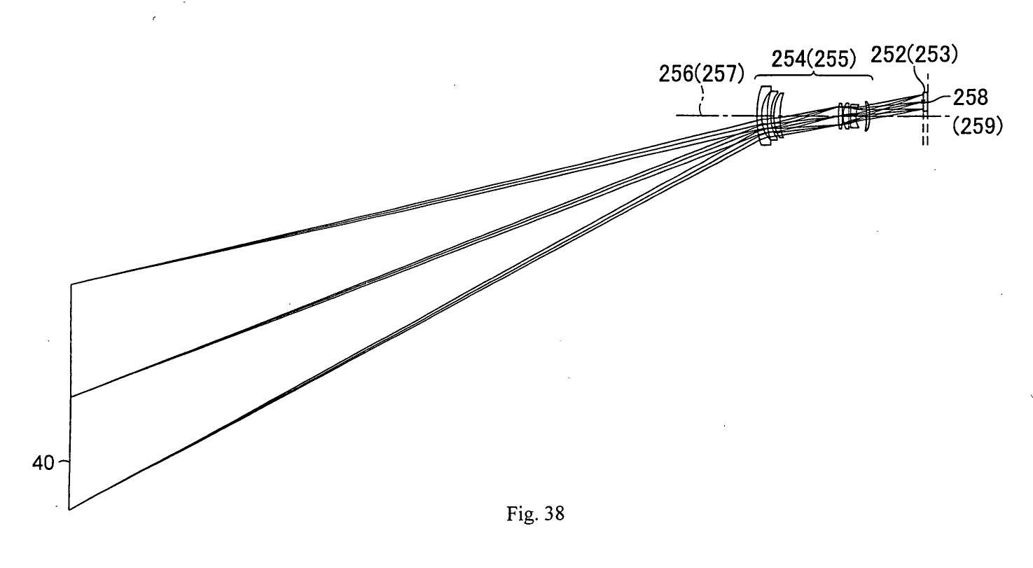

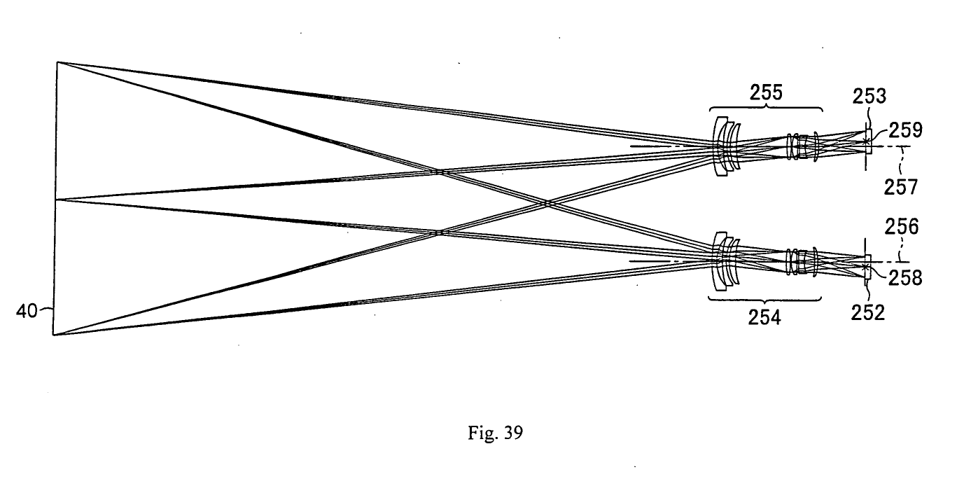

FIGS. 38 and 39 are detailed views of the optical system used in the three-dimensional observation apparatus of Embodiment 6, with FIG. 38 being a side view and FIG. 39 being a top view. These figures show: a right-eye transmission-type LCD (liquid crystal device) 252 and a left-eye transmission type LCD 253; a right-eye image projection optical system 254 and a left-eye image projection optical system 255; a panel 40 that is formed of a hologram diffuser and a Fresnel concave mirror; the optical axis 256 of the right-eye image projection optical system and the optical axis 257 of the left-eye image projection optical system; the center of the image display surface 258 of the right-eye transmission-type LCD; and the center of the image display surface 259 of the left-eye transmission-type LCD.

The centers of the image display surfaces 258 (259) of the transmission-type LCDs are positioned above the optical axes 256 (257) of the image projection optical systems. These optical axes are aligned substantially parallel to a line normal to the panel 40, and the centers of the image display surfaces 258 and 259 of the transmission-type LCDs are de-centered from the optical axes 256 and 257, as illustrated. Further-more, the image display surfaces of the transmission-type LCDs 252 and 253 are aligned substantially parallel with the image projection surface of the panel 40.

With the structure above, the positions of the right and left images projected on the panel 40 will substantially coincide for all field angles. Hence, an observer will be able to successfully merge the left-eye and right-eye images so as to perceive a three-dimensional scene without experiencing any feelings of being uncomfortable or that one needs to rest his eyes.

### Embodiment 7

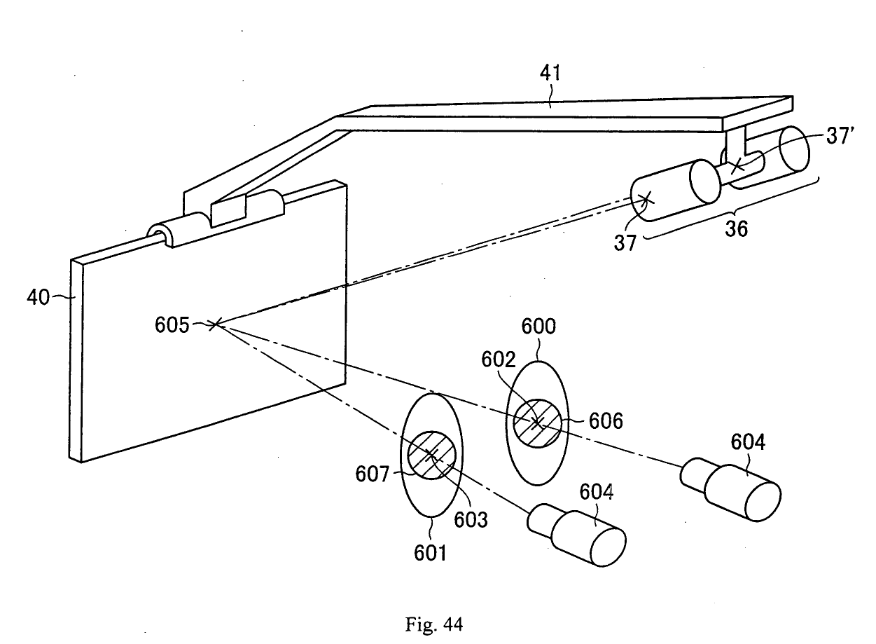

FIG. 44 shows the three-dimensional observation apparatus of Embodiment 7. In FIG. 44, the exit pupils 37 and 37′ of the image projector 36 are projected via a panel 40 that is formed of a hologram diffuser and a Fresnel concave mirror so as to produce enlarged exit pupils 600 and 601. When the hologram diffuser has the structure as described in Embodiment 4, above, the projection performance is obtained.

When an image of a white screen that is illuminated with a light source having C.I.E. chromaticity coordinates (x, y) of (0.31, 0.31) is projected from the image projector 36, the color at the center 605 of the image that is projected via the panel 40 as measured by a color meter 604 from the centers 602 and 603 of the enlarged exit pupils 600 and 601 (that are conjugates to the exit pupils 37, 37′, respectively) has a chromaticity of (x, y)=(0.31, 0.31) in the three-dimensional observation apparatus of this embodiment. When the color at the center 605 of an image projected on the panel 40 is measured from anywhere inside the enlarged exit pupils 600 and 601, the areas indicated by 606 and 607 in the figure have a chromaticity defined by (x, y)=(0.31±0.2, 0.31±0.2). These areas having a chromaticity defined by (x, y)=(0.31±0.2, 0.31±0.2) are the circles having a diameter Φ equal to 60 mm, with the centers of these circles being the centers 602 and 603.

With the structure above, an observer can position his eyes anywhere within the areas 606 and 607. As long as the right eye is positioned within the area 606 and the left eye is positioned within the area 607, an observer will not be aware of significant color changes in the field of view of the observed image. Hence, an observer is provided with good freedom of eye position and will experience little fatigue during observations.

### Embodiment 8

FIG. 42 shows the three-dimensional observation apparatus of Embodiment 8. The image projector 36 projects only a right-eye image on the panel 40 consisting of a hologram-type, diffractive optical element and a Fresnel concave mirror. The exit pupil 37, which projects an image, is conjugated by the panel to form the enlarged exit pupil 1006. The exit pupil 37′, which is not projecting an image, would be projected as an enlarged exit pupil 1006′ if the left eye projector were energized.

The brightness at the center 1009 of the projected image 1008 is 1580 cd./m² when measured by a luminance meter 1007 from inside the projected pupil 1006. It is 500 cd./m² when similarly measured from region that would correspond to projected pupil 1006′ (with the projector for the left eye not energized). The ratio H2/H1 equals 0.032 in this embodiment, which satisfies the above Condition (1). In order to obtain the value above, the hologram diffuser of this embodiment is produced with one exposure. The hologram diffuser is produced by interference exposure of the hologram recording material to light flux from plural coherent light sources. Hologram diffusers produced with many exposures produce increased, unnecessary diffracted light. Therefore, the number of exposures is preferably 10 or fewer. With such a structure, crosstalk can be reduced to the extent that three-dimensional observation is not disturbed.

### Embodiment 9

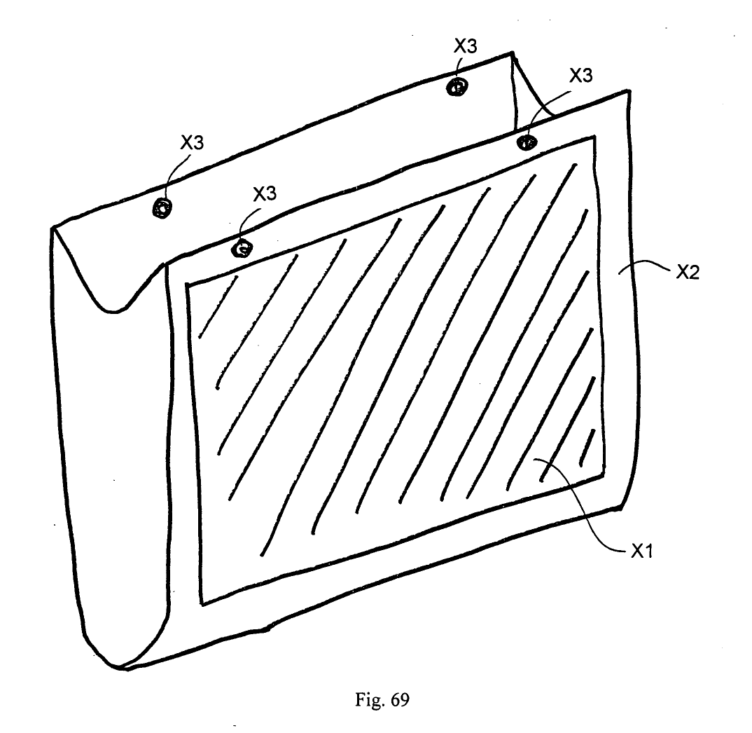

In this embodiment, the hologram-type, diffractive optical element is detachably attached to a Fresnel concave mirror and, as shown in FIG. 69, is made integral with a plastic drape.

FIG. 69 shows a plastic drape X2, a hologram diffuser X1, and buttons X3. The plastic drape X2 is cut out where it overlaps with the hologram diffuser X1. The hologram diffuser X1 is bonded so as to cover the cutout portion of the plastic drape X2. Hereinafter, a plastic drape that is made integral with a hologram diffuser is termed “an integrated drape.” The integrated drape is sterilized and contained in a sterilized pouch that maintains its contents sterilized.

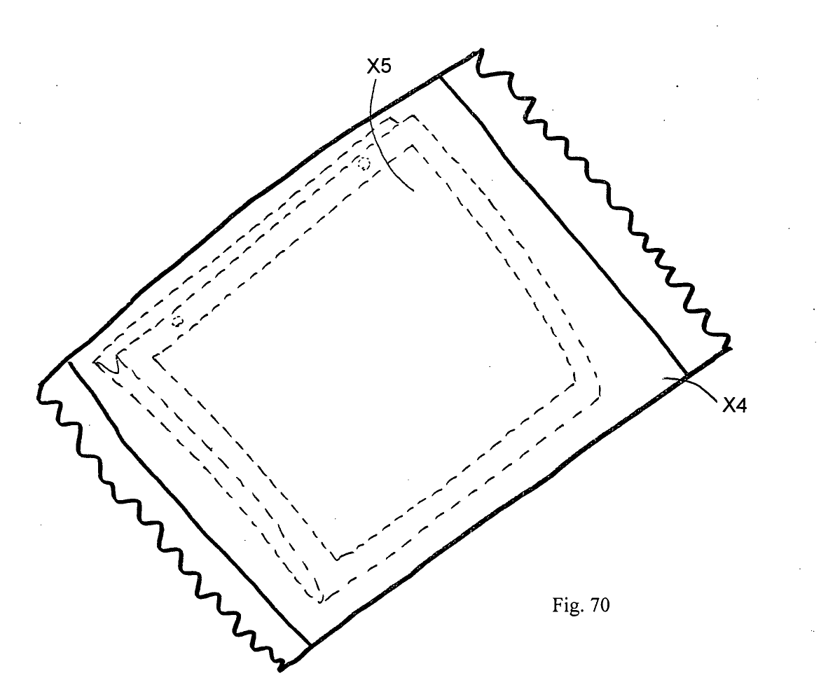

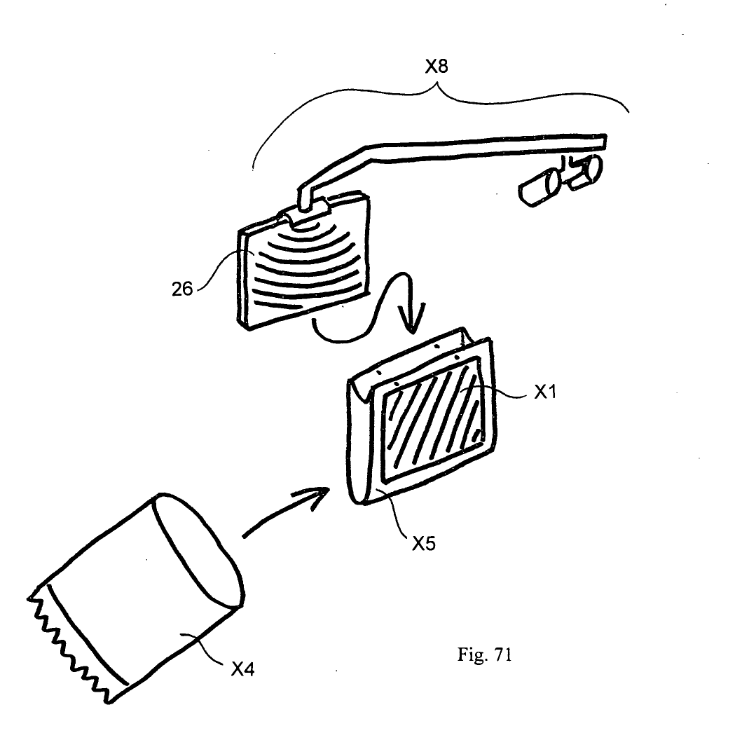

FIG. 70 shows a sterilized pouch X4 and an integrated drape X5 that is sterilized and contained in the sterilized pouch.

As shown in FIG. 71, the sterilized pouch X4 is opened within an operating room. The sterilized integrated drape X5 is then taken out and positioned so that it completely covers the Fresnel concave mirror 26 of a three-dimensional observation apparatus X8. The Fresnel concave mirror 26 is made of an acrylic material and has a mirror surface on one surface. The hologram diffuser X1 of the integrated drape X5 is closely attached to the surface of the Fresnel concave mirror 26 by electrostatic forces.

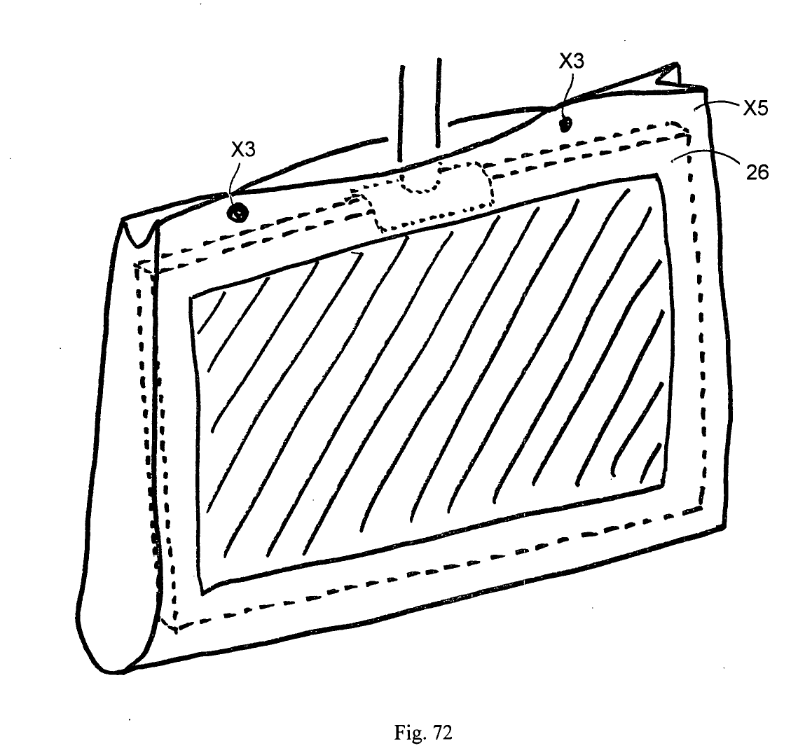

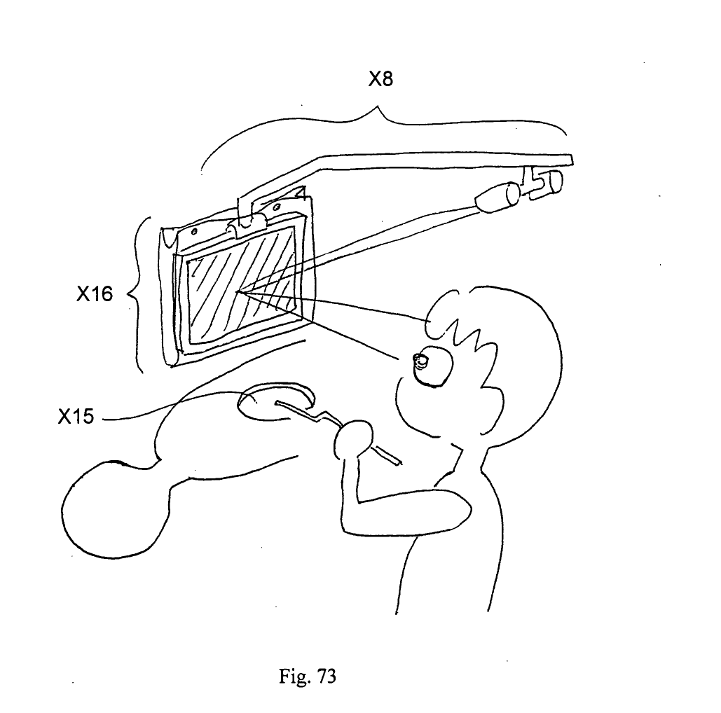

As shown in FIG. 72, after the integrated drape X5 covers the Fresnel concave mirror 26, the opening is closed with the buttons X3 above the Fresnel concave mirror 26 in order to prevent the integrated drape from falling.

As shown in FIG. 73, with the structure above, the parts X16 of a three-dimensional observation apparatus X8 that are close to the surgical site X15 can be maintained sterilized in an operating room.

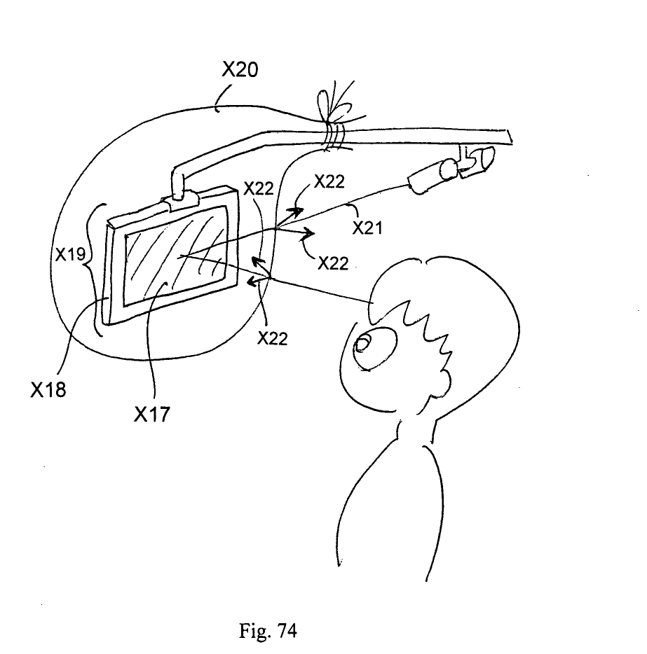

As shown in FIG. 74, when the three-dimensional observation apparatus does not have the structure of this embodiment, and a panel X19 that is integrally formed of a hologram diffuser X17 and a Fresnel concave mirror X18 is covered with a drape X20 that has been separately sterilized, the drape causes light X22 to be scattered and reflected when the light X21 is transmitted through the sterilized drape X20 so as to be incident onto the panel X19. Unfortunately, the rays of the scattered and reflected light X22 will deteriorate the quality of the observed images.

The hologram diffuser of this embodiment is made integral with the plastic drape and is intended to be discarded after each operation. Thus, when the three-dimensional observation apparatus according to this embodiment of the present invention is used in an operating room, a fresh and sterilized, integrated drape is used each time. In this way, a sterilized condition can always be ensured. The disposable drape (i.e., the integrated drape) is formed of a hologram diffuser and a plastic drape. This reduces the cost as compared to a structure in which a hologram diffuser and a Fresnel concave mirror are made to be disposable.

### Embodiment 10

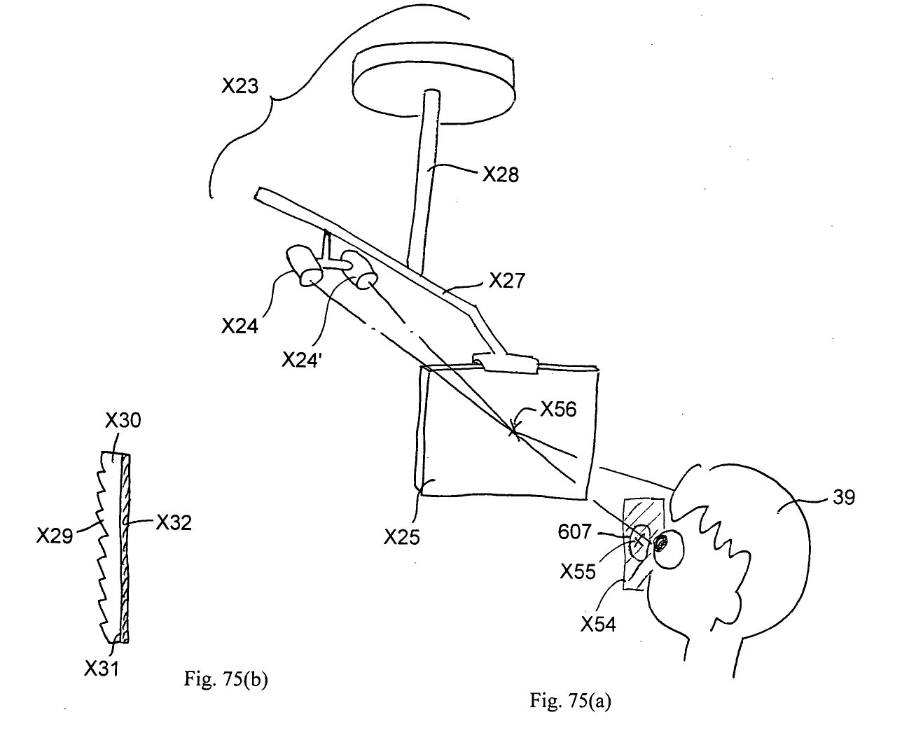

FIGS. 75(a) and 75(b) show the three-dimensional observation apparatus of Embodiment 10, with FIG. 75(b) being a side view of the panel X25 shown in FIG. 75(a). This embodiment uses a Fresnel convex lens instead of a Fresnel concave mirror. FIG. 75(a) illustrates: an observer 39; the panel X25 formed of a hologram-type, diffractive optical element and a Fresnel convex lens; a holding unit X23 that is formed of a first holding unit X27 for holding the image projectors X24 and X24′ and the panel X25; and a second holding unit X28 for supporting the first holding unit X27 from the ceiling. The panel X25 is formed of an acrylic sheet X30 with a convex Fresnel lens X29 formed on one of its surfaces for collecting transmitted light. The panel has a flat surface X31 on the side that is opposite the Fresnel lens surface, and a hologram diffuser X32 is applied to the flat surface.

The holding unit X27 holds the panel and the image projectors in a manner such that the exit pupil of the image projector X24 for the right eye is conjugated by the panel to a right-eye observation exit pupil, and the exit pupil of the image projector X24′ for the left eye is conjugated by the panel to a left-eye observation exit pupil. The holding unit X27 also holds the panel and the image projectors in such a manner that the two light beams projected by the image projectors X24 and X24′ substantially coincide on the panel X25 and the images projected by the image projectors X24 and X24′ are in focus at the panel. Due to the panel having a dispersive effect for the plus and minus first-order light, the exit pupils of the image projectors are enlarged by the panel X25 at these observation exit pupils. Furthermore, the zero-order light does not overlap either of these exit pupils, so the observer can observe stereo image pairs without there being a bright spot at the center due to the zero-order light.

When a white, full-screen image having C.I.E. chromaticity coordinates (x, y) of (0.31, 0.31) is projected from the image projector X24′, the color at the center X56 of the image that is projected via the panel X25 as measured by a color meter from the center X55 of the enlarged exit pupils X54 has a chromaticity of (x, y)=(0.31, 0.31) in the three-dimensional observation apparatus of this embodiment. When the color at the center X56 of an image projected on the panel X25 is measured from anywhere inside the enlarged exit pupil X54, the area indicated by 607 in the figure has a chromaticity defined by (x, y)=(0.31±0.2, 0.31±0.2).

With the structure above, an observer can position his left eye anywhere within the area 607 and not be aware of significant color changes in the field of view of the observed image. Hence, an observer is provided with good freedom of eye position and will experience little fatigue during observations.

FIG. 29 shows the exposure conditions of the hologram diffuser of this embodiment. FIG. 29 illustrates: a hologram recording material 166; the center 167 of the exposure surface of the hologram recording material; a first light source 168; a second light source 169; the center 170 of the first light source;. and the center 171 of the second light source. The first light source is a point light source. When the exposure surface center 167 of the hologram recording material is taken as the origin, the coordinates (X1, Y1, Z1) of the center 170 of first light source are as follows:
X1=0
Y1=297.11
Z1=−578.12.
The second light source is a diffusing surface light source, the coordinates (X2, Y2, Z2) of the center position of which are as follows:
X2=0
Y2=435.317
Z2=−482.718.

The angles (such as α, β, γ in the figure) made by the first light source center 170 and the second light source center 171 as seen from the exposure surface of the hologram recording material are all less than 15°. Thus, the hologram diffuser has weak light deflecting power with regard to bending of the transmitted light rays, and the wavelength dispersion of light transmitted through the hologram diffuser is 5° or less. Furthermore, the observation exit pupils that are formed by the panel undergo small shifts with a change in wavelength so as to provide an increased overlapping area of projected pupils for different wavelengths, as discussed above with regard to FIGS. 4 and 15. Thus, an observer has good freedom of eye position and does not experience undue fatigue during observation.

Referring once more to FIG. 29, the distance A between the exposure surface center 167 of the hologram recording material and the first light source center 170 is exactly equal to the distance B between the exposure surface center 167 of the hologram recording material and the second light source center 171. The hologram diffuser produced under this condition has only prism power with regard to bending of the transmitted light rays and no optical power to serve as a lens that converges or diverges light.

Thus, it is the Fresnel convex lens that provides optical power to converge or diverge light incident onto the display. With such a structure used for the hologram diffuser, the observation apparatus of this embodiment provides exit pupils for observation that do not differ in position depending on the wavelength of light. Thus, a greater overlapping area of projected pupils for different wavelengths is ensured, which gives an observer more freedom of observation positions, and this reduces fatigue during observation. As noted above, a hologram diffuser splits incident light flux into three light fluxes, a plus first-order light flux, a zero-order light flux, and a minus first-order light flux, with the plus and minus first-order light fluxes being scattered light fluxes.

The respective exit pupils of the right and left image projectors are projected via the panel X25 for observation. More specifically, these pupils are conjugated by the panel and formed as: plus first-order, enlarged exit pupils; minus first-order, enlarged exit pupils, and zero-order exit pupils that are not enlarged.

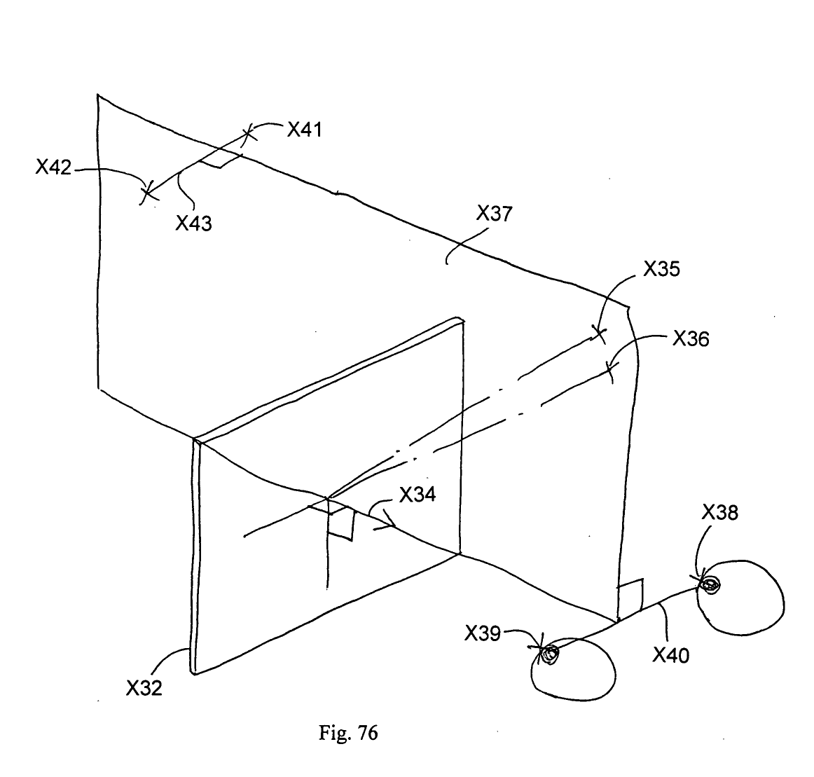

As shown in FIG. 76, a hologram diffuser X32 that forms part of the panel is formed in a manner such that a plane X37 that includes a normal line X34 to the hologram diffuser and the centers of the two light sources X35 and X36 is substantially orthogonal to the line X40 that connects the centers X38 and X39 of the pupils of both eyes of an observer and the plane X37 is also substantially orthogonal to the line X43 that connects the centers X41 and X42 of the right and left exit pupils of the image projectors.

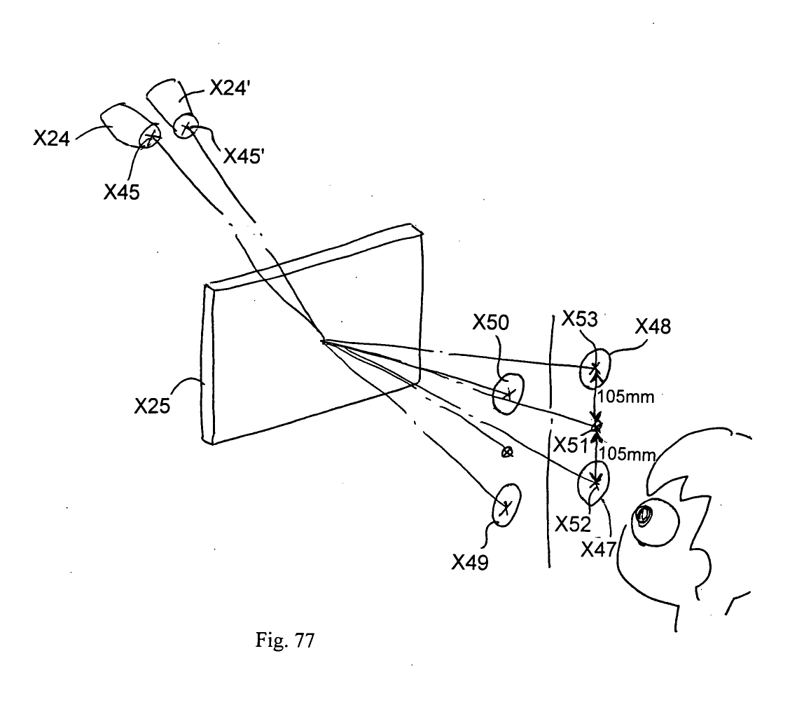

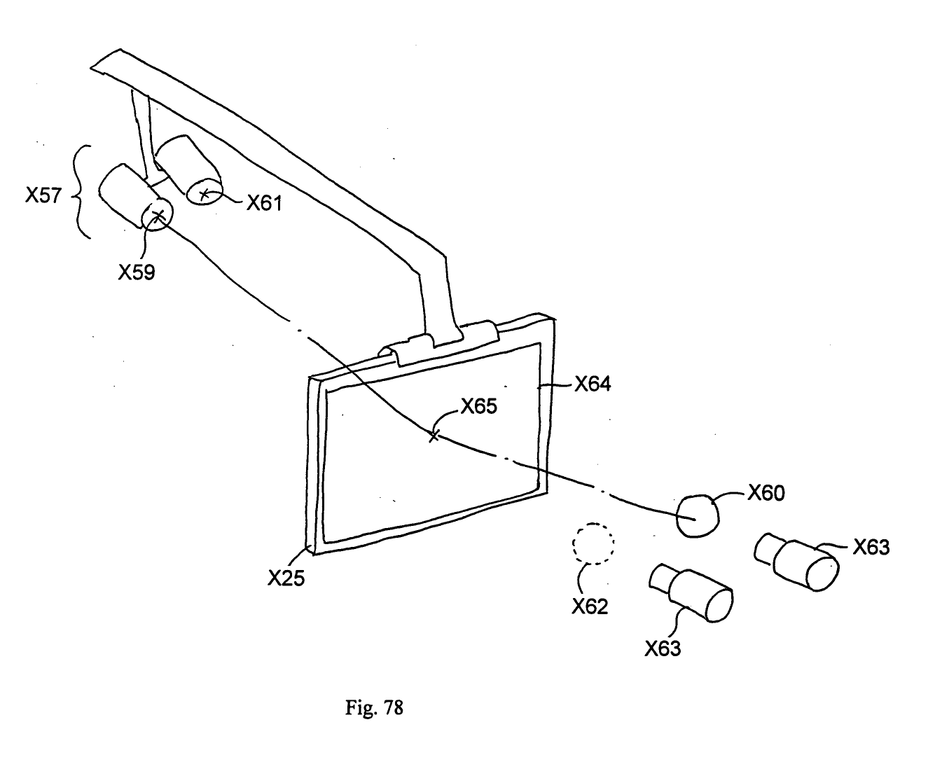

As shown in FIG. 77, the exit pupil X45 of a right-eye image projector X24 is projected via a panel X25 that is formed of the hologram diffuser and the Fresnel convex lens as a right-eye, plus first-order, enlarged exit pupil X47 and a right-eye, minus first-order, enlarged exit pupil X48. Likewise, the exit pupil X45′ of a left-eye image projector X24′ is projected via the panel X25 as a left-eye, plus first-order, enlarged exit pupil X49 and a left-eye, minus first-order, enlarged exit pupil X50. Thus, the observer can observe images projected via the panel X25 at two different observation positions, namely, that of the plus first-order or minus first-order, enlarged exit pupils. This also increases the freedom of the viewing positions, which enables a viewer to readily change his posture during viewing, thereby reducing fatigue during observations.

The distance between the center X51 of the zero-order exit pupil and the center X52 of the plus first-order, enlarged exit pupil is 105 mm, and the distance between the center X51 of the zero-order exit pupil and the center X53 of the minus first-order, enlarged exit pupil is also 105 mm. Thus, the plus first-order, enlarged exit pupil, the zero-order exit pupil, and the minus first-order, enlarged exit pupil do not overlap with one another, as shown in FIG. 9. Hence, by making use of either one of the plus first-order, enlarged exit pupil or the minus first-order, enlarged exit pupil, an observer can observe images with a proper brightness.

FIG. 34 shows the exposure conditions of the hologram diffuser of Embodiment 10. More specifically, FIG. 34 illustrates: a hologram recording material 217; the center 218 of the exposure surface of the hologram recording material; a first light source position 219; a second light source 220, and the center of the second light source 221. When the exposure surface center 218 of the hologram recording material is taken as the origin, the coordinates (X1, Y1, Z1) of the center position of the first light source, which is a point light source, are as follows:
X1=0
Y1=297.11
Z1=−578.12.

When the exposure surface center 218 of the hologram recording material is taken as the origin, the coordinates (X2, Y2, Z2) of the center position of the second light source, which is a rectangular, diffusing light source, are as follows:
X2=0
Y2=435.317
Z2=−482.718.

The second light source has its length dimension parallel with the line 222 that connects the center position 219 of the first light source and the center position 221 of the second light source and has an area of 250 mm×90 mm. The ratio of the length to the width of the second light source is 2.78.

When the three-dimensional observation apparatus of this embodiment is provided with a hologram diffuser produced under the exposure conditions shown in FIG. 34, the enlarged exit pupils for observation are as shown in FIG. 14. Thus, the observer has more freedom of vertical eye position.

As shown in FIG. 15, the lengthwise direction 77 of the rectangular, enlarged exit pupils coincides with the direction of the positional shift 78 of the enlarged exit pupils for different wavelengths that result from wavelength dispersion caused by the hologram diffuser. Therefore, there is provided a larger overlapping area 82 of the enlarged exit pupils. Hence, an observer is able to observe images in their true colors over a larger area.

As shown in FIG. 16, when the hologram diffuser is exposed to a single color light from the first light source position 86, a plus first-order reconstructed beam 87 that reconstructs the light emitted by the second light source used during the construction of the holographic optical element diffuser and a minus first-order reconstructed beam 88 that reconstructs the light emitted by the second light source used during the construction of the holographic optical element diffuser are produced on the far side of the hologram diffuser.

As shown in FIG. 35, the diffracted light intensity profile 227 of this embodiment shows that the diffracted light intensity 229 at the periphery in the lengthwise direction of an image is 60% or greater relative to that of the diffracted light intensity 228 at the center of the image when measured by a light intensity meter 92 along the line 225 that passes through the first-order image center 224 and is parallel to the length of the first-order image 223 of the second light source.

When the hologram diffuser above is used in the apparatus shown in FIGS. 75(a) and 75(b), first-order, enlarged exit pupils projected via the hologram diffuser and the Fresnel convex lens maintain a diffracted light intensity at the periphery in the lengthwise direction of 60% or greater relative to the diffracted light intensity at the center of the rectangular pupil. Thus, when the hologram diffuser of this embodiment is used in a three-dimensional observation apparatus, the wavelength dispersion caused by the hologram diffuser results in positional shifts of the projected pupils for different wavelengths.

As shown in FIG. 19, the diffracted light intensity at the most peripheral part in the length-wise directions of the enlarged exit pupils for different wavelengths is 40% or greater relative to that at the center. Therefore, the differences in diffracted light intensity among the different wavelengths are, at most, 60% in the overlapping area of the projected pupils for the different wavelengths. Hence, the observer can position his eyes anywhere within the overlapping area of the enlarged exit pupils for the different wavelengths and observe images in their true colors without compromising his freedom of position.

As illustrated in FIG. 36, the diffracted light intensity profile 234 for this embodiment shows that the diffracted light intensity 236 at the periphery in the width direction of an image is 80% or more relative to that of the diffracted light intensity 235 at the center of the image when measured by a light intensity meter 92 along the line 232 that passes through the first-order image center 231 and is parallel to the width of the first-order image 230 of the second light source.

When the hologram diffuser above is used in the apparatus shown in FIGS. 75(a) and 75(b), the plus and minus first-order, enlarged exit pupils projected via the hologram diffuser and the Fresnel convex lens maintain a diffracted light intensity at the periphery in the width direction of 80% or more relative to that at the center of the rectangular exit pupil. Hence, an observer can position his eyes anywhere within the plus or minus first-order, enlarged exit pupils so as to observe images with a proper brightness without compromising his freedom in viewing positions.

The three-dimensional observation apparatus of this embodiment uses a hologram-type, diffractive optical element and a Fresnel convex lens to form enlarged exit pupils for viewing. Therefore, an image projection means having a brightness of 800 ANSI lumens or higher, such as that provided by a conventional projector, provides too bright a light flux for use with the present invention. The image projector used with the three-dimensional observation apparatus of this embodiment has a brightness of 100 ANSI lumens. Experiments have proven that an image projection means having a brightness of 200 ANSI lumens or less can be used without the images being perceived as too bright. Such an image projection means allows an observer to comfortably observe the stereo images. However, it is possible to use an image projector having a brightness of more than 200 ANSI lumens by employing a neutral density (ND) filter so as to reduce the overall brightness to 100 ANSI lumens.

FIGS. 38 and 39 are detailed views of the optical system used in the three-dimensional observation apparatus of this embodiment, with FIG. 38 being a side view and FIG. 39 being a top view. These figures illustrate: a right-eye, transmission-type LCD (liquid crystal device) 253 and a left-eye, transmission-type LCD 252; a right-eye image projection optical system 255 and a left-eye image projection optical system 254; a panel 40 formed of a hologram diffuser and a Fresnel convex lens 40; the optical axis 257 of the right-eye image projection optical system and the optical axis 256 of the left-eye image projection optical system; the center of the image display surface 259 of the right-eye transmission-type LCD; and the center of the image display surface 258 of the left-eye, transmission-type, LCD. The optical axes 256 and 257 of the image projection optical systems are arranged parallel to the normal line to the panel 40, and the centers of image display surfaces 258 and 259 of the transmission-type LCDs are outside the optical axes 256 and 257. The image display surfaces of the transmission-type LCDs 252 and 253 are arranged parallel to the image projection surface of the panel 40.

With the structure above, the right and left light fluxes projected onto the panel 40 substantially coincide for all field angles. Hence, an observer is able to successfully observe images without any uncomfortable feeling or tiredness of the eyes when the right and left images are viewed and merged by the brain so as to form an illusion of viewing a three-dimensional image.

Referring to FIG. 75(a), when a white, full-screen image having the CIE chromaticity (x, y)=(0.31, 0.31) is projected from the image projectors X24 and X24′ in FIG. 75(a), the chromaticity coordinates (x, y) at the center X56 of the image projected onto the panel X25 as measured by a color meter from the center X55 of the projected pupil is (x, y)=(0.31, 0.31) in the three-dimensional observation apparatus of this embodiment. When the chromaticity of the center X56 of the image projected onto the panel X25 is measured from inside the projected pupil X54, the image has a color (x, y)=(0.31±0.2, 0.31±0.2) in the area indicated by 607 in the figure. That is to say, x is in the range between 0.31−0.2 and 0.31+0.2, and y is also in the range between 0.31 +0.2 and 0.31−0.2 in the area. The area having a chromaticity (x, y)=(0.31±0.2, 0.31±0.2) has diameter Φ of 60 mm, and is positioned about the center X55 of the projected pupil. To obtain the above results, the hologram diffuser has the structure of Embodiment 4 described above.

With the structure above, the observer can position his eyes anywhere in the area 607 within the enlarged exit pupil X54. From within this area, a typical observer will not be able to discern any color artifacts (i.e., a change in color within the view field). Moreover, the colors observed will be true to those of the subject image. Hence, an observer has freedom of eye position and, as a result of this freedom, will experience less fatigue during observation than otherwise.

### Embodiment 11

FIG. 78 shows the three-dimensional observation apparatus of Embodiment 11. In this figure, an image projector X57 projects only a right-eye image onto a panel X25 that is formed of a hologram-type, diffractive optical element and a convex Fresnel lens. The projector exit pupil X59, which in the figure is projecting light that carries an image, is imaged by the panel such that a conjugate of the exit pupil X59 is formed by the convex Fresnel lens as an observation exit pupil X60. Within the exit pupil X60 one may observe images when looking in the direction of the projector exit pupil X59. The exit pupil X61 in FIG. 78 is shown as not currently projecting an image. However, if the light source and the image projector for the left-eye image were energized, light would project via the panel so that a left-eye image could be viewed within the conjugate region X62, with the center of the light flux also being the point X65. The brightness of the point X65 is 1580 cd./m² when measured by a luminance meter X63 that is directed toward the point X65 from inside the projected pupil X60. Due to undesired scattered light, the brightness at the point X65 of the projected image X64 is 50 cd./m² when measured by a luminance meter X63 that is directed toward the point X65 from inside the region X62.

According to the present embodiment, the hologram diffuser is produced with a single exposure so that the following Condition (3) is satisfied:
H2/H1<0.05 Condition (3)
where

H1 and H2 are as defined in Condition (1) above.

In this embodiment H2/H1 equals 0.032 which satisfies the above Condition (3).

In order to obtain the value of 0.032, the hologram diffuser of this embodiment is produced with one exposure from two light sources. The hologram diffuser is produced by interference exposure of the hologram recording material to light flux from plural coherent light sources. Hologram diffusers produced with many exposures have increased unnecessary diffracted light. Therefore, the number of exposures is preferably 10 or less.

With the structure above, crosstalk can be reduced to an extent that three-dimensional observation is not disturbed.

### Embodiments 12 and 13

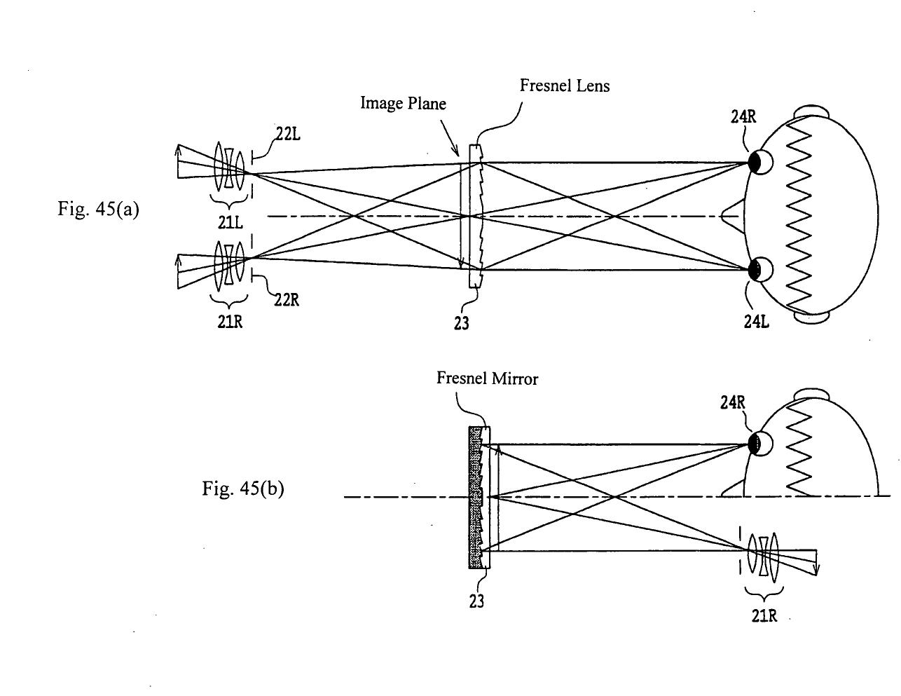

FIG. 45(a) shows an embodiment of a transmission-type three-dimensional observation apparatus (Embodiment 12) and FIG. 45(b) shows an embodiment of a reflection-type three-dimensional observation apparatus (Embodiment 13). In FIG. 45(b), only the right-eye structure is shown, as the left-eye structure has been omitted for convenience of illustration. The three-dimensional observation apparatuses of Embodiments 12 and 13 include projection optical systems 21R and 21L of an image projection device, an image forming optical system 23, and a diffusion optical system (not illustrated). The projection optical systems 21R and 21L project images on one and the same display surface through the two apertures 22R and 22L.

The image forming optical system 23 forms the images of the apertures 22R and 22L of the projection optical systems on the eye pupils 24R, 24L of an observer. The diffusion optical system enlarges the pupils for observation, and the image forming optical system 23 and diffusion optical systems are provided on the display surface. In other words, the display surface coincides with the image forming position of an image projected from the projection device. The image forming optical system 23 provided at the image forming position is a Fresnel lens for a transmission-type, three-dimensional observation apparatus or is a Fresnel mirror for a reflection-type, three-dimensional observation apparatus. The Fresnel mirror or Fresnel lens forms images of the two apertures 22R and 22L that function as observation exit pupils.

The Fresnel surface of a Fresnel mirror or Fresnel lens is arranged at the image forming surface, thus preventing deterioration of image quality. Unlike conventional concave mirrors, the Fresnel surface has a generally flat overall shape that allows the Fresnel surface (which includes many small, concentric, prism-shaped surfaces) to be, overall, a generally planar or slightly curved surface. This allows the many small, concentric, prism-shaped surfaces of the Fresnel surface to be placed at or near the image surface of the left-eye and right-eye display images that are projected by projectors through separate exit pupils.

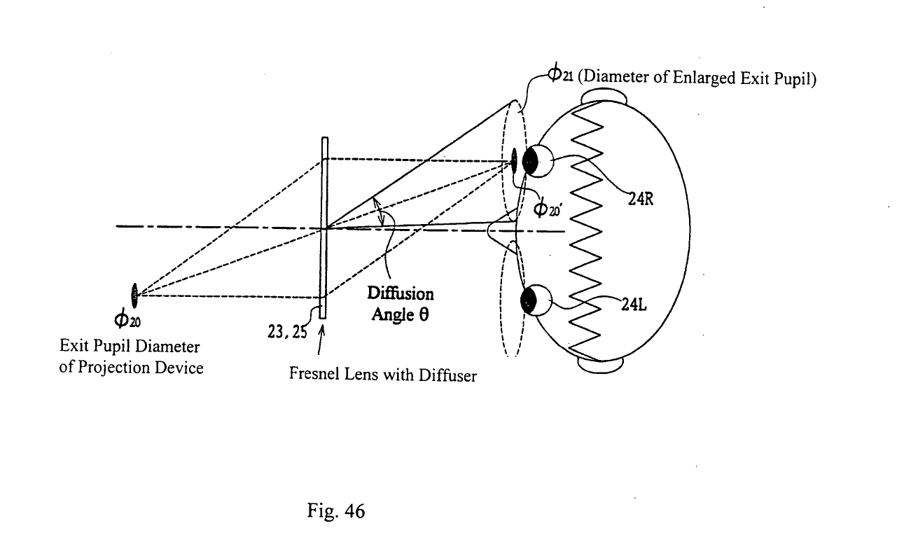

FIG. 46 is an illustration showing the manner in which an observation exit pupil is enlarged by the three-dimensional observation apparatus of the present invention. A transmission-type, three-dimensional observation apparatus is shown in FIG. 46. An image forming optical system 23 and a diffusion optical system 25 are arranged at or near the flat display position of images projected from a projection means (not shown). In FIG. 46, the image forming optical system 23 forms an image (having a diameter Φ20′) of the exit pupil having a diameter Φ20, as illustrated. The diffusion optical system 25 enlarges the observation pupil, which otherwise would be of the size Φ20′, to a diameter Φ21. Although not illustrated in FIG. 46, each eye is provided with enlarged exit pupils for observation. The diffusion optical system 25 is designed so that the right and left, enlarged observation exit pupils do not overlap, thus crosstalk of the right and left images is avoided.

Light is subject to diffusion one time in the transmission-type three-dimensional observation apparatus since light passes through the diffusion optical system 25 provided at the display surface only once. On the other hand, light is subject to the diffusion of the diffusion optical system 25 twice in the reflection-type three-dimensional observation apparatus (not shown in FIG. 46) where light passes through the diffusion optical system 25 provided at the display surface twice.

### Embodiment 14

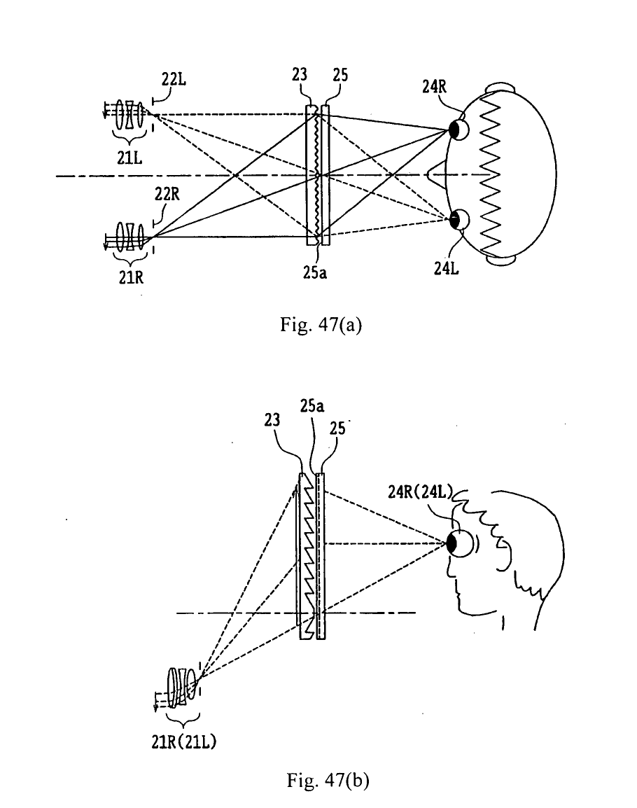

FIGS. 47(a) and 47(b) illustrate Embodiment 14 of the three-dimensional observation apparatus of the present invention, with FIG. 47(a) being a top view and FIG. 47(b) being a side view. The three-dimensional observation apparatus of this embodiment is of the transmission-type. A Fresnel lens having a Fresnel surface on its observation side is provided at the display surface position as an image forming optical system 23 that forms images of the apertures 22R and 22L of the projection devices 21R (21L). These images serve as observation exit pupils where an observer can position his eye pupils 24R and 24L so as to view images projected onto the display surface. A diffusing plate that functions as a diffusion optical system for enlarging the exit pupils is provided near the image-forming optical system 23, which in this case is a Fresnel lens. The Fresnel lens and a diffusing plate 25, together, form a transmission-type display panel, and the diffusing plate 25 has a diffusing surface 25a on its surface that is nearest the Fresnel lens. In this embodiment, the Fresnel lens surface is provided at the image surfaces of the projected images from the projection devices. The diffusing surface 25a is arranged close to the Fresnel lens surface, thereby reducing blur and deterioration of the image quality.

The transmission-type display panel of this embodiment is constructed as an eccentric optical system. Thus, the Fresnel lens surface is an eccentric Fresnel lens surface. As shown in FIG. 47(b), the optical axis of the Fresnel lens surface is below the center of the Fresnel lens, which functions as a planar-convex lens. The eccentric optical system is useful in that it allows the projection system to be positioned out of the way at a location where the projection optical system is less obstructive. In this embodiment, it is preferable for reduced deterioration of image quality that the diffusing surface 25a and the Fresnel surface be provided as close as possible to each other and at the position of the image surface.

### Embodiment 15

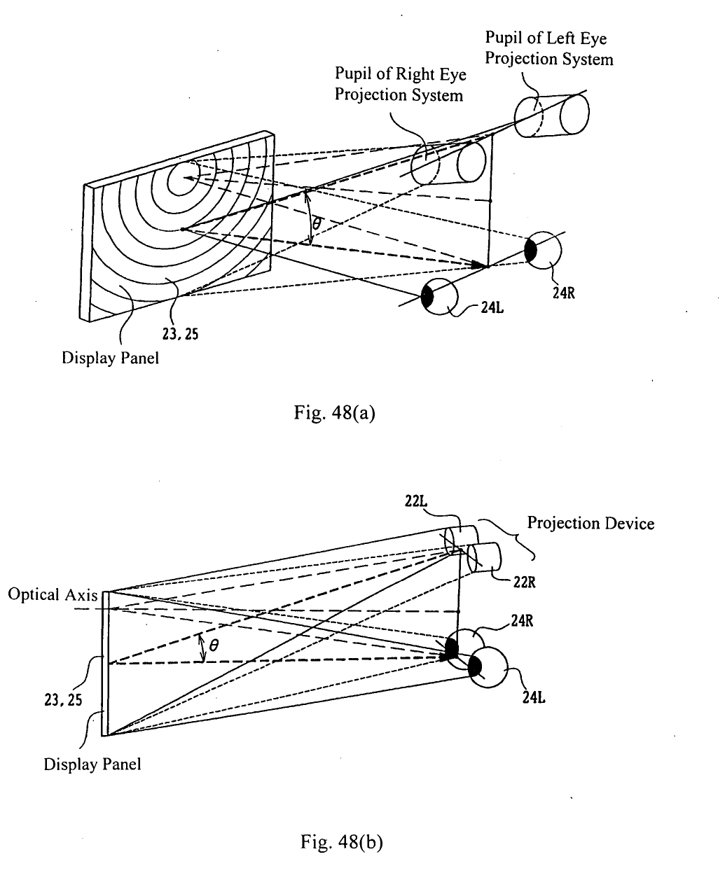

FIGS. 48(a) and 48(b) show Embodiment 15 of the three-dimensional observation apparatus according to the present invention, with FIG. 48(a) being a perspective view and FIG. 48(b) being a side view. The three-dimensional observation apparatus of this embodiment is of the reflection-type. The display panel includes a Fresnel minor 23 that is an image forming optical system for forming images of the apertures 22R and 22L (shown in FIG. 48(b)) of a projection device at observation exit pupils so that an observer's pupils 24R and 24L can view the images. A diffusing means 25 serves to enlarge the observation exit pupils. The components of a reflection-type, three-dimensional observation apparatus have to be arranged in a manner such that the projection device and the observer's head do not interfere with each other. For easier observation, it is better that the normal line drawn to the center of the display panel be roughly aligned with the direction of the observer.

In this embodiment, the optical axis of the light rays that are incident onto the display panel at the center of the panel and the optical axis of light rays that are reflected from the center of the display panel make an angle θ. As can be seen in FIG. 48(a), the optical axis of the Fresnel mirror 23 is de-centered upward from the center of the display panel.

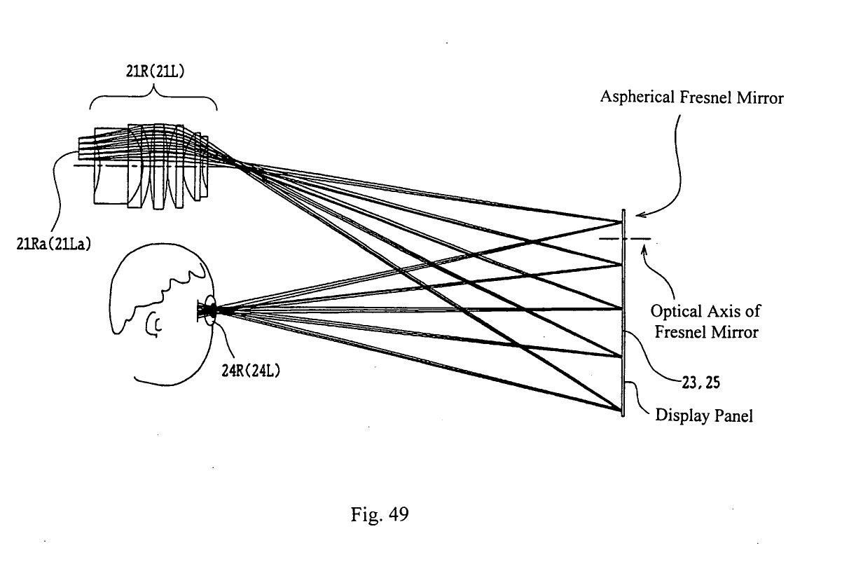

Referring to FIG. 49, which is a side view of the structure shown in FIG. 48(b), but in more detail and from the opposite side, spherical lenses are used in the projection optical systems 21R (21L) of the projection device and the display element surface 21Ra (21La) is de-centered in relation to the optical axes of the projection optical systems 21R (21L) so that the projection device and the observer's face do not interfere with each other. A Fresnel mirror display panel is arranged with its optical axis de-centered above the center of the display panel surface, which is oriented vertically such that a normal line to the center of the display panel is aligned with a line drawn between the midpoint of the observer's eyes and the center of the Fresnel mirror display device. The display panel of this embodiment includes an aspheric Fresnel mirror.

The angle of inclination a of the display panel is defined as the angle between the line that connects the center of the display panel to the observer's pupil and the normal line of the display panel. It is preferable, in terms of ease of observation of a bright image, to ensure that the absolute value of α is 30° or smaller. It is generally preferred that the observer directly faces the display panel (θ=0°). However, the display panel can be used with a being as large as ±30°, and excellent images can still be obtained when the display panel is oriented with α as large as ±15°.

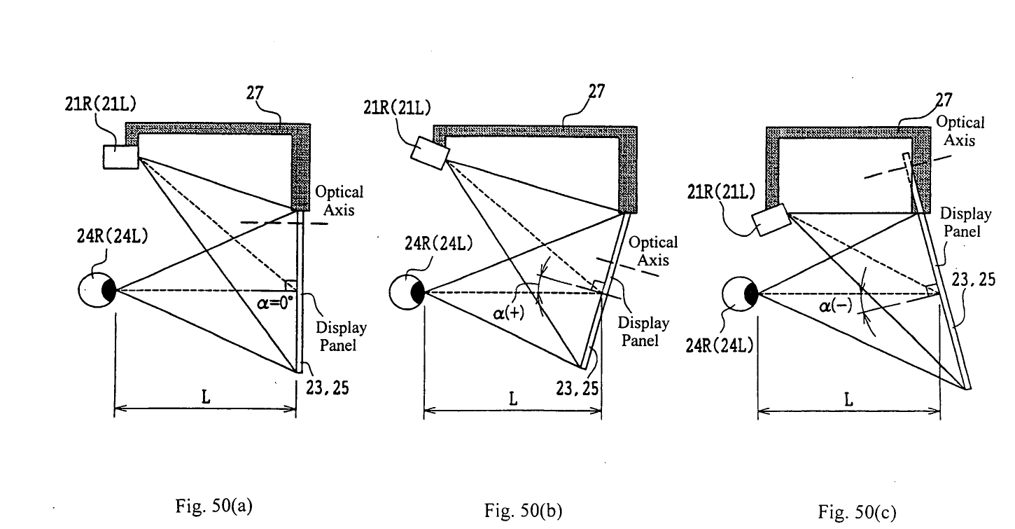

FIGS. 50(a)-50(c) illustrate different values of α. In each figure, the observer's line of sight is horizontal. The relationship between the display panel and the observer's pupil 24R (24L) is adjusted by a combination of the angle of inclination of the display panel and the degree of eccentricity of the optical axis of the Fresnel mirror surface so that an optimized observation condition is obtained. As can be seen in these figures, the projection optical systems 21R (21L) are supported so that they are nearer the ceiling than is the center of the display panel. Moreover, a supporting arm 27 is shown which supports the two projection devices and the display panel at different orientations, with FIG. 50(a) being a vertical orientation of the display panel (i.e., the surface normal is horizontal), with FIG. 50(b) being an orientation wherein the surface normal of the display surface is directed above the eyes of the viewer (wherein the sign of a is positive), and FIG. 50(c) being an orientation wherein the surface normal of the display panel is directed below the eyes of the viewer (wherein the sign of α is negative). In the three-dimensional observation apparatuses shown in FIGS. 50(a)-50(c), a equals zero, +30°, and −30°, respectively. Among the viewing arrangements shown in FIGS. 50(a)-50(c), the more desirable arrangements, in terms of providing bright and high quality images with minimal scattering of unwanted light into the viewer's eyes, are those shown in FIGS. 50(a) and 50(b).

### Embodiment 16

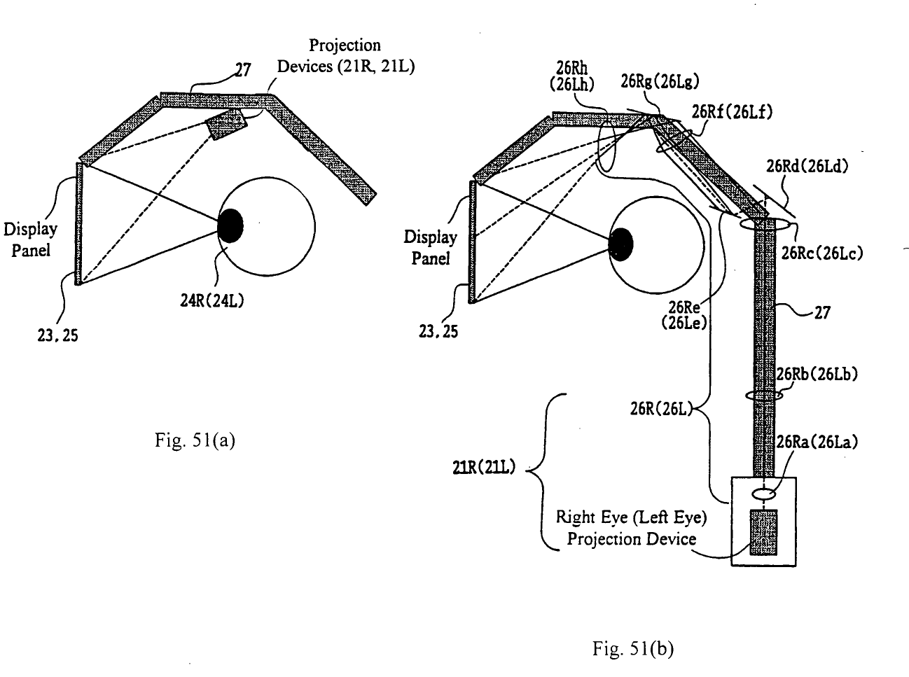

FIGS. 51(a) and 51(b) are side views of another embodiment of a reflection-type, three-dimensional observation apparatus of the present invention. The three-dimensional observation apparatus of FIG. 51(a) has two projection devices and a display panel that is formed of a Fresnel mirror 23 and a diffusing means 25. Right and left, enlarged exit pupils are provided from which images may be observed by the observer placing his eyes at these exit pupils for observation. The three-dimensional observation apparatus of FIG. 51(b) includes the projection optical system 21R (21L) of FIG. 51(a) and a relay system 26R (26L) that is provided in the projection device and supporting arm 27. The relay system 26R (26L) of the embodiment of FIG. 51(b) is formed of the lenses 26Ra-26Rc (26La-26Lc), mirrors 26Rd, 26Re (26Ld-26Le), lenses 26 mirrors 26Rg (26Lg), and lenses 26Rh (26Lh). With this structure, ample space is maintained between the projection device and the observer so that the projection device does not interfere with the activities of the observer.

Various embodiments of display panels that may be used in the three-dimensional observation apparatus of the present invention will now be discussed in detail.

### Display Panel Embodiment 1

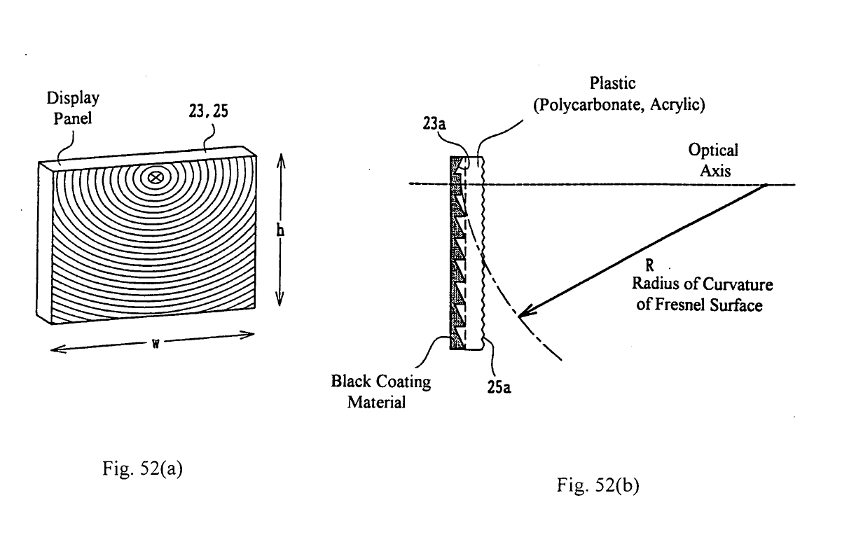

FIGS. 52(a) and 52(b) show an embodiment of a display panel applicable to the three-dimensional observation apparatus of the present invention, with FIG. 52(a) being a perspective view and FIG. 52(b) being a side view. The display panel of this embodiment is of the reflection-type and is formed of an integral panel having both a Fresnel surface 23a and a diffusing surface 25a. The diffusing surface is formed of many randomly formed concave surfaces. More particularly, for example, a plastic resin such as polycarbonate and acrylic may be press-molded from both sides, one using a Fresnel surface metal mold and the other using a diffusing surface metal mold. The Fresnel surface 23a is then coated with aluminum as a reflecting coating, on which a black coating is applied as a protective coating. The Fresnel surface 23a of the display panel serves to form images of the apertures of the two projection devices that function as observation exit pupils and the diffusing surface 25a serves to enlarge these observation exit pupils. The display panel shown in FIGS. 52(a) and 52(b) is constructed as an eccentric, rear-surface Fresnel mirror.

The radius of curvature of the Fresnel surface of a front-surface Fresnel mirror and of a rear-surface Fresnel mirror will now be discussed.

In the case of a rear-surface Fresnel mirror, the radius of curvature R is given by:
R=2nf
where

n is the index of refraction, and

f is the focal length of the rear-surface Fresnel mirror.

On the other hand, in case of a front-surface Fresnel mirror, the radius of curvature R is given by:
R=2f′
where

f ′ is the focal length of the front-surface Fresnel mirror.

Using a rear-surface Fresnel mirror as in this embodiment (since n of a transparent material other than air is greater than 1) enables the aberrations of images formed by the Fresnel mirror to be reduced, since the radii of curvature of the Fresnel surfaces can be longer for a given focal length of the Fresnel optical element. The Fresnel surface 23a of the display panel of this embodiment is an aspheric Fresnel surface, wherein the radii of curvature of the Fresnel surfaces toward the periphery of the Fresnel mirror increase. Providing the Fresnel mirror with such structure serves to further reduce aberrations in imaging the projection exit pupils so as to form the observation exit pupils.

### Display Panel Embodiment 2

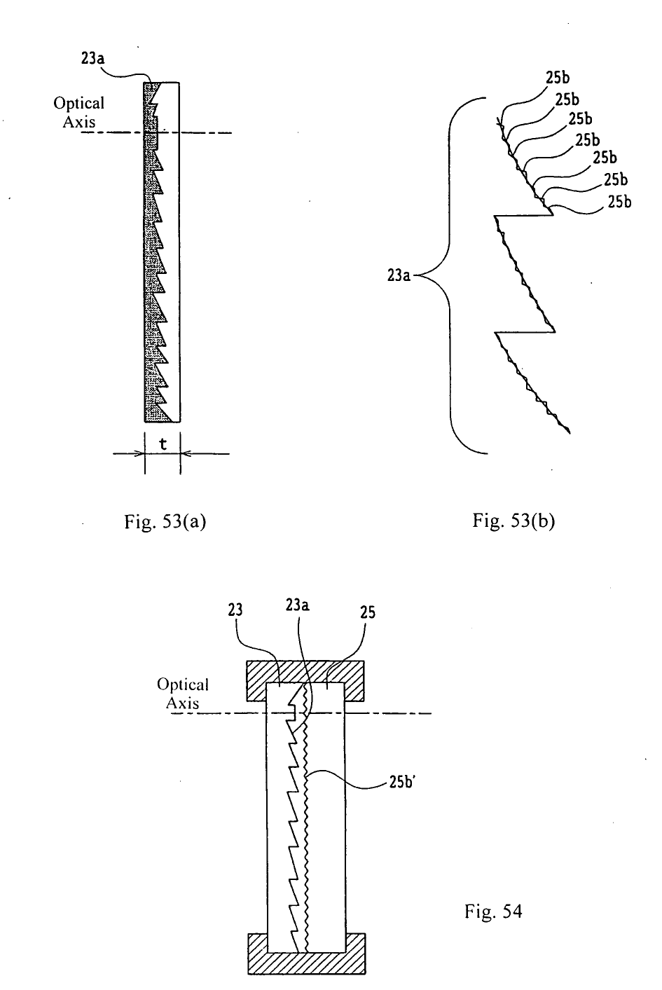

FIGS. 53(a) and 53(b) show another embodiment of a display panel that is applicable to the three-dimensional observation apparatus of the present invention. FIG. 53(a) is a side view and FIG. 53(b) is an enlarged view of the diffusing means. The display panel of this embodiment is of the reflection-type and includes a diffusing means formed of fine concave surfaces 25b that are made integral with a Fresnel surface 23a as shown in FIG. 53(b). The Fresnel surface 23a is provided with a reflecting coating so as to form a rear-surface Fresnel mirror.

The display panel of this embodiment advantageously has a flat front surface, to which an anti-reflecting coating may easily be applied. Projection light passes through the diffusing surface twice in the case of using a reflection-type display panel as shown in FIGS. 52(a) and 52(b). On the other hand, projection light is affected by the diffusion surface only once in the reflection-type display panel of this embodiment. This is because the Fresnel surface 23a that serves to form the observation exit pupils and the fine concave surfaces 25b that serve to diffuse the light are formed on one and the same surface. Therefore, the projection light is diffused only once, which results in reducing the blurriness of the image and thus reduces the deterioration of image quality.

### Display Panel Embodiment 3

FIG. 54 is a side view showing another embodiment of a display panel that is applicable to the three-dimensional observation apparatus of the present invention. The display panel of this embodiment is of the reflection-type, with a front-surface Fresnel mirror as the image forming optical system 23 and a diffusing plate 25 that has a rough surface 25b′ as the diffusing means. The Fresnel surface 23a and the rough surface 25b′ are formed so as to be near each, other.

In the display panel of this embodiment, the Fresnel surface 23a is formed on the surface of the image forming optical system 23 and placed close to the rough surface 25b′. Placing the rough surface near the Fresnel surface significantly reduces blurriness of the image even though the light is affected twice by passing twice through the rough surface. This is because the rays that are dispersed on the first pass do not travel far before being reflected, and thus the dispersion effect is diminished for the rays on their first pass through the rough surface. The display panel of this embodiment can be modified so as to be a front-surface Fresnel mirror on which a diffusing film is applied.

### Display Panel Embodiment 4

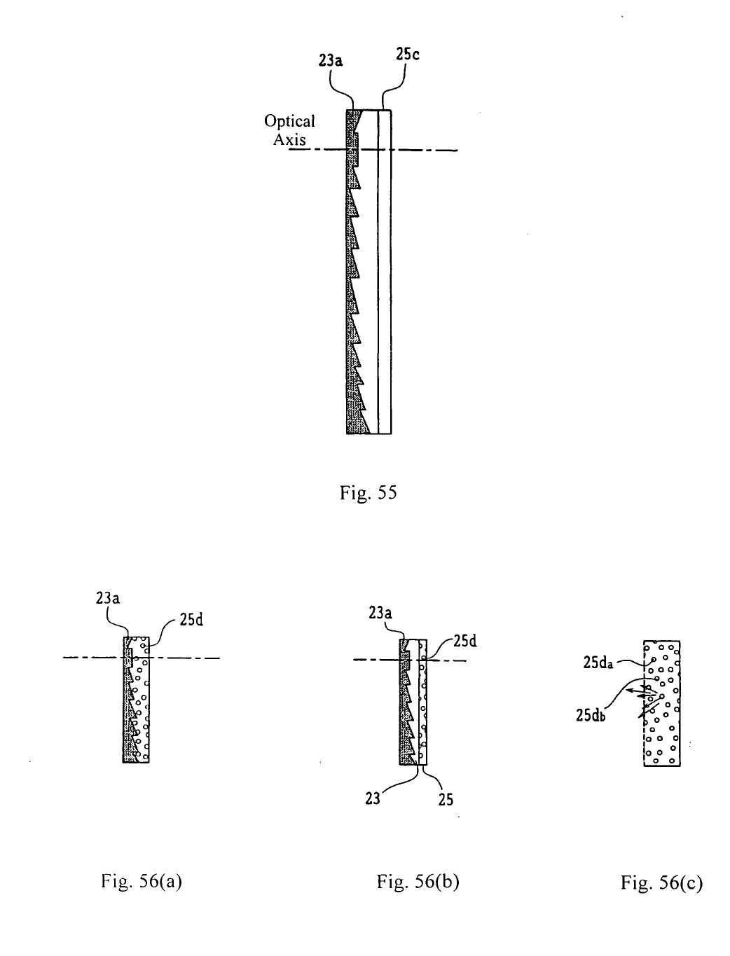

FIG. 55 is a side view showing another embodiment of a display panel that is applicable to the three-dimensional observation apparatus of the present invention. The display panel of this embodiment is of the reflection-type and is formed of an eccentric, rear-surface Fresnel mirror to which a diffusing film 25c is applied to the front surface thereof. The diffusing film 25c can be of the internal-scattering type or where the scattering is due to roughness on one or more of the surfaces of the diffusing film 25c.

### Display Panel Embodiment 5

FIGS. 56(a)-56(c) show another embodiment of a display panel that is applicable to the three-dimensional observation apparatus of the present invention, with FIG. 56(a) being a side view, and FIG. 56(b) being a modification of the structure shown in FIG. 56(a), and FIG. 56(c) illustrating an internal diffusing structure. The display panel of this embodiment is of the reflection-type and uses an internal diffusing member as the diffusing means 25. The internal diffusing member is made of a plastic material mixed with fine transparent particles having different refractive indices 25da, 25db, etc., as shown in FIG. 56(c). Light is diffused by being scattered in different directions while being transmitted through these fine particles 25da, 25db, etc.

The display panel of FIG. 56(a) uses an optical member having a Fresnel surface 23a that forms an eccentric, rear-surface Fresnel mirror that is combined with a plastic material having fine particles 25d mixed therein. The eccentric, rear-surface Fresnel mirror and the internal diffusing member are integrally molded. The display panel of FIG. 56(b) has an eccentric, rear-surface Fresnel mirror and an internal diffusing plate made of plastic material having fine particles 25d mixed therein, with the two being cemented or otherwise arranged close to each other. In the structure in FIG. 56(b), an internal diffusing film can instead be applied to the front surface of an eccentric, rear-surface Fresnel mirror.

### Display Panel Embodiment 6

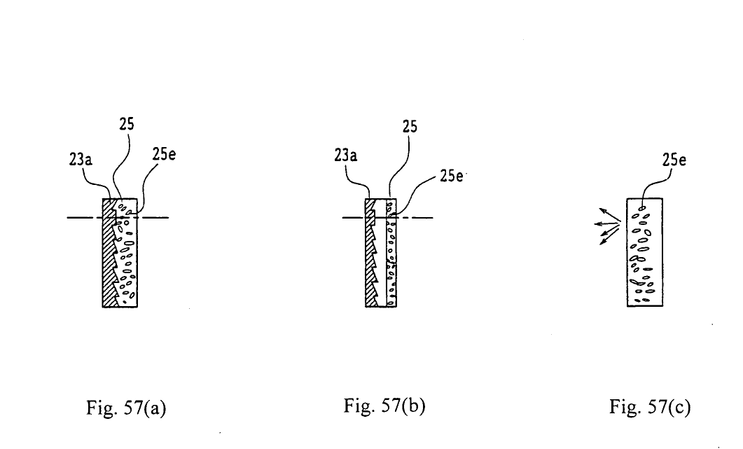

FIGS. 57(a)-57(c) show another embodiment of a display panel that is applicable to the three-dimensional observation apparatus of the present invention, with FIG. 57(a) being a side view, with FIG. 57(b) being a possible modification to the structure shown in FIG. 57(a), and with FIG. 57(c) illustrating an internal diffusing structure. The display panel of this embodiment is of the reflection-type and is an internal diffusing display panel using polymer liquid crystal as the diffusing means 25. Polymer liquid crystal can be used to immobilize liquid crystal, which this embodiment advantageously uses. Polymer liquid crystal 25e is birefringent and changes its orientation, as does other liquid crystal. However, the polymer liquid crystal 25e can be photo-polymerized to immobilize it in a random orientation, as shown in FIG. 57(c).

The display panel of FIG. 57(a) includes an optical member 25 that is formed of polymer liquid crystal and has a rear-surface, eccentric Fresnel mirror 23a. The display panel of FIG. 57(b) has an eccentric, rear-surface Fresnel mirror and a diffusing plate made of polymer liquid crystal, which are cemented together or arranged close to one another. Instead of the diffusing plate being made of polymer liquid crystal, a diffusing film made of polymer liquid crystal can be applied to the front surface of the eccentric, rear-surface Fresnel mirror.

The display panel of this embodiment having the structure above uses birefringent polymer liquid crystal 25e that has been immobilized with a random orientation. Unpolarized light passing through the polymer liquid crystal is subject to slight refraction differences due to differences in polarization of the unpolarized light. Thus, the polymer liquid crystal as a whole has a diffusing effect due to internal scattering caused by the slight refraction differences. Because this embodiment uses internal scattering to obtain diffusion, the surface of the display panel can advantageously be flat, making it easier to be cleaned when dirty as well as facilitating the application of an anti-reflecting coating for preventing reflection of external light.

The diffusing means 25 in another embodiment is a diffusing plate that is formed of a hologram. A hologram diffusing plate can be of the transmission-type or of the reflection-type. Among holograms recorded in volume photosensitive material, it is generally known that a transmission-type hologram has low wavelength selectivity and a reflection-type hologram has high wavelength selectivity. When color images are to be displayed, three sets of hologram interference fringes should be recorded when making a diffuser. For example, one set should be recorded using red light for diffusing red wavelengths, one set should be recorded using green light for diffusing green wavelengths, and one set should be recorded using blue light for diffusing blue wavelengths. Thus, it is desirable to use a transmission-type hologram that has low wavelength selectivity.

The construction of a display panel that is formed of a diffusing plate 25 that uses a transmission-type hologram as described above and a Fresnel concave mirror 23′ will now be described.

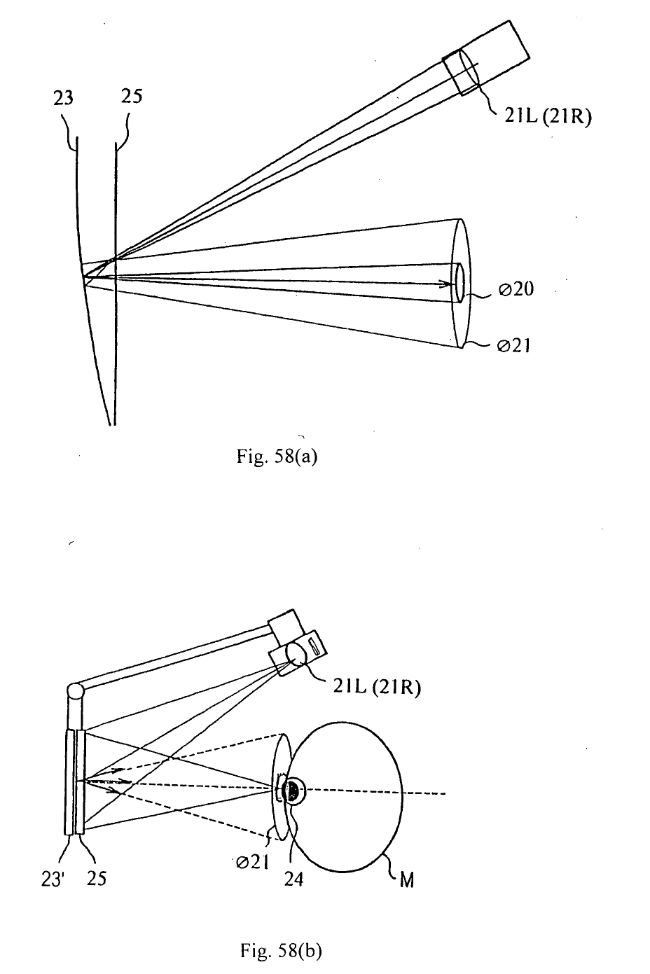

FIG. 58(a) is a side view of a display panel that is formed of a transmission-type, hologram diffusing plate 25 and a concave mirror 23. Also shown is a stereo image projector, with only one of the right and left optical systems being shown and with the other omitted for greater clarity.

FIG. 58(b) shows the geometry of a three-dimensional observation apparatus that uses a modified version of the display panel shown in FIG. 58(a), wherein the concave mirror 23 is replaced by an equivalent Fresnel concave mirror 23′. A diffusing plate 25 that is formed of a transmission-type hologram and a display panel are provided near the projected image surface. The display panel is formed of a Fresnel concave mirror 23′ that forms, at predetermined positions, exit pupils for viewing the exit pupils of the projection optical system. An observer M is then able to view projected images of the left-eye and right-eye projected images by positioning each eye within the corresponding exit pupil for observation. A projected exit pupil Φ20 having a small diameter is enlarged by the diffusing plate 25 so as to form an enlarged exit pupil for viewing Φ21 that has an appropriate size for easy observation. Thus, the projected image can be observed even if the eye 24 of the observer M is shifted outside the small exit pupil Φ20 so long as the eye remains within the larger exit pupil Φ21.

As shown in FIG. 58(a), this embodiment is characterized by the fact that the diffusing plate 25 is formed of a transmission-type hologram provided on the incident side of the concave mirror 23 of the display panel so that light transiting from the projection optical system 21L (21R) to the enlarged exit pupil Φ21 is affected by the diffusing plate 25 a total of two times. Light would normally be affected twice by the diffusing plate 25. However, in this embodiment, the angle at which the light is transmitted through the diffusing plate 25 the first time (before it reaches the concave mirror 23) and the angle at which light is transmitted through the diffusing plate 25 the second time (after it reaches the concave mirror 23) are intentionally made different. By taking advantage of the angular selectivity of a volume hologram, the hologram of the present embodiment is recorded so that light is not diffracted when it is transmitted through the diffusing plate 25 during one of the first time or the second time that it is transmitted through the hologram.

Different images are observed by the right and left eyes of an observer when stereo image pairs are projected so as to enable the observer to perceive three-dimensional observation images using the present invention. Excessive diffusion angles need to be avoided as they are the source of crosstalk between the images, wherein an image intended for observation by only the right eye is seen by both eyes, or vice-versa. In such a case, the perception of a three-dimensional image will not be realized; instead, the observer will merely see a double image. It is preferable that the diffusion angle intensity profile of a point source projected by the diffusing plate 25 when formed as a transmission hologram be less than or equal to 8° when measured between the 50% of peak intensity points. It is also preferable that the diffusion angle intensity profile of a point source projected by the diffusing plate 25 when formed as a transmission-type hologram be less than or equal to 12° when measured between the 10% of peak intensity points. Furthermore, light diffused at an angle of 12° or greater on either side of the peak intensity point should not reach the observer. Hence, it is preferable that the diffusing plate 25 be formed of a transmission-type hologram having a diffracted light intensity profile that rapidly diminishes in relative intensity outside the angles where the 50% of peak intensity occur.

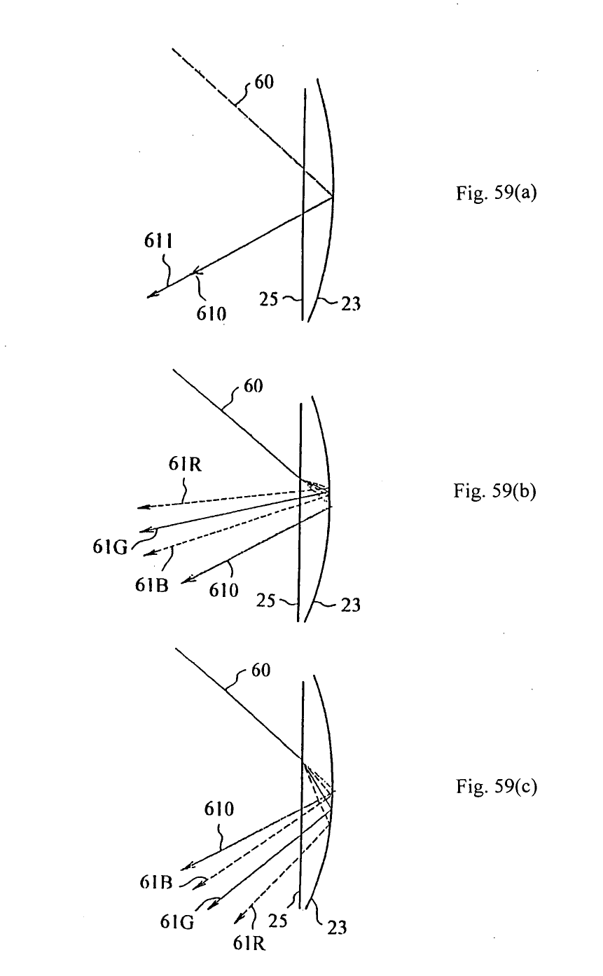

The relationship between the diffraction angle and wavelength dispersion for a transmission-type, hologram diffusing plate 25 and the positional relationship between the concave mirror 23 and the diffusing plate 25 will now be described. The diffusing plate 25 when formed of a transmission-type hologram is produced by recording the interference pattern between a reference light beam and an object light beam that are coherent with one another. The object light beam is from a diffused light source. When the reference light beam and the object light beam are recorded coaxially (in-line), the axial main ray 60 from the projection optical system enters the diffusing plate 25 for the first time and passes through it without diffraction, as shown in FIG. 59(a). Then, the main ray that has passed through the diffusing plate 25 is reflected by the concave mirror 23 (schematically illustrated in FIGS. 59(a)-59(c) as a single concave surface), enters the diffusing plate 25 for the second time, and passes through it. In the case where the incident angle at the first entry is aligned with one of the light beams used to record the hologram, the main ray travels straight at the first incidence point and the scattered light is diffracted into the plus and minus first-order beams that are dispersed. These diffracted beams as well as the reflected zero-order light beam then largely pass straight through the hologram at the second point of incidence after being reflected by the concave mirror 23, as they are largely unaffected by the hologram due to not resembling one of the recording beams in terms of the transiting direction of the beam through the hologram.

On the other hand, in the case where the incidence angle of the second point of incidence onto the hologram surface is similar to that of one of the beams used to record the hologram, the main ray 60 travels substantially straight through without being diffracted at the first point of incidence, and the main ray travels straight through at the second point of incidence. Thus, the zero-order light 610 and the main ray (center ray) 611 of the diffracted light travel in the same direction. FIG. 59(a) illustrates this situation, but the scattered light about the main ray 611 of the diffracted light is not shown. In other words, FIG. 59(a) shows only the zero-order light 610 (i.e., the light that has been diffracted into higher orders and thereby diffused by the diffusing plate 25 is not shown) and the main ray (center ray) 611 of the diffracted light. The zero-order light 610 and main ray 611 propagate in the same direction and reach the center of the exit pupil of the three-dimensional observation apparatus. Thus, as shown in FIG. 59(a), when the diffusing plate 25 is formed of a transmission-type hologram that has a scattering effect with no diffractive bending of the zero-order light beams, the zero-order light 610 and the main ray with scattered higher diffraction orders (not shown) reach the exit pupil. Consequently, a bright spot formed of the zero-order light 610 is disadvantageously observed at the center of an observed image.

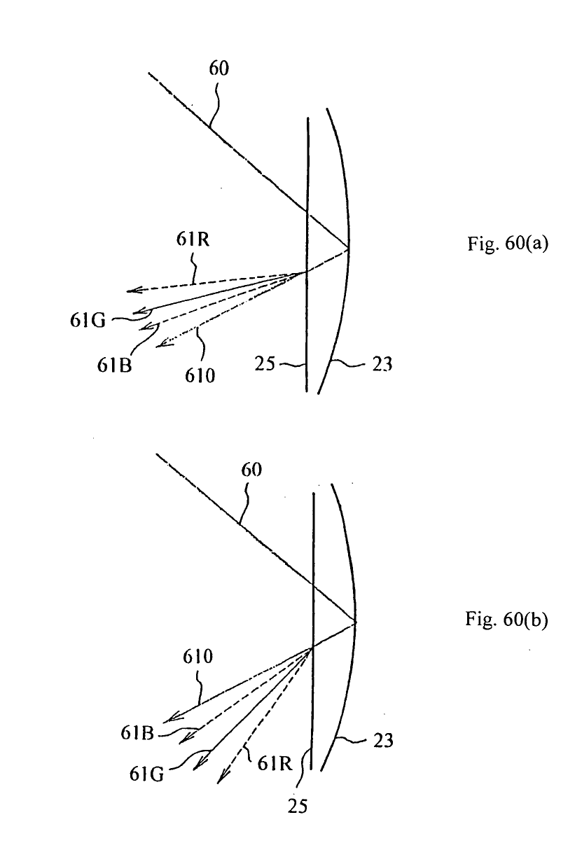

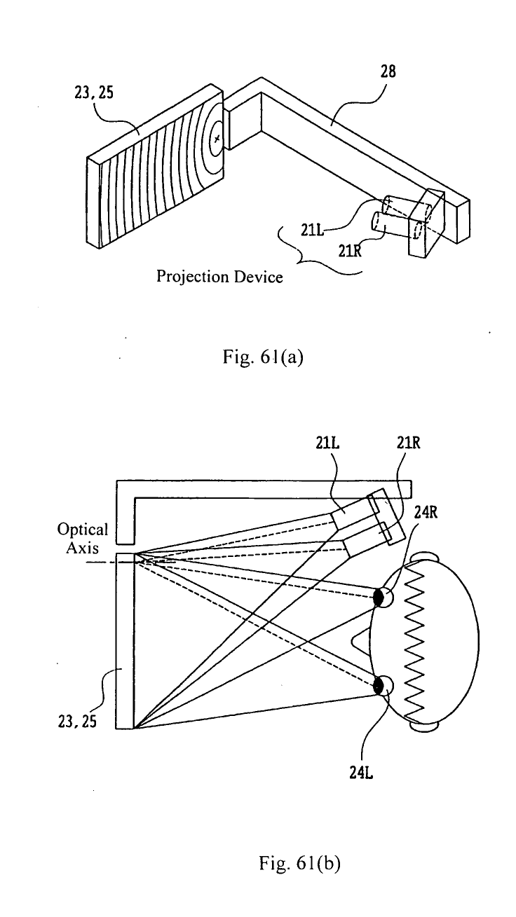

Therefore, it is more desirable that the diffusing plate 25 be formed of a transmission-type hologram that has been recorded with an off-line geometry (meaning that the reference beam and object beam light are incident from different directions (i.e., are not coaxial). The diffusing plate 25 when recorded with an off-line geometry produces diffraction and the accompanying wavelength dispersion of light when the reconstruction (play-out) light is incident in a direction that reproduces the wave patterns of one of the beams used to record the hologram. Depending on the situation of producing the hologram and the surfaces at which the light is diffracted, the optical paths will resemble either those shown in FIGS. 59(b) and 59(c) wherein the dispersion occurs on the first incidence, or those shown in FIGS. 60(a) and 60(b) wherein the dispersion does not occur on the first incidence, but occurs on the second incidence.

FIGS. 59(b) and 59(c) show the case where the incidence angle of light at the first incidence matches the incidence angle of reproduction light that is incident onto the diffusing plate 25, while FIGS. 60(a) and 60(b) show the case where the incident angle of light at the first incidence does not match the incidence angle of reproduction light that is incident onto the diffusing plate 25 until the second incidence. FIGS. 59(b) and 60(a) illustrate the situation in which the diffraction angle is smaller than the incidence angle, and FIGS. 59(c) and 60(b) illustrate the case in which the diffraction angle is greater than the incidence angle.

In these figures, the scattered light has been omitted and only the main rays (center rays) for the wavelengths R, G, and B that are diffracted and refracted by the diffusing plate 25 are shown. The main rays for the wavelengths R, G, and B are indicated by 61R, 61G, and 61B, respectively.

As seen in these figures, a transmission-type hologram with a strong diffraction bending effect can be used as the diffusing plate 25 to separate zero-order light 610 from the diffracted lights 61R, 61G, and 61B. Consequently, the zero-order light can be prevented from entering the exit pupil of the three-dimensional observation apparatus. More precisely, it is desirable that the zero-order light 610 enters at a point that is more than half the diameter of the exit pupil away from the center of the exit pupil, at the plane of the exit pupil, of the three-dimensional observation apparatus.

When the diffusing plate 25 formed of a transmission-type hologram is used, a light source for illuminating the display element surface is, preferably, a combination of three colors RGB, each of which can be produced by a high intensity, single color, LED or LD.

### Embodiment 17

FIGS. 61(a) and 61(b) show another embodiment of the three-dimensional observation apparatus of the present invention, with FIG. 61(a) being a perspective view and FIG. 61(b) being a top view. In this embodiment, the projection device and display panel are arranged in a manner such that a projected image is observed from the right or left or from the front of the reflection-type display panel.

The display panel and two projection devices 21R, 21L are integrally attached to a holding member. 28. The two projection devices may be provided either to the right or to the left of the display panel. In FIGS. 61(a) and 61(b), they are attached to the right of the display panel. Likewise, the optical axis of the Fresnel reflecting surface of the display panel may be de-centered either to the right or to the left on the display panel, but normally will be de-centered in the same direction as the direction that the two projection devices are attached relative to the display panel.

The optical axis of the incident light that is incident onto the center of the display panel from the projection device 21R (21L) and the optical axis of the exit light from the display panel to the right or left eye 24R (24L) of the observer make an angle so that the projection device and the observer's pupil 24R (24L) (as well as the observer's head) do not interfere with each other.

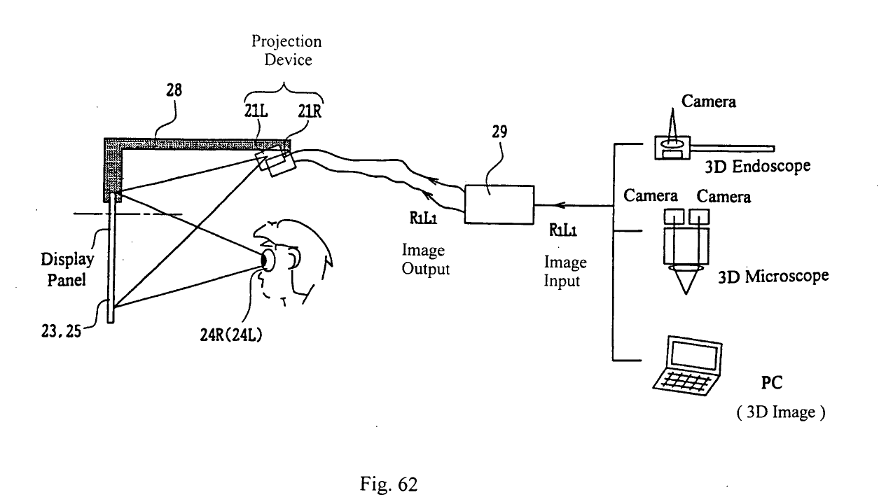

FIG. 62 shows an embodiment of a three-dimensional observation system using the three-dimensional observation apparatus of the present invention. The system of this embodiment uses a reflection-type, three-dimensional observation apparatus. However, any of the three-dimensional observation apparatuses of the present invention is applicable to the three-dimensional observation system of this embodiment.

In this embodiment, the right and left projection devices 21R, 21L are connected to a projection device control apparatus 29. The projection device control apparatus 29 selectively receives images that are picked up by right and left cameras that form part of a three-dimensional image input apparatus, such as a three-dimensional endoscope or a surgical stereo microscope, and transfers the selected images to the right and left projection devices in order to display the images. Other images that the projection device control apparatus 29 in this embodiment can possibly receive include three-dimensional images having parallax that are created via a personal computer.

Examples of using the three-dimensional observation apparatus of the present invention will now be described.

### EXAMPLE OF USE #1

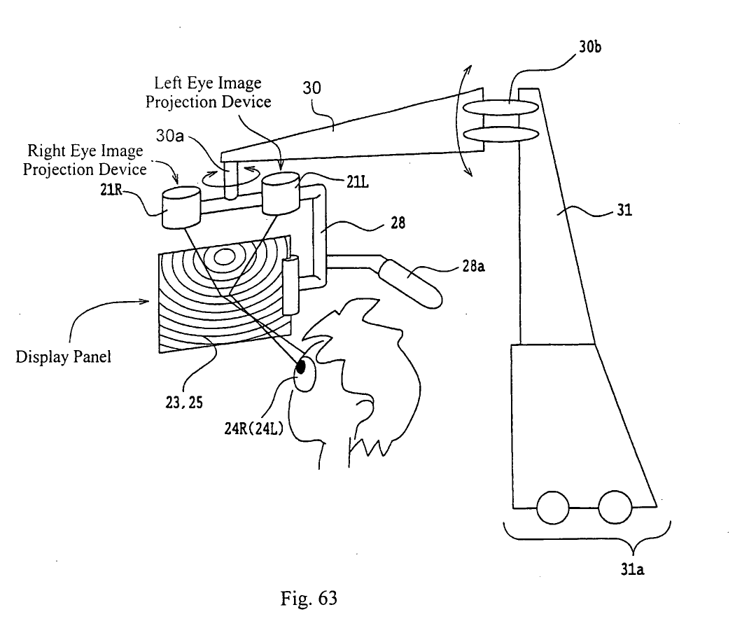

The example shown in FIG. 63 includes: a reflection-type, three-dimensional observation apparatus in which a display panel and right and left projection devices 21R, 21L are integrally attached to a holding member 28; a supporting arm 30 for supporting the holding member 28; and a supporting body 31 having casters 31a for supporting the supporting arm 30.

In the three-dimensional observation apparatus, images having parallax are projected from the right and left projection devices and reflected by the display panel so as to be viewable as enlarged observation exit pupils which are positioned at the right and left eyes 24R and 24L of the observer. The holding member 28 is connected to the supporting arm 30 via a joint 30a that can rotate in the directions indicated by the double-headed arrow. The supporting arm 30 is connected to the supporting body 31 via a joint 30b that can rotate in the directions indicated by another double-headed arrow. Moreover, the supporting body 31 has casters 31a which enable the entire apparatus to be moved, as needed. Thus, the holding member 28 and the supporting arm 30 can be moved and/or rotated in a desired direction so that the observer can change his/her posture at will. Further, the holding member 28 is provided with a handle 28a to facilitate movement/rotation of the display panel to a desired orientation and/or position.

### EXAMPLE OF USE #2

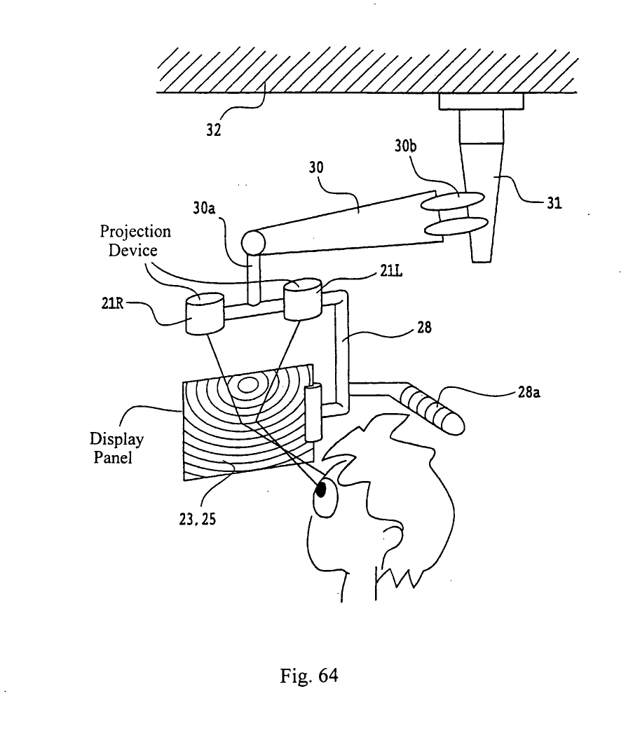

FIG. 64 shows another example of use of the three-dimensional observation apparatus of the present invention. In this example, the three-dimensional observation apparatus is connected to a holding member 28 similar to the one in FIG. 63. However, the supporting body is attached to the ceiling. In this example, the supporting body with casters 31a shown in FIG. 63 is omitted; thus the floor space required by the supporting body with casters 31a is available for other purposes.

### EXAMPLE OF USE #3

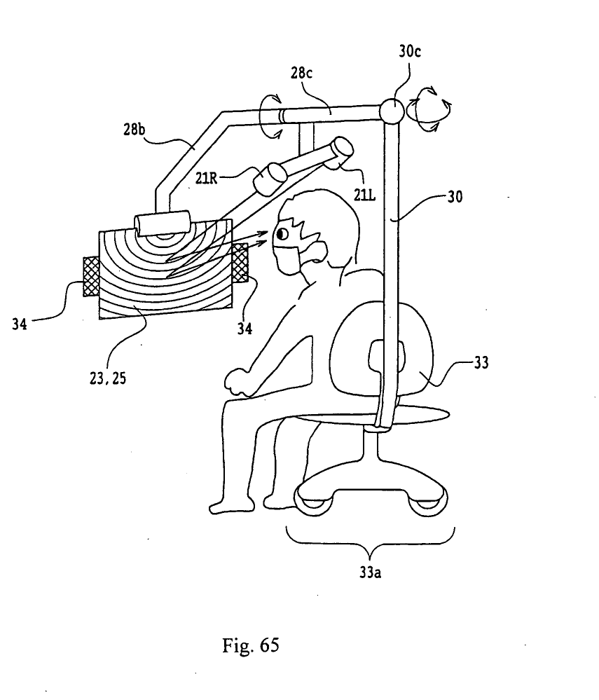

FIG. 65 is another example of use of the three-dimensional observation apparatus of the present invention. In this embodiment, the supporting arm 30 is attached to a surgical chair 33, the display panel is attached to a holding member 28b, and the projection devices 21R and 21L are attached to a holding member 28c. The holding member 28b is rotatably connected to the holding member 28c so that the display panel may be oriented in a desired direction in relation to the projection devices. Moreover, the holding member 28c, to which the projection devices are attached, is connected to the supporting arm 30 via a universal joint 30c that may be rotated 360 degrees in two orthogonal directions, and the surgical chair 33 is provided with casters 33a. Thus, the display panel and projection devices can be moved and/or oriented as desired, and handles 34, 34 are provided on the right and left sides of the display panel to facilitate moving/orienting the display panel without having to touch its surfaces.

### EXAMPLE OF USE #4

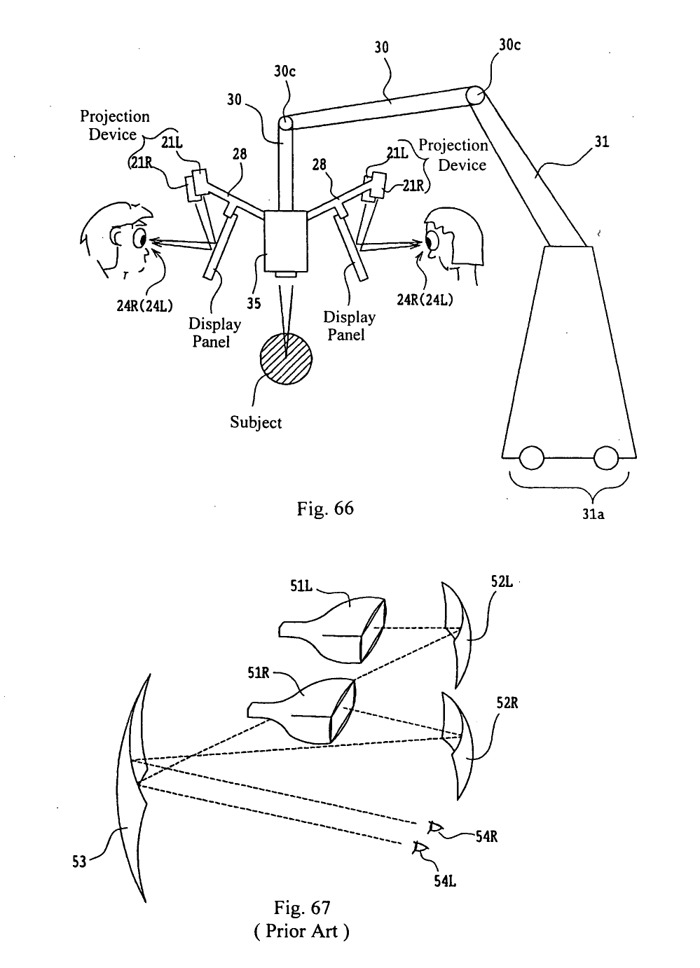

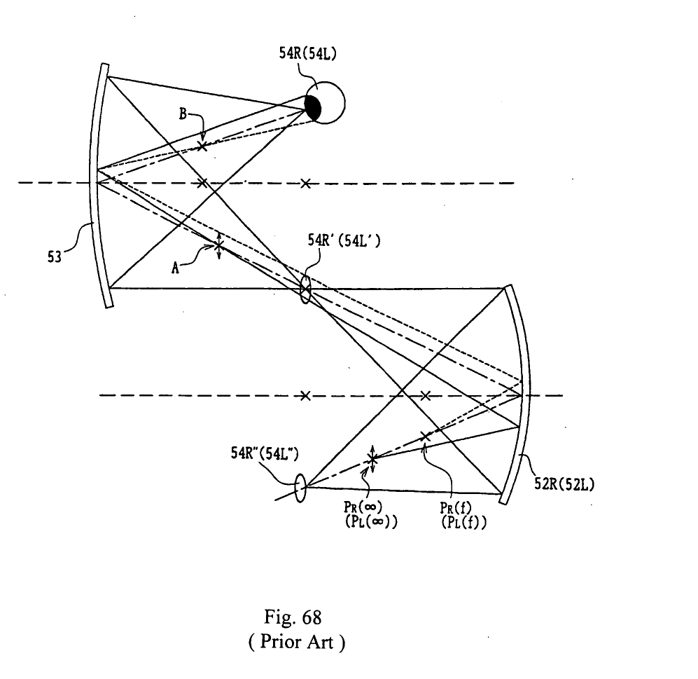

FIG. 66 shows another example of use of the three-dimensional observation apparatus of the present invention. In this embodiment, the three-dimensional observation apparatus includes the projection devices 21R and 21L, and the display panel which are attached to the holding member 28. Two of the three-dimensional observation apparatuses described above are attached to the image input part 35 of a surgical microscope via respective holding members 28, 28. The image input part 35 of a surgical microscope is attached to the supporting arm 30 and the supporting arm 30 is rotatably attached to a supporting body 31 via joints 30c, 30c. The supporting body 31 is provided with casters 31a.

Two cameras are incorporated within the image input part 35 of a surgical microscope. Images of a subject that are picked up by the two cameras are transferred to the projection devices of the two three-dimensional observation apparatuses so that plural observers can simultaneously observe three-dimensional images.

The invention being thus described, it will be obvious that the same may be varied in many ways. For example, the three-dimensional observation apparatuses shown in FIGS. 63-66 above also can be used as display apparatuses for surgical microscopes, endoscopes, medical three-dimensional information images, entertainment products such as computer game machines, and three-dimensional CAD images. Also, among the embodiments discussed above, the reflection-type, three-dimensional observation apparatuses can be constructed as a transmission-type, three-dimensional observation apparatus by using a Fresnel lens instead of a Fresnel mirror in the display panel. In addition, the image display element provided in the image projection means can also be varied, such as by using a DMD, a transmission-type liquid crystal, or a reflection-type liquid crystal. Such variations are not to be regarded as a departure from the spirit and scope of the invention. Rather, the scope of the invention shall be defined as set forth in the following claims and their legal equivalents. All such modifications as would be obvious to one skilled in the art are intended to be included within the scope of the following claims.

1. A stereoscopic observation apparatus comprising:
an image projector having two apertures that projects images having parallax to an image surface, the projected images from the two apertures being substantially overlapped at the image surface, each of the images having been projected through a different one of the two apertures of the image projector;
a holographic optical element that is placed at or near said image surface, the holographic optical element having diffractive properties that vary with wavelength so as to cause dispersion for light of different wavelengths that is diffracted into non-zero orders, the dispersion resulting in the holographic optical element having diffusive properties for light diffracted by the holographic light into diffractive orders higher than the zero order; and
a Fresnel optical element having positive optical power that functions to form exit pupils for observation by imaging the respective apertures of the image projector as enlarged exit pupils for observation, said enlarged exit pupils for observation having been enlarged by the imaging effect of the Fresnel optical element as well as by the dispersive effect of the holographic optical element; wherein
the amount of dispersion caused by the holographic optical element over the wavelength range 450 nm-650 nm for diffracted light of the first order is less than or equal to one-half the angular amount that each first-order diffracted beam is diffracted from the direction of propagation of the zero-order beam that passes straight through the holographic optical element.

2. The stereoscopic observation apparatus of claim 1, wherein the holographic optical element is constructed and oriented in the projected light paths so that the direction of the dispersion caused by the holographic optical element is non-parallel to a line drawn between the centers of said two apertures.

3. The stereoscopic observation apparatus according to claim 1, wherein the orientation and dispersive effect of the holographic optical element relative to the two apertures causes the images of these two apertures as formed by the Fresnel optical element to be enlarged in a direction that is substantially perpendicular to the direction of a line that connects the centers of the two apertures.

4. The stereoscopic observation apparatus according to claim 3 wherein, when the image projector projects images of a test object, such as a white screen having chromaticity (x, y) through the apertures, the chromaticity (x′, y′) of said images, as detected at the enlarged exit pupils for observation within a circular region having a center that coincides with the center of each enlarged exit pupil for observation and a diameter Φ equal to or larger than 50 mm , is given by:
(x′, y′)=(x±0.05, y±0.05)
where
(x, y) are the C.I.E. chromaticity coordinates of the images of the test object as viewed at the center of the exit pupil, and
(x′, y′) are the C.I.E. chromaticity coordinates of the projected image of the test object as viewed within said circular region of the enlarged exit pupil.

5. The stereoscopic observation apparatus according to claim 1, wherein the holographic element has optical power that is less than the optical power of the Fresnel optical element.

6. The stereoscopic observation apparatus according to claim 1, wherein the projection device projects images having a brightness of less than 200 ANSI lumens.

7. The stereoscopic observation apparatus according to claim 1, wherein the projector includes two image display devices, each displaying one of the two images at a respective display surface, and the two images are projected onto a substantially planar surface along two optical axes;
a normal line drawn to the surface of the holographic element is substantially parallel to each of said two optical axes; and
said substantially planar surface is substantially parallel to each of said display surfaces.

8. The stereoscopic observation apparatus according to claim 1 wherein, when an image is projected through only one aperture to the image surface, the following condition is satisfied:
H2/H1<0.05
where
H1 is the light intensity, measured at the center of a first observation exit pupil that is conjugate to a first exit pupil of a stereoscopic observation apparatus, in the direction of the center of a first light flux when the first light flux is currently projecting an image of a test object, such as a white screen, at all field angles through the first exit pupil; and
H2 is the light intensity, measured at the center of a second observation exit pupil that is conjugate to a second exit pupil of the stereoscopic observation apparatus, in the direction of the center of a second light flux when the second light flux is projected through the second exit pupil, but at a time when the second light flux is not being projected through the second exit pupil and the first light flux is being projected through the first exit pupil, and carries the image of the test object.

9. The stereoscopic observation apparatus according to claim 1, wherein the holographic element is made by exposure of an optical recording medium on a substrate to light that produces an interference pattern, the interference pattern being formed by interfering coherent light beams emitted from a first light source and a second light source, the second light source being formed of plural light sources arranged on a first plane, and the center of the first light source, the center of the light emitting surface of the second light source, and the center of the exposure surface of the hologram recording material lie substantially within a second plane; and
the second plane is substantially perpendicular to a line which connects the centers of said two apertures, as well as substantially perpendicular to a line which connects the centers of said two observation exit pupils.

10. The stereoscopic observation apparatus according to claim 1, wherein the holographic element is made by exposure to an interference pattern formed by interfering coherent light beams emitted from a first light source and a second light source; and
an angle made between a line connecting the center of the emission surface of the first light source and a point in the exposure area on a substrate for recording the interference pattern and a line connecting the center of the emission surface of the second light source and the point in the exposure area on a substrate for recording the interference pattern is less than or equal to 20 degrees.

11. The stereoscopic observation apparatus according to claim 1, wherein the holographic element is made by exposure to an interference pattern formed by interfering coherent light beams emitted from a first light source and a second light source; and
the following condition is satisfied:
0.9<L1/L2<1.11
where
L1 is a distance from the center of the exposure area on a substrate for recording the interference pattern to the center of the emission surface of the first light source, and L2 is a distance from the center of the exposure area on the substrate for recording the interference pattern to the center of the emission surface of the second light source.

12. The stereoscopic observation apparatus according to claim 1, wherein
the holographic element is made by exposure to an interference pattern formed by interfering coherent light beams emitted from a first light source and a second light source;
the second light source has an elongated emission surface the longer dimension of which is substantially aligned with a line that connects the center of the first light source to the center of the second light source; and
following condition is satisfied:
L/S>3
where
L is a length of the longer side of the emission surface of the second light source, and
S is a length of the shorter side of the emission surface of the second light source.

13. The stereoscopic observation apparatus according to claim 12, wherein the holographic element, when being irradiated by monochromatic light emitted by the first light source, generates an elongated plus first-order reconstructed beam and an elongated minus first-order reconstructed beam that reconstruct the beam emitted by the elongated emission surface of the second light source and, in at least one of the plus first-order and minus first-order reconstructed beams, the light intensity at the periphery in the longer direction is greater than or equal to 40% of the light intensity at the center.

14. The stereoscopic observation apparatus according to claim 12, wherein the holographic element, when being irradiated by monochromatic light emitted by the first light source, generates an elongated plus first-order reconstructed beam and an elongated minus first-order reconstructed beam that reconstruct the beam emitted by the elongated emission surface of the second light source and, in at least one of the plus first-order and minus first-order reconstructed beams, the light intensity at the periphery in the shorter direction is greater than or equal to 80% of the light intensity at the center.

15. The stereoscopic observation apparatus according to claim 1, wherein the holographic optical element is integrally formed with a plastic bag that is adapted to cover the Fresnel optical element.

16. The stereoscopic observation apparatus according to claim 2, wherein the centers of the exit pupils for observation are at least 50 mm from the display surface.

17. The stereoscopic observation apparatus according to claim 1, wherein the holographic optical element generates minus first-order light, zero-order light, and plus first-order light.

18. The stereoscopic observation apparatus according to claim 1, wherein the first-order diffracted beam has a beam width, as measured between the 50% intensity beam profile points, of less than 12 degrees.

19. The stereoscopic observation apparatus according to claim 1, wherein the first-order diffracted beam has a beam width, as measured between the 10% intensity beam profile points, of less than 12 degrees.
